(19) United States
(12) Patent Application Publication
(10) Pub. No.: US 2020/0044240 A1
(43) Pub. Date: Feb. 6, 2020

(54) Graphite and Group IVA Composite Particles and Methods of Making

(71) Applicant: KRATOS LLC, Irmo, SC (US)

(72) Inventors: Timothy D. Newbound, Chelsea, MI (US); Reza Kavian, Chelsea, MI (US); Jeff A. Norris, Lexington, SC (US); Richard Owen Crowther, Redford, MI (US)

(21) Appl. No.: 16/338,576

(22) PCT Filed: Oct. 9, 2017
(86) PCT No.: PCT/US2017/055732

§ 371 Date: Apr. 1, 2019

Related U.S. Application Data
(60) Provisional application No. 62/405,693, filed on Oct. 7, 2016.

(51) Int. Cl. H01M 4/36; H01M 4/587; H01M 4/38; H01M 10/0525; H01M 4/62

(52) U.S. Cl. CPC H01M 4/366; H01M 4/587; H01M 4/628; H01M 10/0525; H01M 4/386

(57) ABSTRACT

The present invention provides micron or submicron particles (NPs) that are comprised of a variety of materials, including Group IVA elements such as silicon (Si) that are known to have a high electrochemical capacity in Li-ion secondary batteries. The micron or sub-micron particles of the invention are provided with a surface layer, or surface modification, that imparts additional functionality to the particle. Surface modification prevents the formation of a dielectric oxide layer on the primary Group IV A particles, allowing elements of the surface modifier to covalently bond directly to the Group IV A elements, accommodates volumetric expansion to help mitigate ingress of electrolyte solvents from penetrating the surface modifier, mitigates disruption of SEI layers formed during electrochemical cycling and provides favorable surface properties to allow the formation of strong bonding to binders and other materials in the electrode composite. The NPs can be combined with graphite particles to create a composite graphite particle that can be used for battery anodes.

### CROSS-REFERENCE TO RELATED APPLICATION(S)

This application claims the benefit of U.S. Provisional Patent Application No. 62/405,693, filed on Oct. 7, 2016, herein incorporated by reference in its entirety.

### SUMMARY

Since Silicon (Si) has ten times the gravimetric capacity to store Lithium (Li) compared to graphite, it has been pursued by battery manufacturers as a Li-active material for Lithium Ion Battery (LIB) negative electrodes. However, the volume changes of Si during lithiation and de-lithiation creates excessive solid-electrolyte interphase (SEI) surrounding the particles, loss of electrical contacts, impeded Li⁺ mobility, and capacity fade.

This present invention provides electrochemically active micron and submicron particles that are coated or combined with graphite to produce composites with enhanced performance in battery negative electrodes.

The present invention relates generally to the formation of various particles that can be used as materials for battery anodes. The present invention provides micron or submicron particles (NPs) that are comprised of a variety of materials, including Group IVA elements such as silicon (Si) that are known to have a high electrochemical capacity in Li-ion secondary batteries. The micron or sub-micron particles of the invention are provided with a surface layer, or surface modification, that imparts additional functionality to the particle. Surface modification prevents the formation of a dielectric oxide layer on the primary Group IVA particles, allowing elements of the surface modifier to covalently bond directly to the Group IVA elements. The surface modifier can prevent the formation of excessive solid electrolyte interphase (SEI) due to volumetric expansion of the Group IV particles by forming an impermeable barrier to electrolyte solvent. The inventors of the present application have previously developed a flexible, scalable process (U.S. Pat. No. 9,461,304, herein incorporated by reference) to produce sub-micron surface-modified and non-surface modified silicon particles (U.S. Pat. No. 9,461,309). By employing this general process, it is possible to produce sub-micron surface modified or non-surface particles, such as modified Si particles (SiNPs). The present invention provides additional methodology where such particles are further treated by methods wherein the particles are coated or contain surface modifiers wherein the particles are shielded by the surface modification or coating.

The invention also comprises graphite composite particles comprising graphite and the micron or sub-micron Group IVA particles that are surface modified. In one aspect of the invention, the invention provides micron-sized spherical graphite (SG) formed from Flake Natural Graphite (FNG) or synthetic graphite particles that have been combined with micron and/or sub-micron electrochemically active particles. The submicron particle or nanoparticle is electrochemically active with the active battery ion increasing the overall negative electrode capacity above the theoretical capacity of a pure graphite electrode. This composite negative electrode would then be used in rechargeable batteries including, but not limited to, Li⁺ (lithium-ion), Na⁺, Mg²⁺, K⁺, Al³⁺, Zn²⁺, etc. The nanoparticle could be Si, Sn, Co, Al, Fe, Ti, Ge, Pb etc.; an oxide, nitride, or hydride etc.; or a group IVA alloy comprising several elements.

In the present invention, methods of combining electrochemically active micron or submicron particles (NPs) with graphite during the manufacture of SG are described. It should be understood that the submicron NPs may be coated with a functional layer prior to combining with graphite. One possible method of forming this composite is to combine NPs with graphite flakes at the start of the spheronization process. This method would result in NPs imbedded in the surface and trapped between layers in the graphite particle that has been abraded into a round or potato-like shape. This structure would be beneficial to control the volumetric expansion of the NP during charge and discharge cycles.

In a different embodiment, flake graphite would be processed with Si NPs. The resulting product would then be composed of graphite with Si NP that could be spheronized and coated by typical process. This material then would be used as a negative electrode for a LIB (or other rechargeable battery) with higher capacity.

In some embodiments, uncoated SG particles may be prepared according to the general scheme represented by the first three steps in FIG. 1. The cost of this multi-step process has prevented most graphite producers from producing SG for a market that until recently was very small. However, with the recognition from battery manufacturers that SG has clear performance benefits in LIBs, and with the increasing production of LIBs, demand for SG has increased. Optionally, additional process steps may be desired to produce highly purified SG particles. In either case, the SG particles may be combined with NPs by the following methods.

In one embodiment, the graphite particles may be stirred into a NP slurry produced by bead milling. A surface modifier applied to the NP in the bead milling process would be selected such that the surface properties of the NP would be compatible with the solvent and the graphite particles to avoid agglomeration of the NP and uniform distribution of the NPs with graphite. Upon thorough mixing, the solvent will be evaporated from the slurry. This process will allow thorough dispersion of the NPs on the graphite surfaces and they will become bonded to, embedded into pores or crevices on the surfaces of the graphite. This process can be applied to graphite before or after spheronization (see FIGS. 2-4).

In another embodiment, SG and NP powders may be combined in their desired proportions by tumbling in a vessel under air or inert atmosphere. Optionally, a chemical vapor may be introduced into the vessel by slowly purging the vessel with the vapor in the inert gas while the vessel is agitated. Exposure of the NP and SG surfaces to the vapor will allow the vapor to become adsorbed, or in some cases, to become chemically bonded to the particles' surfaces.

In another embodiment, the SG and NPs can be mixed together in their desired proportions and stirred in a light solvent. Optionally, additional solvent and a monomer or polymer may be dissolved or dispersed in the solvent to serve as a binder or a passivation layer to protect the particle surfaces. Providing that the solvent has a sufficiently low boiling range, the solvent can be evaporated by heating and evacuation, leaving behind the solid SG particles with NPs well-dispersed on the SG surfaces.

In still another embodiment, electrochemically active material may be added to the NPs to some extent. For example, Si NPs used in LIB negative electrodes could be prelithiated. Optionally, additional hydrocarbons may be added either in solution or in gas phase (as described above) to further passivate the SiNPs and to provide a protective barrier that prevents solvents from reacting with active lithium and to stabilize all particle surfaces.

In another embodiment, a porous graphite network is formed prior to surface coating. The porous network can be formed during formation of the spherical graphite particle or after formation of spherical graphite particle through the use of pore formers, which can be removed through heating, leaching, or any other method. The pores with passage openings of about 30 to about 900 nm allow access to nanoparticles capable of reversibly intercalating and de-intercalating Li⁺, Na⁺, Mg²⁺, and other metal ions, i.e. nanoparticles composed of Group IVA particles and/or alloy-based composites including, but not limited, to silicon, silicon oxide, germanium, tin, iron, titanium oxide, etc. Nanoparticles less than about 600 nm in size can enter these porous cavities. The pores allow room for the host nanoparticle to expand and contract as electrochemically active metal ions, such as Li⁺, insert and de-insert in the host nanoparticle. This particle will then be coated with a surface layer that is permeable by the electrochemically active metal ion, but the surface layer impedes ingress of electrolyte solvents that can decompose to form SEI. This spherical coated graphite impregnated with Group IVA particles or alloy composites, including but not limited to silicon or other host nanoparticles, represented by FIG. 4 can then be used in a negative electrode battery composite.

In another embodiment, the host NP can be coated with surface layer that will allow the NP to be evenly dispersed in a graphite precursor fluid. Upon heat processing, the composite is converted to synthetic graphite with the host NPs embedded throughout the graphite composite. The graphite/NP composite can then be milled and classified to the appropriate dimension and then spheronized as described previously. Alternatively, the graphite precursor and NP fluid can be spray-dried to form the ideal sized particles, thus forgoing the step for spheronization by abrasion.

In summary, spherical graphite (SG) formed from natural flake graphite has been recognized as very high performing intercalation material, demonstrated by its widespread use in lithium-ion battery (LIB) negative electrode composites. High performance batteries with long cycle life require anode materials with high electrochemical specific capacity, optimal particle size and shape, low reactivity with electrolyte, and high purity. High capacity alloying materials, such as Group IVA elements (Si, Ge, Sn) have also been used as active materials in negative electrodes. Managing cycle stability, particularly in Si-containing negative electrode composites in LIBs, has been notoriously difficult due in part to large volumetric changes during electrochemical cycling. This invention describes, among other things, methods to embed sub-micron electrochemically active particles in SG during the production of SG. Additionally, it covers the embedding of submicron Group IVA elements in porous graphite, which is then formed into SG. This allows for the submicron particle to expand and contract during cycling protected by a continuous layer that mitigates contact with electrolyte solvents, thus mitigating the formation of excess SEI and leading higher cycle efficiency and to higher performance batteries. The unique architecture of these particles contributes to greater charge density compared to graphite and better cycle stability in secondary batteries, including Li-ion batteries.

### BRIEF DESCRIPTION OF THE DRAWINGS

FIG. 1 depicts a generalized process scheme showing steps in the production of spherical graphite from flake natural graphite.

FIG. 2 depicts a graphical representation of NP coverage on the outer surface of a graphite particle with a coating covering both the NP and SG particles.

FIG. 3 depicts a graphical representation of NP coverage imbedded in the surface of a graphite particle with a coating covering both the NP and SG particles.

FIG. 4 depicts a graphical representation of NP coverage imbedded in pores and crevices within a graphite particle with a coating covering both the NP and SG particles.

FIG. 5 depicts an Energy Dispersive X-ray Spectrum showing resolved K-alpha signals that include Si, O, and C.

FIG. 6 depicts an SEM image ofnc-Si particles functionalized with benzene.

FIG. 7 depicts an Energy Dispersive X-ray Spectrum of benzene functionalized nc-Si (about 300 nm) following removal of excess benzene.

FIG. 8 depicts an FTIR spectrum ofnc-Si particles functionalized with benzene.

FIG. 9 depicts a TGA scan of benzene passivated nc-Si (estimated APS about 300 nm or less) at 30° C./min.

FIG. 10 depicts a TGA scan of benzene passivated nc-Si (estimated APS about 300 nm or less) at 10° C./min.

FIG. 11 depicts a charge/discharge plot.

FIG. 12 depicts a charge/discharge plot.

FIG. 13 depicts a charge capacity plot.

FIG. 14 depicts a charge/discharge plot.

FIG. 15 depicts a charge capacity plot.

FIG. 16 depicts a charge/discharge plot.

FIG. 17 depicts a charge capacity plot.

FIG. 18 depicts a charge/discharge plot.

FIG. 19 depicts a charge capacity plot.

FIG. 20 depicts a charge/discharge plot.

FIG. 21 depicts a charge capacity plot.

FIG. 22 depicts a charge/discharge plot.

FIG. 23 depicts a charge capacity plot.

FIG. 24 depicts a charge/discharge plot.

FIG. 25 depicts a charge capacity plot.

FIG. 26 depicts a charge/discharge plot.

FIG. 27 depicts a charge/discharge plot.

FIG. 28 depicts a charge/discharge plot.

FIG. 29 depicts a charge/discharge plot.

FIG. 30 depicts a comparison of lithium ion batteries prepared with anodes including functionalized Group IVA particles versus batteries prepared with a standard carbon based anode.

FIG. 31 depicts a correlation between resistance and specific charge capacity.

FIG. 32 depicts charge/discharge cycles for a Si-NP negative electrode composite with graphite and Li PA polymer made from aqueous slurry. The negative electrode was paired with a NCM523 counter electrode, with both referenced to a Li reference electrode.

FIG. 33 depicts charge/discharge cycles for the disclosed Si-NP negative electrode composite with graphite and PVDF polymer made in NMP solvent. The negative electrode was paired with a NCM523 counter electrode, with both referenced to a Li reference electrode.

FIG. 34 depicts an SEID diagram corresponding to FIG. 33.

FIG. 35 depicts a particle size distribution measured from SiNP that have been milled in benzene with the average particle size distribution (D50)=176 nm measured by dynamic light scattering (DLS).

FIG. 36 depicts the SEM image of benzene functionalized nc-Si.

FIG. 37 depicts an FTIR spectrum of nc-Si particles functionalized with benzene.

FIG. 38 depicts the result of energy dispersive x-ray analysis (EDXA) of the benzene functionalized nc-Si particles.

FIG. 39 depicts a TGA scan of the benzene functionalized nc-Si particles heated in air at a rate of 30° C./min. up to 900° C.

FIG. 40 depicts a TGA scan of the benzene functionalized nc-Si particles heated in air at 10° C./min. up to 500° C.

FIG. 41 depicts the particle size distribution measured by DLS of SiNP material made as described in example 2; APSD (D50)=133 nm.

FIG. 42 depicts a first discharge/charge cycle of the Li half-cell electrode made from the CNFG composite with 85% NFG and 15% SiNP with LiPAA binder.

FIG. 43 depicts a plot from Li half-cell cycled at C/3 comparing electrodes made from flake natural graphite and an 85:15 graphite/SiNP mixture uncoated vs. coated.

FIG. 44 is a representation of the process scheme for combining SiNP with graphite, spheronization and coating of spherical graphite.

FIG. 45 is an SEM image shown of flake natural graphite with SM Si (15 wt %) coated with polyacrylamide. The dispersion was done in and alkane slurry. SiNP is shown on the surface and in places it appear to be accumulated in high concentrations, especially around crevices in the graphite.

FIG. 46 is an SEM image shown of flake natural graphite with SiNP dispersed and coated with a thin polymer coating derived from propylene.

FIG. 47 Table summarizing heat treatment conditions and electrochemical performance of electrodes derived from examples 3-14.

FIG. 48 Depicts the first particle (NP) coated with a primary coating and a secondary coating that shields the first layer from electrolyte solvent. SEI forms only on the second layer.

FIG. 49 depicts the first particle (NP) coated with a primary coating and a secondary coating that shields the first layer from electrolyte solvent. The first particles are dispersed on a graphite surface also coated with the second layer. SEI forms only on the second layer.

FIG. 50 depicts the first particle (NP) coated with a primary coating and a secondary coating that shields the first layer from electrolyte solvent. The first particles are dispersed on a graphite surface that was previously coated. SEI forms only on the second layer and on the graphite coating.

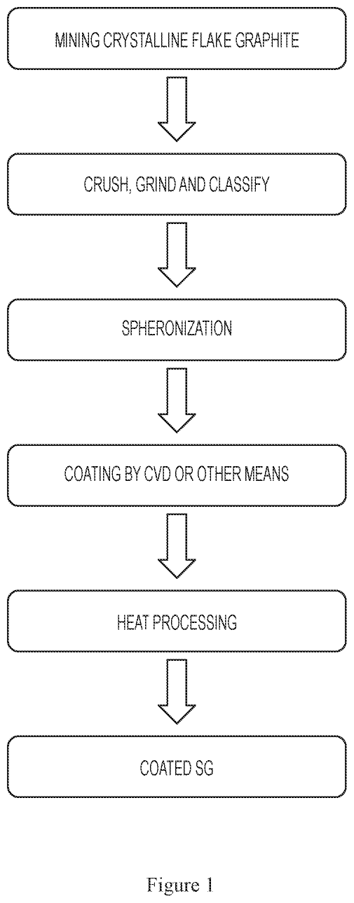

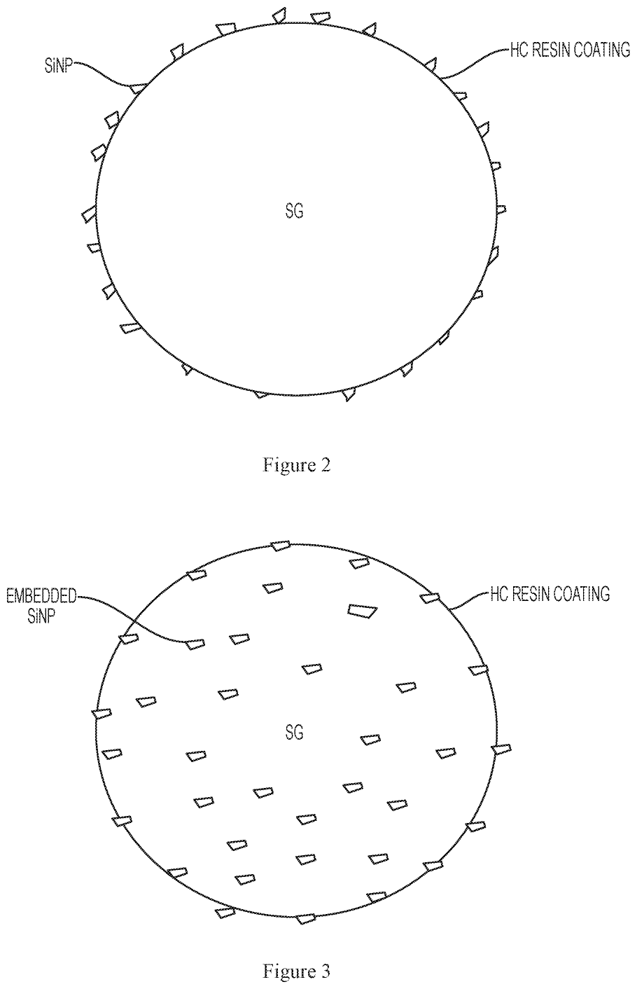

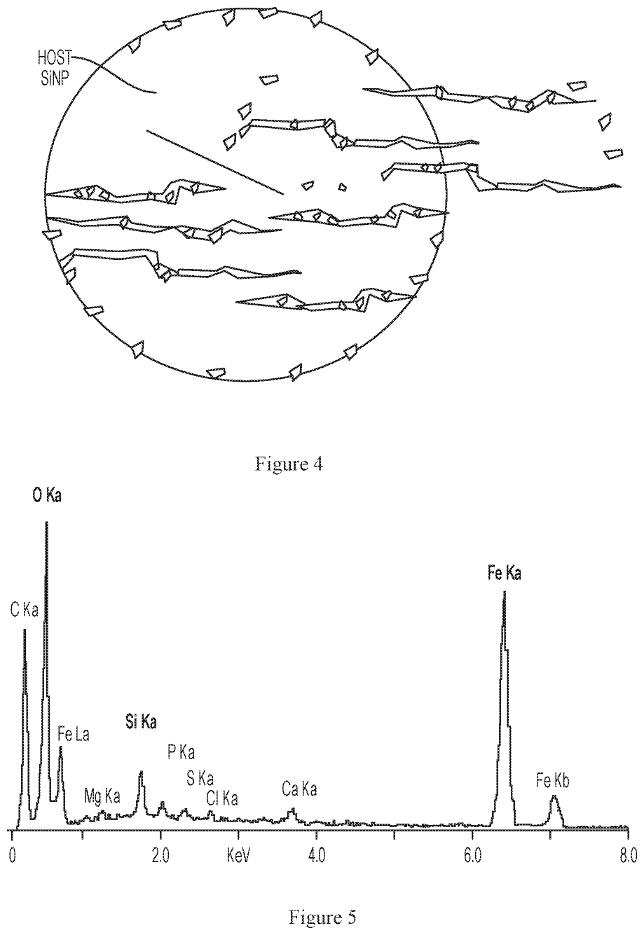

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In one embodiment, the invention provides graphite composite particles and methods of making the graphite composite particles. In one embodiment the method of making the graphite composite particles is where first particles are combined with graphite particles to provide graphite composite particles wherein the first particles are embedded on the surface or in pores of the graphite particles. To be “embedded” can mean that the first particles are either embedded, captured, trapped or becomes lodged on the surface or in the pores or crevices of the graphite particles.

In one embodiment the first particles can have a core material comprising silicon, silicon oxide (SiOₓ where x is <2), germanium, tin, lead, iron, aluminum, lithium, cobalt, or an alloy of any combination of any one or more of silicon, germanium, tin, lead, iron, aluminum, lithium or cobalt and the individual particles can have a dimension of between 15 nm-500 nm, or more suitably 100-150 nm, the dimension measurement being the measurement of the narrowest girth of the particle. In certain embodiments the graphite particles that are combined with the first particles can consist of flake natural graphite, spherical graphite or synthetic graphite. In certain embodiments that graphite particles can have pore openings that typically range in size of 200-1000 nm, where the size of the pore openings is measured by the narrowest distance across the pore perpendicular to the surface of the graphite particle. In certain embodiments the graphite particle size distribution is between 2000 nm-40000 nm, the size being the narrowest girth of the particles. In certain embodiments the first particles are embedded in the graphite particles such that in the graphite composite particle, suitably 5-25 wt % of the graphite composite particle consists of the first particle, with remaining wt % being the graphite particle. In other embodiments, the first particles are embedded in the graphite particles such that in the graphite composite particle, suitably 25-50 wt % of the graphite composite particle consists of the first particle, with remaining wt % being the graphite particle.

The invention discloses a number of embodiments in how the first particles are combined with the graphite particles. In one embodiment, the first particles are combined with the graphite particles in a turbulent mixer capable of homogenizing dry powders without causing significant changes in particle shapes or size distributions. In another embodiment, the first particles are combined with the graphite particles in a dry spheronization process, such as those known in the art, in which the graphite particle becomes abraded and captures the first particle on the surface or within pore openings in the surface of the graphite particle. In another embodiment, first particles are combined with spheronized graphite particles, where the particles are combined during a classifying step in which the spheronized graphite particles are fluidized in a gas with the first particles, such that the first particles collide and become embedded on the surface or within pores in the graphite particles. Suitable gasses include nitrogen, argon, forming gas (argon or nitrogen blended with hydrogen, typically 3-5% in hydrogen), natural gas (methane, ethane or other light gaseous hydrocarbons), air or a blend of any of these gases. In another embodiment, the first particles are combined with the graphite particles by combining the first particles with the graphite particles in a planetary centrifugal mixer. In another embodiment, the first particles are combined with the graphite particles by stirring them together in a solvent, optionally with sonication, followed by evaporation of the solvent. Suitably any solvent can be used, including to include, but not limited to alkanes and cycloalkanes (such as pentanes, hexanes, heptanes octanes) tetrahydrofuran (THF), dimethylformamide (DMF), chlorinated solvents (such as dichloromethane or 1,2-dichloroethane), toluene, In another embodiment, first particles are combined with a synthetic graphite precursor, where following the combination the particles are subjected to heat processing to graphitize the precursor and surrounding the first particle within the synthetic graphite. Any known heat treatment process to create crystalline (synthetic) graphite can be used, including heat treatments between 1,200-3,000° C.

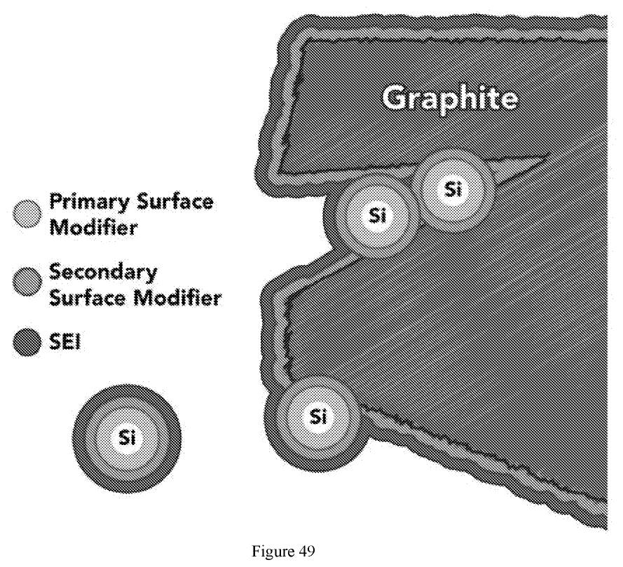

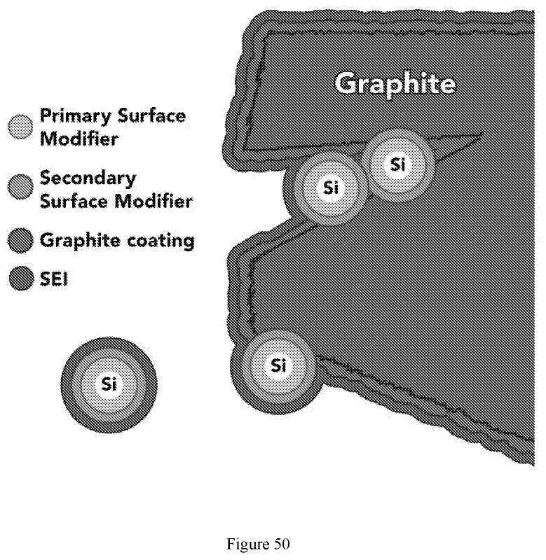

In certain embodiments, the graphite particles may have a coating applied prior to combining with the first particles. In this case, prior to combining the first particles with the coated graphite, the first particles are coated with a secondary layer that can be chemically bonded to the primary surface coating. In doing so, the primary particles have and additional surface layer that prevents electrolyte solvent from penetrating to the first layer and in some cases clusters of Si particles may be formed that are joined by the secondary layer in addition to separate NPs of the first particle coated by a primary and a secondary layer. In this embodiment, the first particles would then be combined with the coated graphite by any of the methods described in this invention with no additional coating applied. This embodiment is represented by FIGS. 48-50.

In other embodiments of the invention, the composite graphite particles provided can have a coating, and the invention provides methods for coating the composite graphite particles. In certain embodiments, that composite graphite particles are coated by with a compound by chemical vapor deposition. The compound can be any compound desired, including a light alkene or alkyne such as ethylene, propylene or acetylene, styrene, neoprene, butenes, butadiene, pentenes, pentadiene, organic carbonates, fluorinated alkenes, 1H, 1H, 2H-pefluoroalkenes (wherein the alkene is C3-C12). In certain embodiments in the vapor deposition process a peroxide can be used as a radical initiator, such as tert-butyl peroxide or an organic titanate (eg. titanium iso-propoxide) and the alkene or alkyne that can be entrained in the gas phase and allowed to come into contact with the graphite particles and embedded first particles. In another embodiment, the graphite composite particles are coated by stirring and optionally sonicating the graphite composite particle together in a solution with solvated polymer, followed by evaporation of the solvent. This process may be done in vacuo. A radical initiator may also be used as a catalyst. The particles can be stirred in an appropriate solvent that would dissolve the polymer. Suitable solvated polymers include polyacrylonitrile (PAN) in n,n-dimethylformamide (DMF), or polyethylene-co-acrylic acid in THF, or polymethyl methacrylate (PMMA) in THF, or polystyrene in THF. In another embodiment the graphite composite particles are coated by stirring the graphite composite particle in a solvent with a reagent or combination of reagents that form(s) a polymer, followed by evaporation of the solvent. This process can also be done in vacuo. In another aspect of the invention, the coated graphite composite particle is subjected to a heat treatment process to cure the coating. Curing in this context means to reduce the hydrocarbon coating of the coated graphite composite particle to a carbon shell. Suitable high temperatures include temperatures in the range of 400-1500 degrees C. and this heat treatment must be done in an inert atmosphere (such as in Ar or N2 gas). The coated graphite composite particles can also be subjected to a process to induce cross-link coupling of the coating constituents, such as by introducing the coated graphite composite particles to lower heated temperatures, such as between 120-250 degrees C. This can be done under inert atmosphere, formation gas (such as Ar/H2 95:5), or depending on the coating in may be done in air or in a vacuum.

The first particles present in the composite graphite particles, and used in the methods of making the composite graphite particles can have other specific features envisioned by in the invention. In one embodiment, the first particle is passivated by a non-dielectric layer covering at least a portion of a surface of the first particle. The non-dielectric layer can be formed from a wide variety of compounds or elements including hydrogen (H₂), alkenes, alkynes, aromatics, heteroaromatics, cycloalkenes, alcohols, glycols, thiols, disulfides, amines, amides, pyridines, pyrroles, furans, thiophenes, cyanates, isocyanates, isothiocyanates, ketones, carboxylic acids, amino acids, aldehydes, 1,2-dimethoxyethane (also referred to as glyme, monoglyme, dimethyl glycol, or dimethyl cellosolve); 1-methoxy-2-(2-methoxyethoxy)ethane (also referred to as diglyme, 2-methoxyethyl ether, di(2-methoxyethyl)ether, or diethylene glycol dimethyl ether); 1,2-bis(2-methoxyethoxy)ethane (also referred to as triglyme, triethylene glycol dimethyl ether, 2,5,8,11-tetraoxadodecane, 1,2-bis(2-methoxyethoxy)ethane, or dimethyltriglycol); 2,5,8,11,14-pentaoxapentadecane (also referred to as tetraglyme, tetraethylene glycol dimethyl ether, bis[2-(2-methoxyethoxy)ethyl]ether, or dimethoxytetraglycol); dimethoxymethane (also referred to as methylal); methoxyethane (also referred to as ethyl methyl ether); methyl tert-butyl ether (also referred to as MTBE); diethyl ether; diisopropyl ether; di-tert-butyl ether; ethyl tert-butyl ether; dioxane; furan; tetrahydrofuran; 2-methyltetrahydrofuran; diphenyl ether, toluene, benzene, a polycyclic aromatic, a fullerene, a metallofullerene, a styrene, a cyclooctatetraene, a norbomadiene, a primary alkene, a primary alkyne, a saturated or unsaturated fatty acid, a peptide, a protein, an enzyme, 2,3,6,7-tetrahydroxyanthracene, catechol, 2,3-hydroxynaphthalene, 9,10-dibromoanthracene, terephthalaldehyde, dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), sulfalone, polyaramids, PAN, polyacrylic acid (PAA) and its neutralized salt, MPAA (M=Li, Na or K), polyethylene oxide (PEO), poly(methyl methacrylate) (PMMA), carboxymethyl cellulose (CMC), polyaniline (PANI), polyimide (PI), poly(ethylene-co-acrylic acid) (PEAA), cellulose, monosaccharides, polysaccharides, metal-oxides, titanium isopropoxide (Ti(i-OPr)4, where OPr═OC₃H₇), and aluminum isopropoxide (Al(i-OPr)₃), carboxylates, EC, EMC, DMC, MEC, FEC DFEC, vinylene carbonate, perfluoroalkyl ethylene carbonates, perfluoroalkenes (C2-C12) and 1H,H1,H2-perfluoroalkenes (C3-C12), p-phenylenediamine, succinamide, phenylene diamines (o-, m- and p-analogs) and alkyldiamides ranging from C2-C12.

In certain embodiments, the first particle has an outer surface that is substantially free of silicon oxide species, as characterized by X-ray photoelectron spectroscopy (XPS). In certain embodiments, the first particle has a SiOₓ content of less than or equal to 1%, as characterized by X-ray photoelectron spectroscopy (XPS), wherein x is ≤2.

In other embodiments, the core material of the first particle further comprises: one or more elements used for p-type semiconductor doping, such as boron, aluminum, and gallium; one or more elements used for n-type semiconductor doping, such as nitrogen, phosphorous, arsenic, and antimony; one or more elements found in metallurgical silicon, such as aluminum, calcium, titanium, iron, and copper; one or more conductive metals such as aluminum, nickel, iron, copper, molybdenum, zinc, silver, and gold; or any combination of the foregoing components.

In other embodiments, the core material of the first particle is free of p-type and n-type semiconductor doping elements.

In other embodiments, the core material of the first particle has an outer surface modified with one or more surface-modifying agents, wherein the surface-modifying agent is benzene, mesitylene, xylene, 2,3-dihydroxynaphthalene, 2,3-dihydroxyanthracene, 9,10-phenanthrenequinone, 2,3-dihydroxytetracene, fluorine substituted 2,3-dihydroxytetracene, trifluromethyl substituted 2,3-dihydroxytetracene, 2,3-dihydroxypentacene, fluorine substituted 2,3-dihydroxypentacene, trifluromethyl substituted 2,3-dihydroxypentacene, pentacene, fluorine substituted pentacene, naphthalene, anthracene, pyrene, perylene, triphenylene, chrysene, phenanthrene, azulene, pentacene, pyrene, a polythiophene, poly(3-hexylthiophene-2,5-diyl), poly(3-hexylthiophene), polyvinylidene fluoride, a polyacrylonitrile, polyaniline crosslinked with phytic acid, single wall carbon nanotubes, multi-walled carbon nanotubes, C60 fullerenes, C70 fullerenes, nanospherical carbon, graphene, graphite nanoplatelets, carbon black, soot, carbonized conductive carbon, or any combination thereof.

In other embodiments the first particle is an alloy of the core material and lithium, and the first particle alloy is coated with a continuous coating on the surface of the first alloy particle with one or more surface-modifying agents, the surface-modifying agent is a polymer or a monomer additive. In certain embodiments, the polymer additive may be polystyrene, polyacrylonitrile, polyacrylic acid, lithium polyacrylate, polyaramides, or polyaniline. In certain embodiments that the monomer additive may consist of alkenes, alkynes, aromatics, heteroaromatics, cycloalkenes, alcohols, glycols, polyglycols, ethers, polyethers, thiols, disulfides, amines, amides, pyridines, pyrroles, imides, imidazoles, imidazoline, furans, thiophenes, cyanates, isocyanates, isothiocyanates, ketones, carboxylic acids, esters, amino acids, aldehydes, acrylates, methacrylates, oxylates, organic carbonates, lactones, and the gases H₂, O₂, CO₂, N₂O, and HF, or fluorinated analogs thereof. In certain embodiments the continuous coating of the first particle forms a protective shell capable of impeding diffusion of oxygen and/or water to cores of the first particle alloy, wherein the continuous coating is capable of allowing Li+ ion mobility and/or facilitate electrical charge transfer from the first particle alloy to an electrode current collector. Another function of the continuous coating, which can be applied to the first particle and can also be applied to the graphite particle after imbedding the first particle on the graphite surface is to provide a protective layer that impedes ingress of electrolyte solvents around the region of the first particle and mitigates the formation of excessive SEI caused by volumetric expansion of the active GroupIVA particles.

The present invention encompasses a graphite composite particle made by any of the methods detailed in the application. In one such embodiment, the graphite composite particle comprises a first particle, wherein the first particle has a core material comprising silicon, silicon oxide (SiOx where x is <2), germanium, tin, lead, iron, aluminum, lithium, cobalt, or an alloy of any combination of any one or more of silicon, germanium, tin, lead, iron, aluminum, lithium or cobalt; and a graphite particle, wherein the first particle is embedded on the surface or in a pore of the graphite particle.

In other embodiments of the invention, the invention provides methods of making a coated nanoparticle comprising providing a first particle, wherein the first particle has a core material comprising silicon, silicon oxide (SiOx where x is <2), germanium, tin, lead, iron, aluminum, lithium, cobalt, or an alloy of any combination of any one or more of silicon, germanium, tin, lead, iron, aluminum, lithium or cobalt. The nanoparticle is then passivated by coating it with a non-dielectric layer covering the surface of nanoparticle, or with a surface modifying agent. This nanoparticle is then coated in its entirety by a variety of processes. In certain embodiments, the nanoparticles are coated by with a compound by chemical vapor deposition. The compound can be any compound desired, including a light alkene or alkyne such as ethylene, propylene or acetylene, styrene, neoprene, butenes, butadiene, pentenes, pentadiene, organic carbonates, fluorinated alkenes, 1H, 1H, 2H-pefluoroalkenes (wherein the alkene is C3-C12). In certain embodiments in the vapor deposition process a peroxide can be used as a radical initiator, such as tert-butyl peroxide or an organic titanate (eg. titanium iso-propoxide) and the alkene or alkyne that can be entrained in the gas phase and allowed to come into contact with the nanoparticles. In another embodiment, the nanoparticles are coated by stirring and optionally sonicating the particles together in a solution with solvated polymer, followed by evaporation of the solvent. This process may be done in vacuo. A radical initiator may also be used as a catalyst. The particles can be stirred in an appropriate solvent that would dissolve the polymer. Suitable solvated polymers include polyacrylonitrile (PAN) in n,n-dimethylformamide (DMF), or polyethylene-co-acrylic acid in THF, or polymethyl methacrylate (PMMA) in THF, or polystyrene in THF. In another embodiment the nanoparticles particles are coated by stirring the particles in a solvent with a reagent or combination of reagents that form(s) a polymer, followed by evaporation of the solvent. This process can also be done in vacuo. In another aspect of the invention, the coated nanoparticles particles are subjected to a heat treatment process to cure the coating. Curing in this context means to reduce the hydrocarbon coating of the coated graphite composite particle to a carbon shell. Suitable high temperatures include temperatures in the range of 400-1500 degrees C. and this heat treatment must be done in an inert atmosphere (such as in Ar or N2 gas). The coated graphite composite particles can also be subjected to a process to induce cross-link coupling of the coating constituents, such as by introducing the coated graphite composite particles to lower heated temperatures, such as between 120-250 degrees C. This can be done under inert atmosphere, formation gas (such as Ar/H2 95:5), or depending on the coating in may be done in air or in a vacuum.

The present invention encompasses coated nanoparticle made by any of the methods detailed in the application. In one such embodiment, the coated nanoparticle comprises a core material comprising silicon, silicon oxide (SiOx where x is <2), germanium, tin, lead, iron, aluminum, lithium, cobalt, or an alloy of any combination of any one or more of silicon, germanium, tin, lead, iron, aluminum, lithium or cobalt, a non-dielectric layer or a surface modifier covering the surface of the core material; and a coating covering particle (and the non-dielectric or surface modified layer) in its entirety.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present invention also contemplates other embodiments “comprising”, “consisting of”, and “consisting essentially of”, the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrase “at least one of A, B, . . . and N” or “at least one of A, B, . . . N, or combinations thereof” are defined in the broadest sense to mean one or more elements selected from the group comprising A, B, . . . and N, that is to say, any combination of one or more elements A, B, . . . or N including any one element alone or in combination with one or more of the other elements, which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4”. The term “about” may refer to plus or minus 10% of the indicated number. For example, “about 10%” may indicate a range of 9% to 11%, and “about 1%” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### Abbreviations

SEI=Solid Electrolyte Interphase formed from electrochemical decomposition of electrolyte solvents.

Nm=nanometer (100 nm=0.1 micron)

NP=Technically, nanoparticles are defined to be particles of 100 nm or less. However, it is common to see reference to particles of several hundred nm referred to as nanoparticles. It would be technically correct to call them submicron particles whenever possible. That would include all particles less than 1 micron (1,000 nm).

CVD=chemical vapor deposition.

LIB=Lithium-Ion Battery

SG=Spherical Graphite (this does not distinguish between natural or artificial graphite. Either source can be spheronized)

NFG=Natural Flake graphite

1H,1H,2H-perfluoroalkanes=These are fluoroalkenes with a double bond between the first two carbon atoms (C1 and C2) and hydrogen on C1 and C2 and F atoms only on every other carbon atom in the carbon chain.

i.e. 1H,1H,2H-pefluorooctene is: CH2=CH-CF2-CF2-CF2-CF2-CF2-CF3

FTI=Fourier Transform InfraRed

EDXA=Energy Dispersive X-ray Analysis

SEM=Scanning Electron Microscope

XPS=X-ray Photoelectron Spectroscopy

TGA=ThermoGravimetric Analysis

DLS=Dynamic Light Scattering (technique for measuring particle size distributions by measuring Brownian motion)

PSD=Particle Size Distribution

APSD=Average PSD (one metric that is often given as D50 or the diameter of particles in the distribution that marks 50% of the particle volume. In other words, 50% by volume of the particles in the distribution are smaller than the D50 size.)

PAA=poly(acrylic acid)

LiPAA=The Li+ salt of PAA

PAN=Poly(acrylonitrile)

PMMA=Poly(methylmethacrylate)

EC=ethylene carbonate

FEC=Fluoroethene carbonate

DMC=Dimethyl carbonate

DEC=Diethyl carbonate

DMF=dimethyl formamide

THF=tetrahydrofuran

### EXAMPLES

It should be kept in mind that the following described embodiments are only presented by way of example and should not be construed as limiting the inventive concept to any particular physical configuration.

### Example 1

### Toluene Passivated Silicon Particles

In one example, p-type silicon wafers with measured resistivity of 2-4 ohm/cm² were crushed, then ground with mortar and pestle, then passed through a #60 mesh sieve. The powder was further reduced to submicron particles with a ball mill. In 40 gram batches, the submicron silicon powder was added to a 250 mL polypropylene container with 100 mL of muriatic acid and 4-8 ceramic balls (12 mm dia.). The screw-top lid was closed and the container was turned on a rolling mill at 60 rpm for two hours. Pressure buildup in the container caused the container to bulge. In some instances where larger quantities or lower grades of silicon were treated, the container was subject to bursting due to the buildup of H₂ gas. After two hours of agitation on the roller mill, the bottle was allowed to stand for another two hours motionless. The bottle was carefully opened with the release of pressure and the liquid was drawn from the container above the solid in the bottle via syringe. Another 100 mL of fresh muriatic acid was added and the bottle closed and rolled for another 2-hour period followed by a 2-4 hour period of standing in an upright position. The bottle was opened again with release of much less pressure than after the initial acid treatment. The aqueous liquid portion was carefully drawn from the solid as before. The decanted liquid was noticeably clearer than the liquid drawn from the first acid treatment. After thoroughly decanting the aqueous liquid, 100 mL of toluene was added to the solid, the screw-top lid was replaced and the bottle was rolled again for 4-6 hours with the ceramic balls remaining in the container for agitation. After allowing at least 1 hour for settling, the lid was opened with little to no pressure released from the vessel and liquid was drawn away followed by another 100 mL portion of toluene added to the vessel. The vessel was again rolled to agitate the silicon powder in toluene for another 4-6 hours before allowing the mixture to settle and opening the vessel to remove the liquid toluene via syringe. The remaining toluene was removed by evaporation assisted by reduced pressure at room temperature.

Following a similar procedure, other hydrocarbon passivated micron- to nano-sized particles can be created using n-type Group IVA wafers, or wafers with higher or lower resistivity or bulk MG Group IVA ingot material. The amounts of material treated can vary depending on the grade of the bulk material and size and burst strength of polypropylene or polyethylene container used.

### Example 2

### Benzene Passivated Silicon Particles

In another example, following the identical milling procedure describe of Example 1, benzene (C₆H₆) was instead used as the passivating hydrocarbon in place of toluene. Applied similarly, benzene may be replaced in subsequent reactions by other hydrocarbons with more strongly bonding functional groups. Benzene is one of few organic hydrocarbons that will bond reversibly to silicon surfaces. Thus, benzene passivated Group IVA material is a convenient stable intermediate to use for introducing other functional hydrocarbons on to the particle surface. This is one of few forms of Group IVA material in which thermodynamics plays an important role in the surface chemistry as opposed to be being dominated by kinetics.

In another example, wafers of three different types of silicon were ground to specification. Benzene was the solvent used during the grinding process, but oxygen and trace amounts of water were not excluded. The three types of silicon were (i) phosphorus-doped silicon (i.e., n-type silicon) with a manufacturer-specified resistivity of 0.4-0.6 Ωcm² (ii) boron-doped silicon (i.e., p-type silicon) with a manufacturer-specified resistivity of 0.014-0.017 Ωcm², and (iii) 99.5% pure intrinsic silicon. The average particle size (APS) of the ground, benzene-coated n-type silicon particles, measured by electron microscopy, was found to be less than 400 nm (<400 nm).

### Example 3

### Passivated Silicon Particles

In another example, 325 mesh Si powder was processed by a Netzsch Dynostar mill using 0.4-0.6 mm yttrium-stabilized zirconia beads in benzene. The solids loading of the Si-benzene slurry was 30-40 percent. Particle size distribution (PSD) analysis indicated that the average particle size (APS) was reduced to about 200 nm. Further processing to smaller APS required a change in grinding media to smaller bead size. Changing to 0.1 mm diameter beads or smaller will allow APS reduction to less than 100 nm. Below 100 nm, further APS reduction in benzene becomes difficult due to rapidly increasing viscosity of the slurry. Furthermore, following the APS reduction progress by light-scattering PSDA methods becomes difficult due to particle agglomeration.

Removal of benzene from submicron particles was accomplished by evaporation of benzene under reduced pressure. Care must be taken to provide heat to the vessel with the slurry to avoid freezing of the benzene. A 20 mm glass tube mated between the flask containing the Si/benzene slurry and a receiving flask for the solvent condensate by 24/40 ground glass joints allowed the solvent to be removed from the nano-silicon/benzene slurry. While pressure in the joined flasks was briefly, but repeatedly reduced via vacuum, care was taken not to apply too much dynamic vacuum as solvent vapors easily sweep nano particles into the receiving flask when the velocity of those vapors is high.

On a laboratory scale, this method is adequate for isolation of the Group IVA particles from solvent slurries. In an industrial process, it may be more efficient to remove solvents by circulating dry nitrogen gas across heated evaporations plates covered with the slurry at near atmospheric pressure. The solvent saturated gas may be passed through a condenser to recover the solvents and restore the unsaturated gas for further recirculation. This process may minimize carryover of nanoparticles into the solvent condenser.

Characterization of the benzene passivated Si particles includes SEM, EDXA and TGA-MS. SEM images were used to measure individual particles and to gain more assurance that particle size measurements truly represent individual particles rather than clusters of crystallites. While SEM instruments also have the capability to perform Energy Dispersive X-ray Spectrometry (EDS), it is also possible with sufficiently small particle sizes that an elemental composition will confirm the presence of carbon and the absence of oxides through observance and absence respectively of their characteristic K-alpha signals. FIG. 5 is an EDS spectrum showing resolved K-alpha signals that include Si, O, and C. Iron and other metal impurities were added to demonstrate that they could also be observed and do not interfere with the observance of lighter elements.

### Average Particle Size (APS)

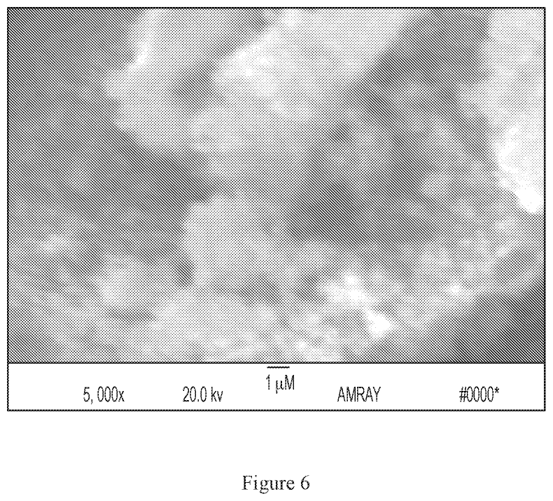

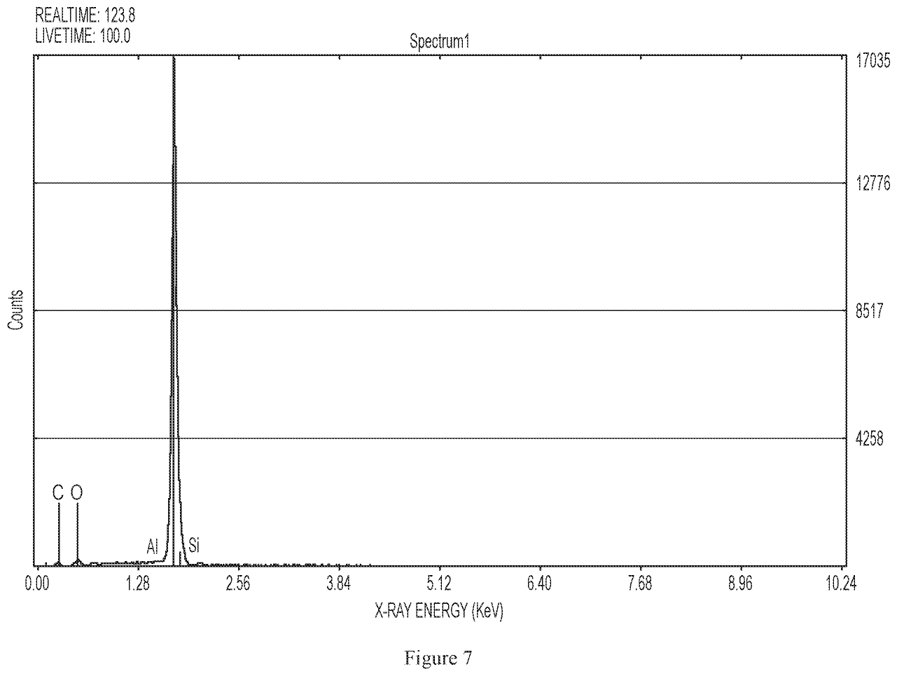

APS as determined by a Microtrac particle size was between 200 and 300 nm. Initial SEM images were recorded in addition to EDXA scans. While the initial SEM images were inadequate to resolve the particle size of the analyzed sample, the EDXA scan revealed good data that confirms the presence of hydrocarbon and minor oxidation (See FIGS. 6 and 7, respectively). The sample was mounted on an aluminum stub, so the signal in the position of Al K-alpha seen in the EDXA scan is most likely a contribution of the Al mounting stub. The image in FIG. 6 indicates that the APS is well below submicron range.

### Identification of Surface Organics

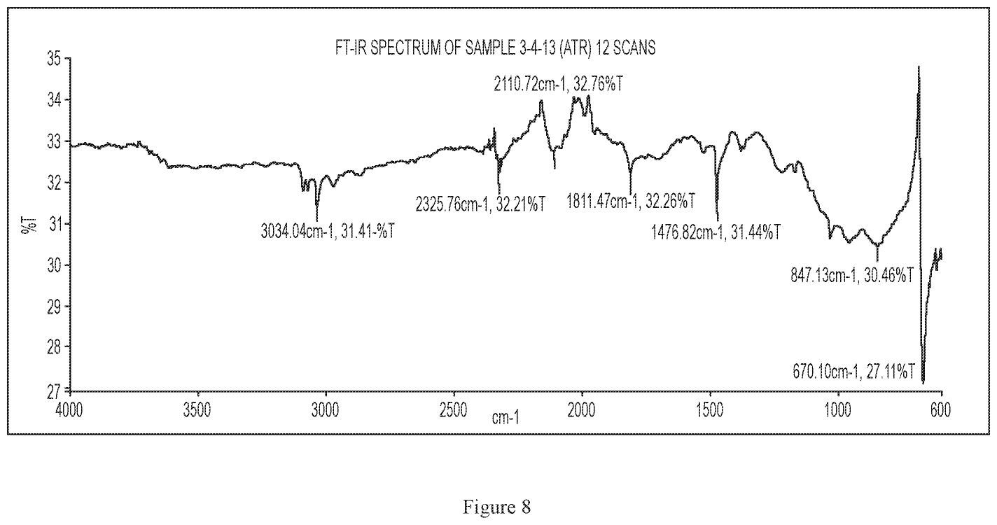

One qualitative test for surface organics is the measurement of a Fourier Transform InfraRed (FTIR) spectrum. FTIR measures modes of molecular vibrations due to stretching and bending frequencies of molecular bonds. While it is possible in FIG. 8 to see evidence of the FTIR fingerprint left behind by benzene, there are no significant shifts in the C—H stretching frequencies due to perturbations from their bonding interactions to the Si surfaces. C—C bending patterns will have to be examined in more detail. This is where perturbations (wave number shifts) will be most prominent if those interactions are indeed strong enough to shift bands beyond spectral resolution limits (±4 cm⁻¹).

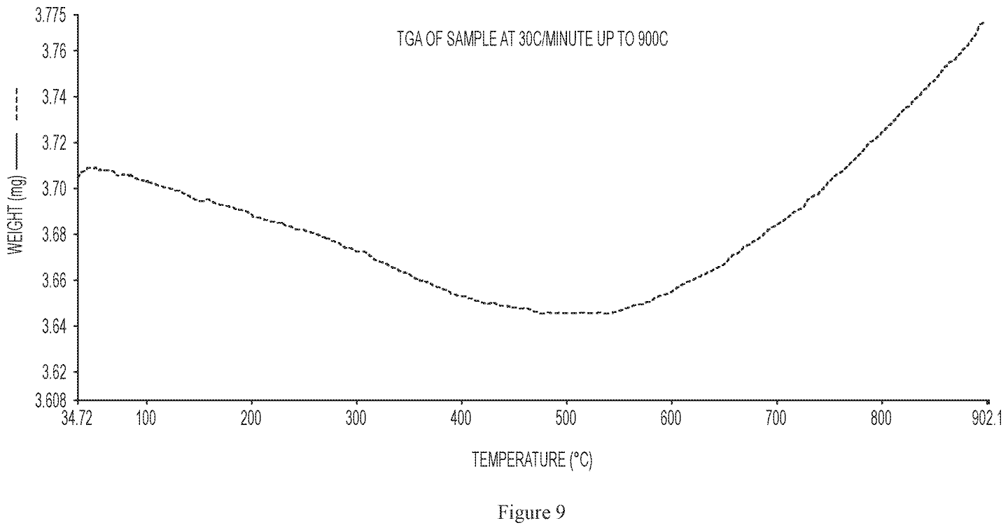

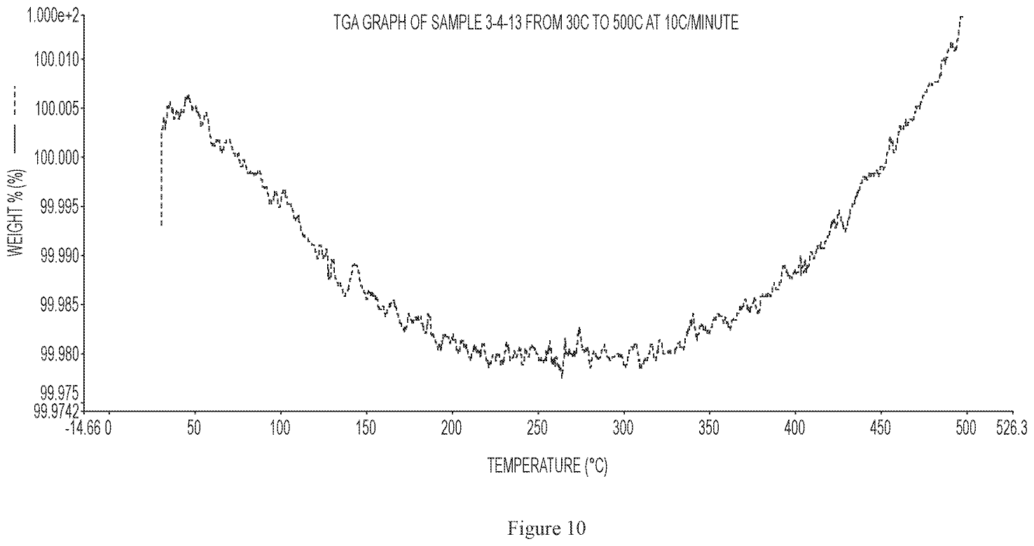

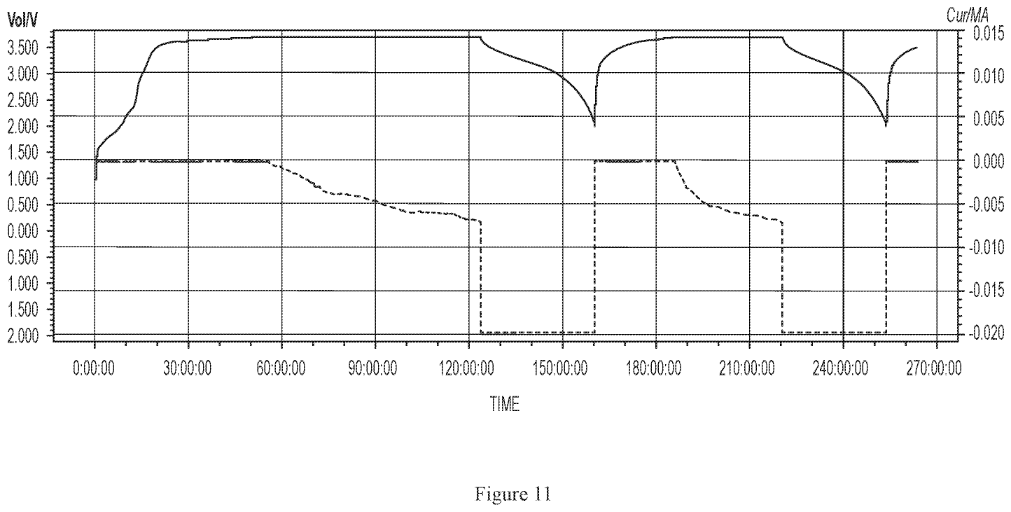

Further evidence that benzene is bound to the particle surfaces with bonding interactions that appear stronger than hydrogen bonding, but not as well defined as would be expected from a discrete monolayer, is shown in TGA scans. FIGS. 9 and 10 are TGA scans run at heating rates of 30 degrees C./s and 10 degrees C./s, respectively. The initial scan at 30 degrees C./s was done to quickly observe the thermal profile up to 900° C. (1,652° F.). In this scenario, the compound is stable to oxidation up to 500° C. (932° F.) and also notable is the fact that it appears to lose mass gradually. The solvent hangs on well past its boiling point. The slower scan rate in FIG. 10 demonstrates that while benzene is continuously evolved from the sample, throughout the temperature range, the material will survive up to 250° C. for several minutes before beginning to oxidize at this slower scan rate. For this reason, using this material in a fixed (packed) bed reactor held at a sustained temperature may not survive beyond 250° C. (482° F.). However, the dynamic desorption of surface bound benzene does not occur instantly and could protect the Si surface from oxidation briefly at higher temperatures. The mass loss accounts for only 0.02% of the total mass before oxidation begins to occur.

### Example 4

### Toluene Passivated Silicon Particles

Si particles processed in benzene solvent by milling 325 mesh intrinsic Si (99.99%, Alpha Aesar) with 0.5-0.6 mm yttrium-stabilized zirconia beads until reaching about 300 nm apparent APSD were passivated by stirring in toluene and heating to reflux under inert atmospheres. To 20 g of the dried particles in a 200 mL round bottom flask was added 50 mL of toluene freshly distilled from sodium. The same procedure was followed with particles made from the previous stock, but further milled with 0.1 mm beads to an apparent APSD less than 200 nm. The true APSD estimated from SEM images was less than 100 nm. In both cases, the particles were refluxed for 1-2 hours in toluene blanketed under 1 atmosphere of purified nitrogen.

With toluene passivated Si NPs, a sharper decline of the mass loss is expected in the TGA with greater sustained stability at higher temperatures. This would be expected for a passivating layer characterized by stronger, more defined bonding interactions to localized sites. Due to toluene's asymmetry, stronger Si—C bonding interactions will be formed to the ring carbon bound to methyl compared with other C—H ring carbon-silicon interactions. Greater evidence of C—C bond vibrations will also be manifest in the IR spectrum band shifts.

### Example 5

### Lithium-Ion Coin Cells

Surfaced-modified Group IVA particles were prepared as described herein and used to fabricate anodes, which were subsequently incorporated into lithium-ion coin cells. In general, the surface-modified Group IVA particles were prepared, incorporated into an anode paste or ink, and applied to a copper substrate, which was then fashioned into an anode and incorporated into a coin cell. In certain instances, the surface-modified Group IVA particles were combined with one or more additional components in the anode paste or ink (e.g., conductive adhesion additive, a dopant additive) before application to the copper substrate.

Exemplary lithium-ion coin cells fabricated, along with component and fabrication variables are provided in the tables below. Several cells were cycled for sufficient time to provide meaningful performance data regarding charge capacity, discharge capacity, specific charge capacity and capacity fade. Charge/discharge cycles were measured on Li⁺ coin cells made from the anode films combined with selected commercial cathode films and electrolytes. Cathodes were made from LiCoO₂ on an Al substrate, and the electrolyte was LiPF₆ in a blend of organocarbonate solvents. A series of anodes were compared with a single selection of cathode and electrolyte formulation.

The “capacities” for the coin cells refer to charge capacities. However, discharge capacity is also an important parameter because it represents the amount of electrical charge that can be delivered by the coin cell when it has been charged according to a given set of parameters. Charge capacity, which is measured for a given coin cell and is given in units of mAh (milliampere hours) is distinct from specific charge capacity, which is determined for a given anode if the anode was weighed and the weight (mass) of the copper substrate was known and can be subtracted, leaving the net weight (mass) of the anode material deposited on that particular anode. The specific charge capacity is then calculated by dividing the coin cell charge capacity by the mass of anode material, and this quantity is therefore given in mAh g⁻¹ (milliampere hours per gram of anode material).

The specific charge capacity of the silicon particles, which make up only part of the anodes, is another parameter. Most of the anodes contain, in addition to particles of a particular type of silicon, some combination of (i) an unknown percentage of a covalently-attached surface modifier (such as 2,3-dihydroxy-naphthalene or 9,10-dibromoanthracene), (ii) a certain percentage of a non-covalently attached conductive adhesion additive (typically 9% or 10% of commercially available 99.5% pure C₆₀, although this additive was not added to some anodes), and (iii) a certain percentage of a dopant additive (typically 2% or 7% of commercially available C₆₀F₄₈, although this additive was not added to many anodes). The mass of the modifier and, if present, the additives, must be subtracted from the mass of the anode, and the resulting mass of the silicon particles alone would be used in the calculation of the specific charge capacity (i.e., coin-cell charge capacity divided by the mass of silicon particles equals the specific charge capacity, in mAh g⁻¹, of the silicon particles in that particular anode in that particular coin cell).

Some of the charge/discharge cycles were performed with different current- and voltage-limit set parameters. These can be discerned by inspecting the figures showing both voltage and current vs. time (the voltage curve is shown in red and the current curve is shown in blue in these figures). In most cases, the voltage limits were set at 3.7 V for charging and 2.0 V for discharging. The current limits varied considerably in order to test whether slow charging/discharging (i.e., 0.01 mA), at least initially, resulted in coin cells more resistant to capacity fade than cells that were charged and/or discharged more quickly (i.e., ≥0.02 mA).

Test results indicate that charge capacity, charging rate and capacity fade are all dependent of the type of c-Si and the surface modifiers used. Examples are based on a n-type c-Si series, however p-type c-Si performs well in some respects for both charge mobility and capacity fade. Intrinsic Si (high purity undoped) does not appear to perform as well.

The addition of charge acceptors to functionalized c-Si composites such as C₆₀ and possibly C₇₀ fullerenes greatly enhance the charge mobility and therefore, the performance of the battery anodes from both charge capacity and capacity fade perspectives. Furthermore, modified fullerene materials (C₆₀F₄₈) exhibit significantly enhanced performance, even in low concentrations as dopants. These results indicate that fluorinated fullerenes and their derivatives may provide significant performance and stability when included in battery anode films made from the surface-modified Group IVA particles. Although not wishing to be bound by theory, it is believed these additives are acting as charge mobility improvers, as well as binders for the composite materials. This allows manufacture of small format battery anodes without the need for polymers used universally by others in the industry.

Charge and discharge capacities of anodes prepared from pastes including the surface-modified Group IVA particles exhibit at least comparable performance to commercial carbon anodes. Optimizing particle size, surface modification, and conductive adhesion additives/dopants may allow for improved performance up to two orders of magnitude.

TABLE 1
Lithium-Ion Coin Cell Fabrication Variables
Coin Cell 4210-2 #1
I. Silicon Particles

| | |
|---|---|
| A. Type of silicon wafer used to produce the particles | 0.4-0.6 Ω cm⁻¹ P-doped (n-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 2,3-dihydroxynaphthalene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀ conductive adhesion additive |
| B. Dopant additive | 2 wt % C₆₀F₄₈ dopant additive (previously referred to |
| | as D48 dopant) |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | paintbrush |
| C. Anode thickness | unknown thickness |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

The charge/discharge plot (0.01 mA charge/discharge current throughout) shown in FIG. 11 revealed the following for Coin Cell 4210-2 #1 as described in Table 1. The initial charge capacity was 0.930 mAh. The initial discharge capacity was 0.364 mAh. The initial charging of the cell presumably includes the reduction of trace amounts of impurities as well as the reduction of some electrolyte solvent molecules to form the solid-electrolyte interface (SEI). The second charge capacity was 0.425 mAh, only slightly larger than the first discharge capacity. The second discharge capacity was 0.339 mAh, only slightly smaller than the initial discharge capacity.

TABLE 2
Lithium-Ion Coin Cell Fabrication Variables
Coin Cell 4210-2 #2
I. Silicon Particles

| | |
|---|---|
| A. Type of silicon wafer used to produce the particles | 0.4-0.6 Ω cm⁻¹ P-doped (n-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 2,3-dihydroxynaphthalene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀ conductive adhesion additive |
| B. Dopant additive | 2 wt % C₆₀F₄₈ dopant additive |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | paintbrush |
| C. Anode thickness | unknown thickness |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

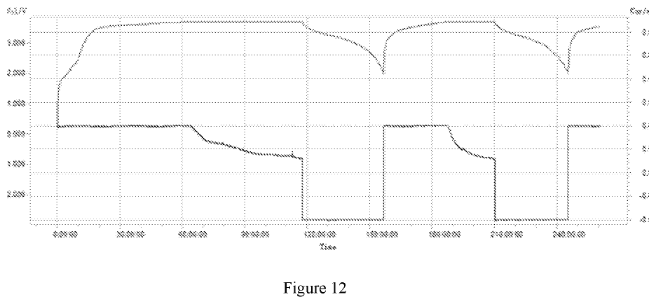

The charge/discharge plot (0.01 mA charge/discharge current throughout) shown in FIG. 12 revealed that Coin Cell 4210-2 #2, as described in Table 2, has almost identical charge/discharge behavior to the previous entry, 4210-2 #1. The initial charge capacity was the same, 0.930 mAh. The initial discharge capacity was 0.391 mAh (it was 0.364 mAh for cell #1). The second charge capacity was 0.424 mAh, nearly identical to the value for cell #1 (0.425 mAh). The second discharge capacity was 0.355 mAh, slightly higher than the value for cell #1 (0.364 mAh).

TABLE 3
Lithium-Ion Coin Cell Fabrication Variables
Coin Cell 4D10-0
I. Silicon Particles

| | |
|---|---|
| A. Type of silicon wafer used to produce the particles | 0.4-0.6 Ω cm⁻¹ P-doped (n-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 9,10-dibromoanthracene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀ conductive adhesion additive |
| B. Dopant additive | no dopant additive |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | Automated film applicator |
| C. Anode thickness | 0.100 mm |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

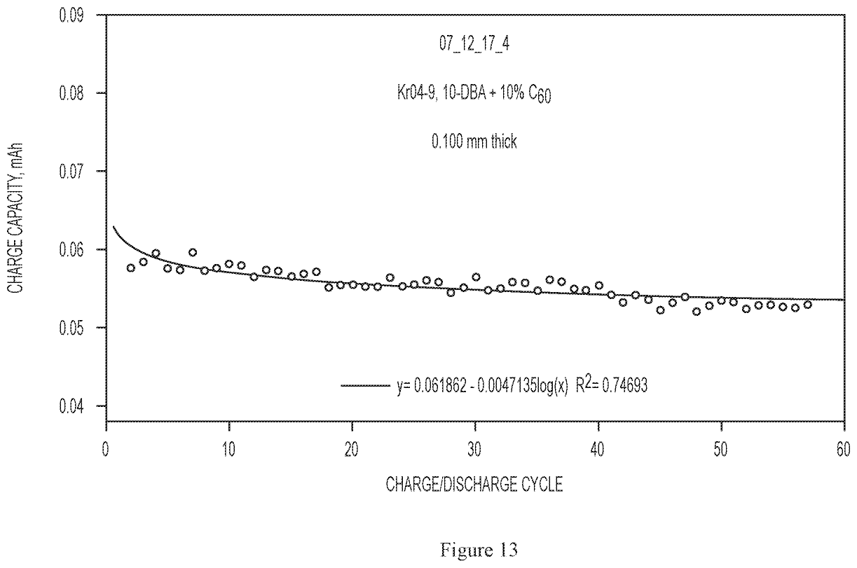

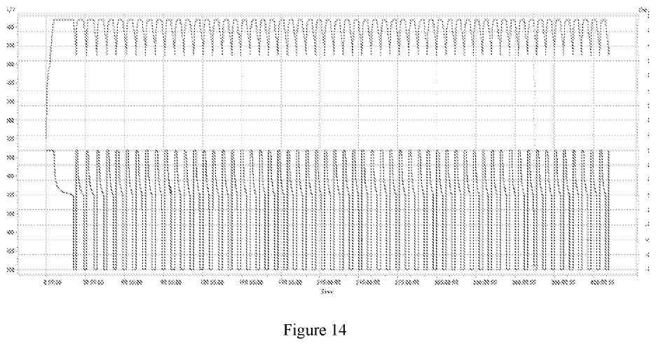

The mass of the anode in Coin Cell 4D10-0 of Table 3 was ca. 7 mg. Therefore, the initial coin-cell charge capacity, extrapolated to 0.062 mAh from the logarithmic fit to these data as shown in FIG. 13, translates into an initial specific charge capacity of 8.9 mAh g⁻¹ for this anode material. The capacity fade is less than 10% over these 58 cycles as shown in FIG. 14.

TABLE 4
Lithium-Ion Coin Cell Fabrication Variables
Coin Cell 4D10-2 #1
I. Silicon Particles

| | |
|---|---|
| A. Type of silicon wafer used to produce the particles | 0.4-0.6 Ω cm⁻¹ P-doped (n-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 9,10-dibromoanthracene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀ conductive adhesion additive |
| B. Dopant additive | 2 wt % C₆₀F₄₈dopant additive (previously referred to as |
| | D48 dopant) |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | Film Applicator |
| C. Anode thickness | 0.100 mm |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

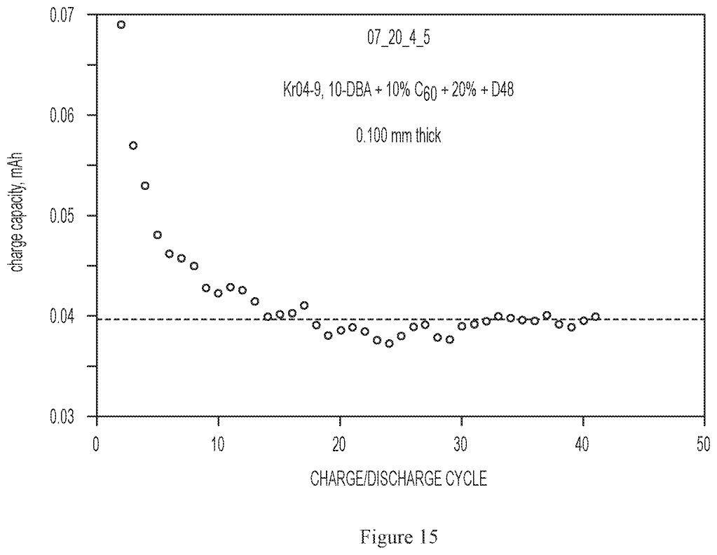

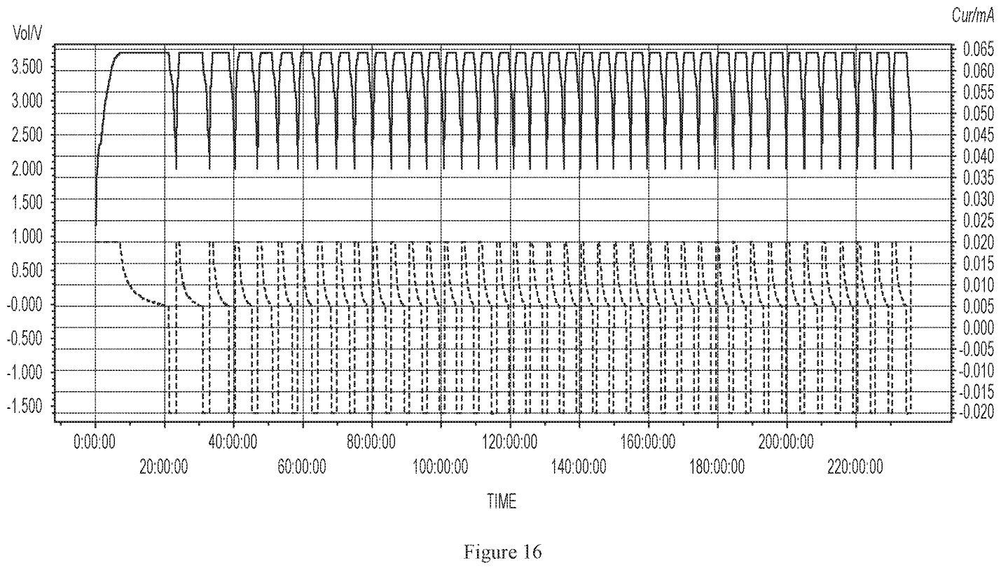

The mass of this anode in Coin Cell 4D10-2 #1 of Table 4 was ca. 7 mg. Therefore, the nominal coin-cell charge capacity of 0.04 mAh from cycle 15 through cycle 41 translates into a specific charge capacity of 5.7 mAh g⁻¹ for this anode material, as shown in FIG. 15. The capacity fade appears to be insignificant after cycle 15 as shown in FIG. 16.

TABLE 5
Lithium-Ion Coin Cell Fabrication Variables
Coin Cell 4D10-2 #2
I. Silicon Particles

| | |
|---|---|
| A. Type of silicon wafer used to produce the particles | 0.4-0.6 Ω cm⁻¹ P-doped (n-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 9,10-dibromoanthracene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀ conductive adhesion additive |
| B. Dopant additive | 2 wt % C₆₀F₄₈ dopant additive (previously referred to |
| | as D48 dopant) |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | Film Applicator |
| C. Anode thickness | 0.100 mm |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

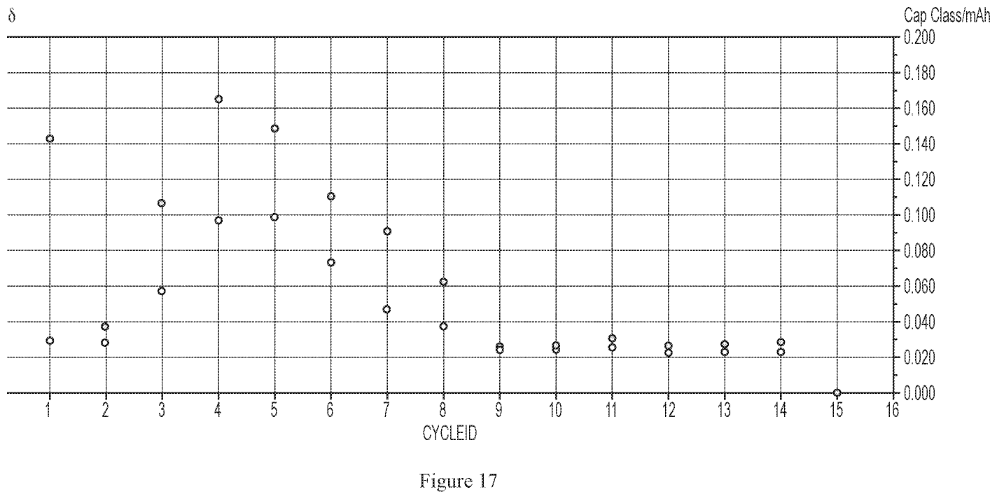

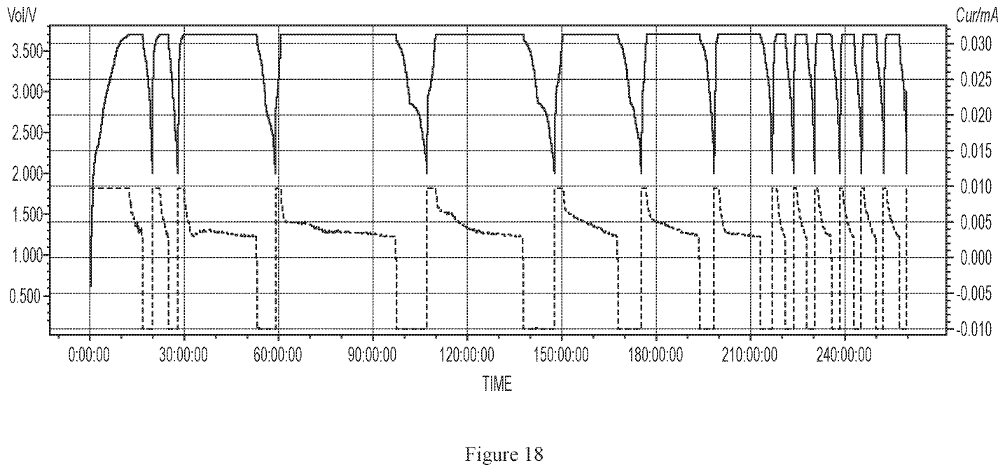

Table 5 shows Coin Cell 4D10-2 #2. FIGS. 17 and 18 show the performance data for the coin cell.

TABLE 6
Lithium-Ion Coin Cell Fabrication Variables
Coin Cell 4D10-2 #3
I. Silicon Particles

| | |
|---|---|
| A. Type of silicon wafer used to produce the particles | 0.4-0.6 Ω cm⁻¹ P-doped (n-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 9,10-dibromoanthracene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀ conductive adhesion additive |
| B. Dopant additive | 2 wt % C₆₀F₄₈ dopant additive (previously referred to |
| | as D48 dopant) |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | Film Applicator |
| C. Anode thickness | 0.100 mm |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

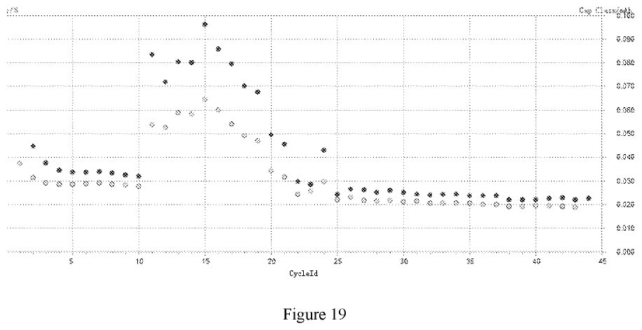

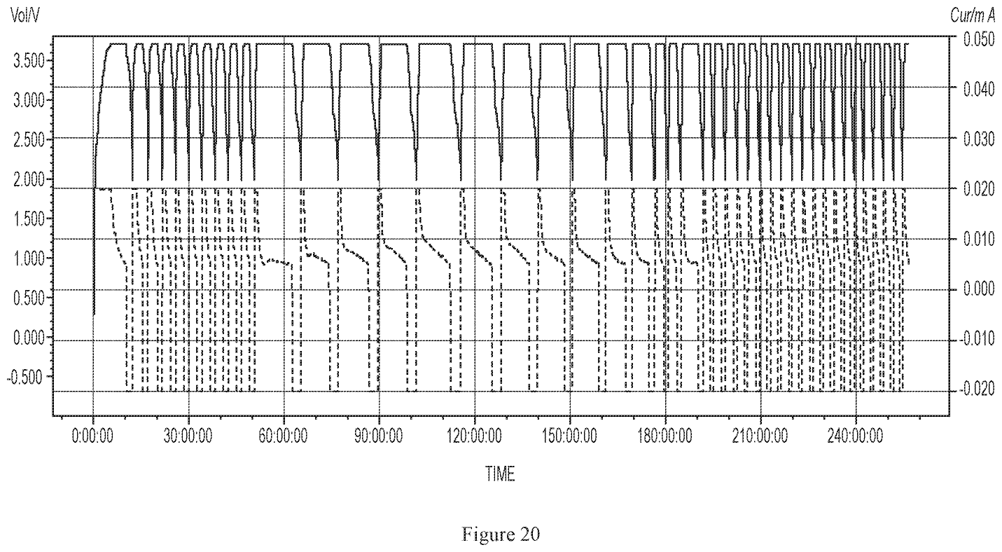

Table 6 shows Coin Cell 4D10-2 #3. FIGS. 19 and 20 show the performance data for the coin cell.

TABLE 7
Lithium-Ion Coin Cell Fabrication Variables
Coin Cell 4D10-2 #4
I. Silicon Particles

| | |
|---|---|
| A. Type of silicon wafer used to produce the particles | 0.4-0.6 Ω cm⁻¹ P-doped (n-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 9,10-dibromoanthracene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀ conductive adhesion additive |
| B. Dopant additive | 2 wt % C₆₀F₄₈ dopant additive (previously referred to |
| | as D48 dopant) |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | Film Applicator |
| C. Anode thickness | 0.100 mm |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

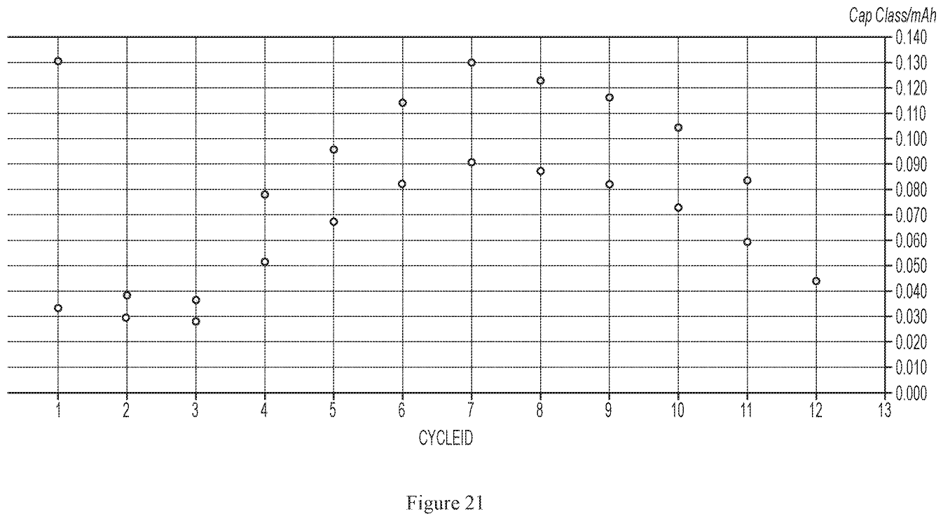

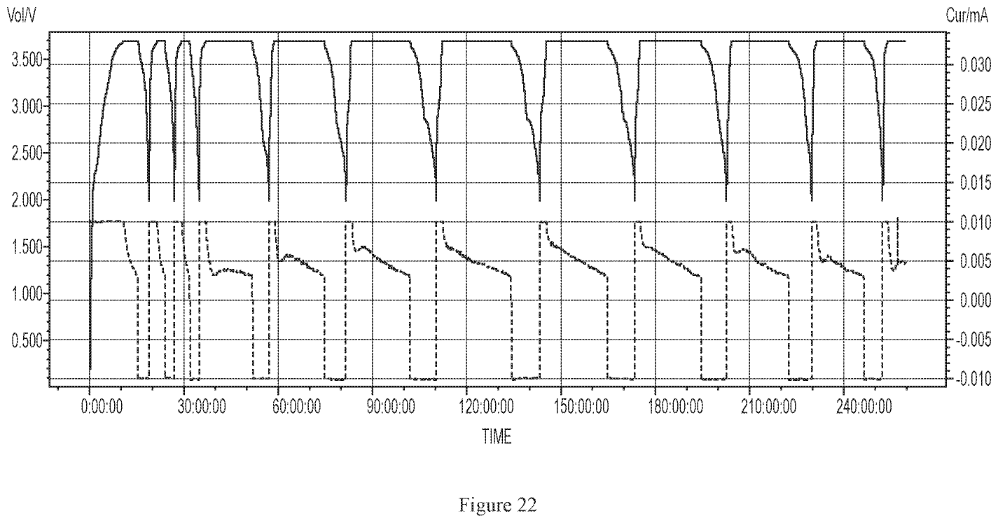

Table 7 shows Coin Cell 4D10-2 #4. FIGS. 21 and 22 show the performance data for the coin cell.

TABLE 8
Lithium-Ion Coin Cell Fabrication Variables
Coin Cell 429-0
I. Silicon Particles

| | |
|---|---|
| A. Type of silicon wafer used to produce the particles | 0.4-0.6 Ω cm⁻¹ P-doped (n-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 2,3-dihydroxynaphthalene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 9 wt % C₆₀ conductive adhesion additive |
| B. Dopant additive | no dopant additive |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | Film Applicator |
| C. Anode thickness | 0.200 mm |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

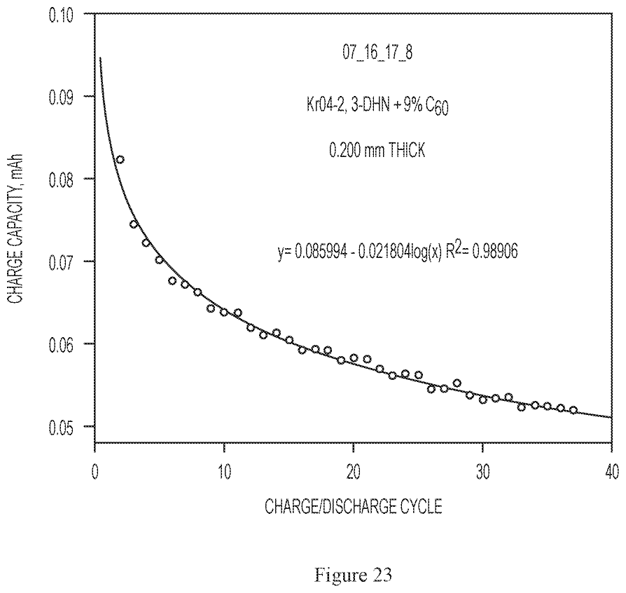

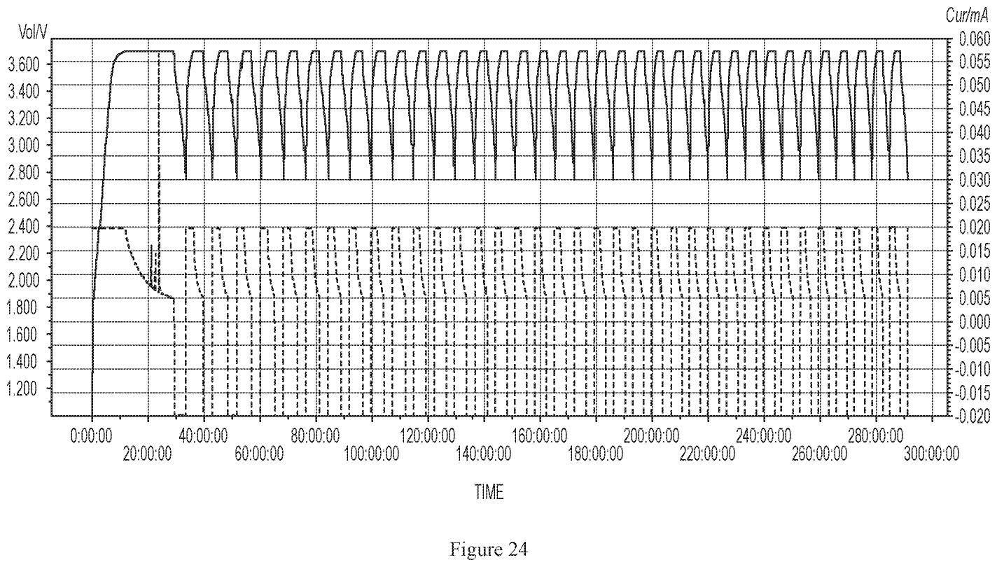

The anode mass of Coin Cell 429-0 of Table 8 is probably ca. 7 mg. The specific charge capacity of the anode material during the third cycle is ca. 11 mAh g⁻¹ as shown in FIG. 23. The capacity fade is quite significant as shown in FIG. 24.

TABLE 9
Lithium-Ion Coin Cell Fabrication Variables
Coin Cell 4210-7
I. Silicon Particles

| | |
|---|---|
| A. Type of silicon wafer used to produce the particles | 0.4-0.6 Ω cm⁻¹ P-doped (n-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 2,3-dihydroxynaphthalene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀conductive adhesion additive |
| B. Dopant additive | 7 wt % C₆₀F₄₈ dopant additive (previously referred to |
| | as D48 dopant) |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | paintbrush |
| C. Anode thickness | unknown thickness |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

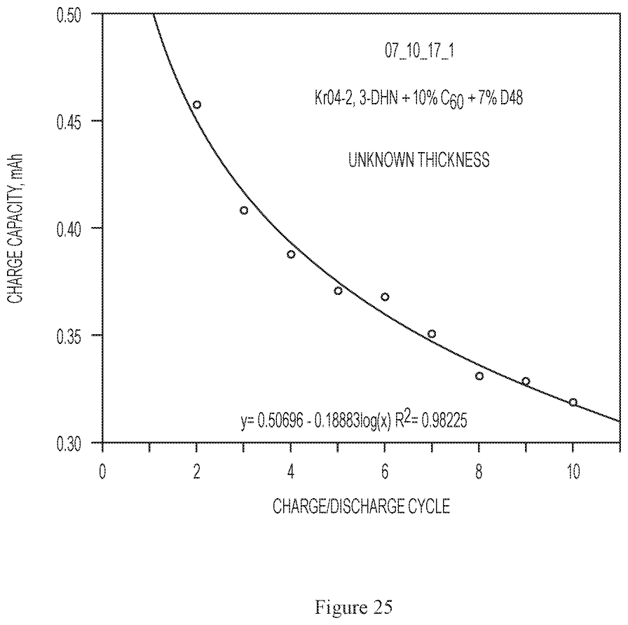

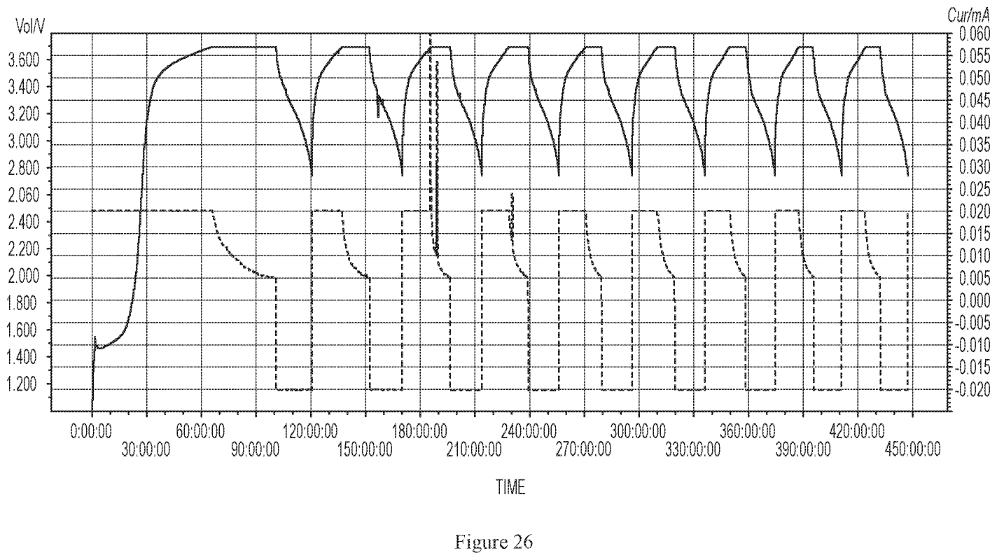

Coin Cell 4210-7 of Table 9 has excellent charge capacity but only marginal fade characteristics as shown in FIGS. 25 and 26. Taking the coin cell charge capacity after the first 10 cycles, 0.319 mAh, the specific charge capacity of this anode material, assuming that the anode weighed ca. 7 mg, is ca. 46 mAh g⁻¹. Note that the theoretical specific charge capacity of silicon, ca. 4,000 mAh g⁻¹, is ca. 87 times higher. However, the amount of silicon in this anode is almost certainly 20+% lower than 7 mg (it contains 10% C₆₀ conductive adhesion additive, 7% C₆₀F₄₈ dopant additive, and an unknown amount of 2,3-DHN surface modifier). Therefore, the specific charge capacity of the silicon in this anode material is probably ca. 58 mAh g⁻¹. Furthermore, that is the specific charge capacity after 10 cycles, during which time the cell lost more than 25% of the charge capacity during the second cycle. Calculating the specific charge capacity of the silicon in the anode based on that, it is ca. 76 mAh g⁻¹

TABLE 10
Lithium-Ion Coin Cell Fabrication Variables
Coin Cell 1210-0 #1 and Coin Cell 1210-0 #3
I. Silicon Particles

| | |
|---|---|
| A. Type of silicon wafer used to produce the particles | 99.5% pure intrinsic silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 2,3-dihydroxynaphthalene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀ conductive adhesion additive |
| B. Dopant additive | no dopant additive |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | Automated film applicator |
| C. Anode thickness | 0.100 mm |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

Coin Cell 1210-0 #1 of Table 10 had still not reached 3.7 V after many hours; the voltage seemed to have stabilized at ca. 3.6 V and continued to charge. The voltage limit was changed to 3.6 V and the cell was restarted. It was still charging at 0.0075 mA after an additional 20 hr. Coin Cell 1210-0 #3 exhibited essentially the same behavior, and the same voltage-limit switch was made. The only difference was that it was still charging at 0.0131 mA after the additional 20 hr. Note, 0.02 mA for constant current phases; down to 0.005 mA for constant voltage phase during charging.

TABLE 11
Lithium-Ion Coin Cell Fabrication Variables
Coin Cell 4210-0 #1 and Coin Cell 4210-0 #3
I. Silicon Particles

| | |
|---|---|
| A. Type of silicon wafer used to produce the particles | 0.4-0.6 Ω cm⁻¹ P-doped (n-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 2,3-dihydroxynaphthalene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀ conductive adhesion additive |
| B. Dopant additive | no dopant additive |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | Automated film applicator |
| C. Anode thickness | 0.100 mm |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

Coin Cell 4210-0 #1 of Table 11 had not reached 0.005 mA during the first constant voltage (3.7 V) phase after 27 h. Coin Cell 4210-0 #3 of Table 11 had not reached 3.7 V during the first constant current phase after 17 h. Note, 0.02 mA for constant current phases; down to 0.005 mA for constant voltage phase during charging.

TABLE 12
Lithium-Ion Coin Cell Fabrication Variables
Coin Cell 5210-0 #1; Coin Cell 5210-0 #2; Coin Cell 5210-0 #3
I. Silicon Particles

| | |
|---|---|
| A. Type of silicon wafer used to produce the particles | 0.014-0.017 Ω cm⁻¹B-doped (p-type) silicon |
| B. Particle Size | APS < 400 nm |
| C. Solvent used for the grinding process | Benzene |
| D. Solvent removal methodology | Vacuum distillation followed by vacuum drying for 6 hr |
| | at 23(2) ° C. |
| E. Treatment with or without aq. HF or anhydrous HF | Not treated with HF |
| F. Aerobic or anaerobic treatment of silicon particles | Aerobic |

II. Surface Modification (covalently attached aromatic hydrocarbon derivatives)

| | |
|---|---|
| A. Modifier | 2,3-dihydroxynaphthalene |
| B. Method of modification | 20 wt %; triglyme reflux (216° C.) for 6 hr |
| C. Aerobic or anaerobic treatment | aerobic |

III. Addition of non-covalently-attached conductive adhesion and/or dopant additives

| | |
|---|---|
| A. Conductive adhesion additive | 10 wt % C₆₀ conductive adhesion additive |
| B. Dopant additive | no dopant additive |
| C. Method of addition | dichloromethane; 23(2) ° C.; 10 min with sonication; air |
| | dried |
| D. Aerobic or anaerobic treatment | aerobic |

IV. Preparation of anode sheet

| | |
|---|---|
| A. Solvent, ratio of solvent to silicon particles, | 1,2,3-Trichloropropane; 40 wt % solids loading with |
| sonication | sonication |
| B. Method of application | Automated film applicator |
| C. Anode thickness | 0.100 mm |
| D. Method of anode drying | 1 hr air-dry with heat ramp to 90° C.; 100° C.; 1 hr |
| | under vacuum + 30 min from vacuum to atmospheric |
| | pressure |
| E. Aerobic or anaerobic treatment | aerobic |

V. Coin cell assembly (strictly anaerobic)

| | |
|---|---|
| A. Cathode | 0.1 mm thick × 19 mm diameter LiCoO₂ on Al |
| | substrate |
| B. Separator film | Celgard 0.025 mm thick × 20 mm diameter |
| C. Electrolyte solution | EC:DMC:DEC (4:3:3) with 1M LiPF₆ (+unknown |
| | proprietary additives) |

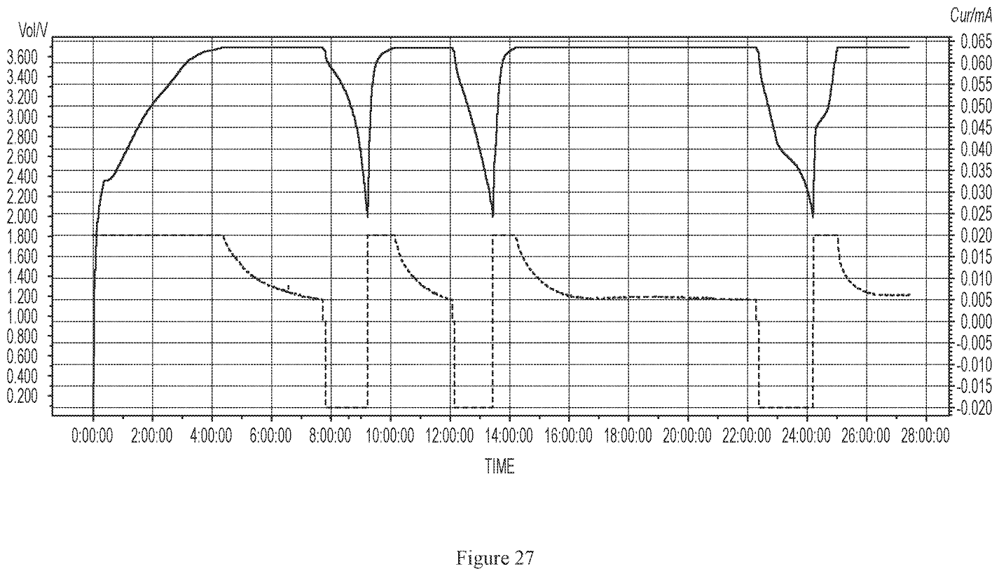

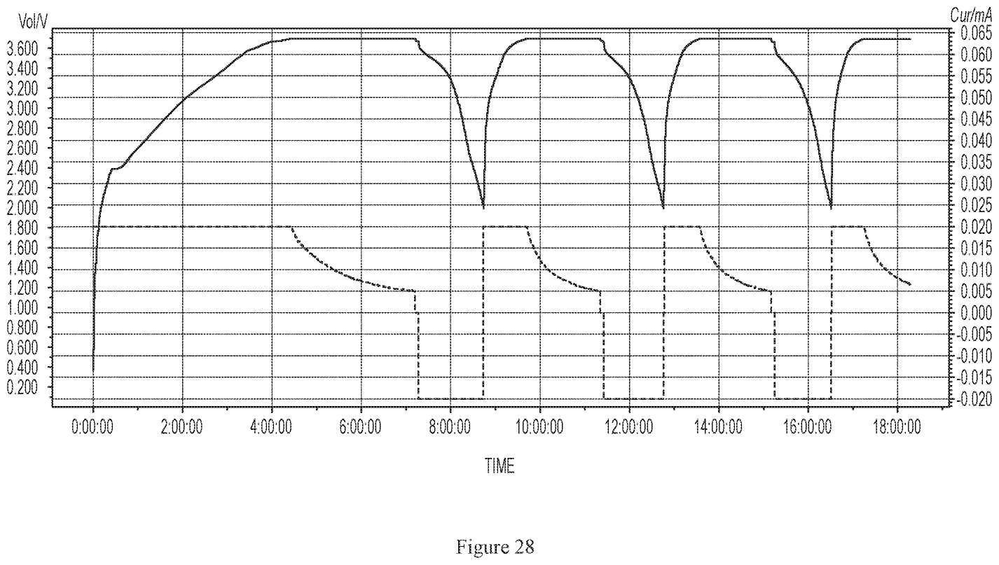

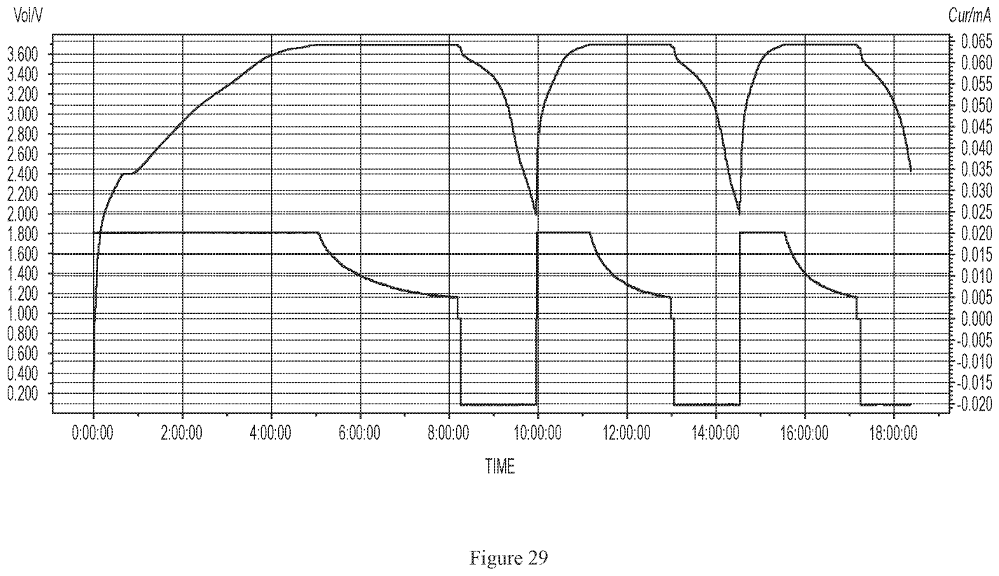

FIGS. 27-29 show charge/discharge cycles for the coin cells of Table 2. Coin Cell 5210-0 #1 showed the following performance: 1^{st} cycle: charge capacity=0.119 mAh; discharge capacity=0.029 mAh; 2^{nd} cycle: charge capacity=0.037 mAh; discharge capacity=0.026 mAh; 3^{rd} cycle: charge capacity=0.069 mAh; discharge capacity=0.037 mAh; and 4^{th} cycle: charge capacity=0.027+ mAh (not finished charging at this time). Coin Cell 5210-0 #2 showed the following performance: 1^{st} cycle: charge capacity=0.116 mAh; discharge capacity=0.029 mAh; 2^{nd} cycle: charge capacity=0.034 mAh; discharge capacity=0.027 mAh; and 3^{rd} cycle: charge capacity=0.031 mAh; discharge capacity=0.026 mAh. Coin Cell 5210-0 #3 showed the following performance: 1^{st} cycle: charge capacity=0.130 mAh; discharge capacity=0.034 mAh; and 2^{nd} cycle: charge capacity=0.041 mAh; discharge capacity=0.031 mAh.

Tables 13 and 14 show the coin cell data charge capacity, discharge capacity, specific charge capacity, and fade, in a summarized fashion. The data in Table 14 is intended to compare the surface modification trends, all with the same n-type silicon base. As the surface modifier grows in size, there is observed a reduction of resistivity and an increase in specific charge capacity.

TABLE 13

| | | | | | Spec. | |
|---|---|---|---|---|---|---|
| | * CCC/CVC | (wet) film | Charge | Discharge | Charge | Cap. |
| Anode | Vₘₐₓ/Vₘᵢₙ | thickness/ | Capacity | Capacity | Capacity | Fade |
| Formula | (mA)/(V) | mass (mg) | (mAh) | (mAh) | (mAh/g) | # cycles |
| 4210-2 | 0.010/0.003 | 0.100 mm | 0.425 | 0.364 | 80.1 | 11% |
| #2 | 3.70 V/2.00 V | 5.3 | | | | 3 |
| 4210-2 | 0.010/0.003 | 0.100 mm | 0.424 | 0.355 | 80.0 | 11% |
| #4 | 3.70 V/2.00 V | 5.3 | | | | 3 |
| 4210-0 | 0.020/0.005 | 0.100 mm | 0.368 | 0.334 | 62.4 | 6% |
| #1 | 3.70 V/2.00 V | 5.9 | | | | 2 |
| 4210-0 | 0.020/0.005 | 0.100 mm | 0.232 | 0.193 | 39.3 | 27% |
| #3 | 3.70 V/2.00 V | 5.9 | | | | 3 |
| 5210-0 | 0.020/0.005 | 0.100 mm | 0.051 | 0.042 | 8.6 | 14% |
| #1 | 3.70 V/2.00 V | 5.9 | | | | 20 |
| 5210-0 | 0.020/0.005 | 0.100 mm | 0.069 | 0.050 | 11.7 | 0%^{†} |
| #2 | 3.70 V/2.00 V | 5.9 | | | | 14 |
| 1210-0 | 0.020/0.005 | 0.100 mm | 0.059 | 0.053 | 10.0 | 30% |
| #1 | 3.60 V/2.00 V | 5.9 | | | | 14 |
| 1210-0 | 0.020/0.005 | 0.100 | 0.110 | 0.095 | 18.6 | 40.7 |
| #3 | 3.60 V/2.00 V | 5.9 | | | | 4 |
| 4B10-0 | 0.02 mA/ | unknown | 0.062 | 0.06 | 8.9 | 10% |
| #2 | 3.70 V/2.75 V | ~7 mg | | | | 60 |
| 4B10-2 | 0.02 mA/ | 0.100 mm/ | 0.05 | 0.04 | 5.7 | 30% |
| #1 | 3.70 V/2.75 V | 7 mg | | | | 45 |
| 429-0 | 0.02 mA/ | 0.200 mm/ | 0.13 | 0.075 | 10.8 | 20% |
| #4 | 3.70 V/2.00 V | 12 mg | | | | 20 |
| CMS | 0.02 mA/ | 0.05 mm | 0.826 | 0.755 | 51.6 | 16% |
| graphite | 3.7 V/2.0 V | (dry)/16 mg | | | | 3 |
| anode | | | | | | |

*Anode formulae: 1***-*: (intrinsic) 99.5%; 325 mesh (Alpha Aesar) CAS #7440-21-3 4***-*: (n-type); P-doped wafer; Resist. = 0.4-0.6 Ω cm⁻¹ 5***-*: (p-type); B-doped wafer; Resist. = 0.014-0.016 Ω cm⁻¹
Cathode formula: LiCoO₂
Solvent/Electrolyte: EC:DMC:DEC (4:3:3 by vol.)/LiPF₆ (1 M)
**CCC: Constant Current Charge CVC: Constant Voltage Charge Vₘₐₓ: Charging voltage limit Vₘᵢₙ: Discharge voltage limit
†charge capacity increased during the first few cycles; insufficient cycles have been acquired to show capacity fade.

TABLE 14

| | | * CCC/ | | | | Spec. | |
|---|---|---|---|---|---|---|---|
| | | CVC | (wet) film | Charge | Discharge | Charge | Cap. |
| Anode | Resist. | VmaxNmin | thickness/ | Capacity | Capacity | Capacity | Fade |
| Formula | M Ω/cm | (mA)/(V) | mass (mg) | (mAh) | (mAh) | (mAh/g) | # cycles |
| 4210-0 | 0.020 | 0.020/0.005 | 0.100 mm | 0.368 | 0.334 | 62.4 | 6% |
| #1 | | 3.70 V/ | 5.9 | | | | 2 |
| | | 2.00 V | | | | | |
| 4110-0 | 0.180 | 0.020/0.005 | 0.100 mm | 0.347 | 0.323 | 42.8 | |
| #3 | | 3.70 V/ | 8.1 | | | | |
| | | 2.00 V | | | | | |
| 4B | >40 | 0.020/0.005 | 0.100 mm | 0.043 | 0.033 | 14.8 | 0%^{†} |
| #1 | | 3.70 V/ | 2.9 | | | | 11 |
| | | 2.00 V | | | | | |
| 4B10-0 | 9.8 | 0.020/0.005 | 0.100 mm | 0.051 | 0.034 | 14.1 | 35% |
| #1 | | 3.70 V/ | 3.6 | | | | 11 |
| | | 2.00 V | | | | | |
| CMS | Not | 0.02 mA/ | 0.05 mm | 0.826 | 0.755 | 51.6 | 16% |
| graphite | meas. | 3.7 V/2.0 V | (dry)/16 mg | | | | 3 |
| anode | | | | | | | |

4B*** = n-type c-Si surface passivated with benzene only.
4110-0 = n-type c-Si surface modified with catechol (dihydroxy benzene).
4210-0 = n-type c-Si surface modified with dihydroxy naphthalene.

### Example 6

### Comparison to Carbon Anode

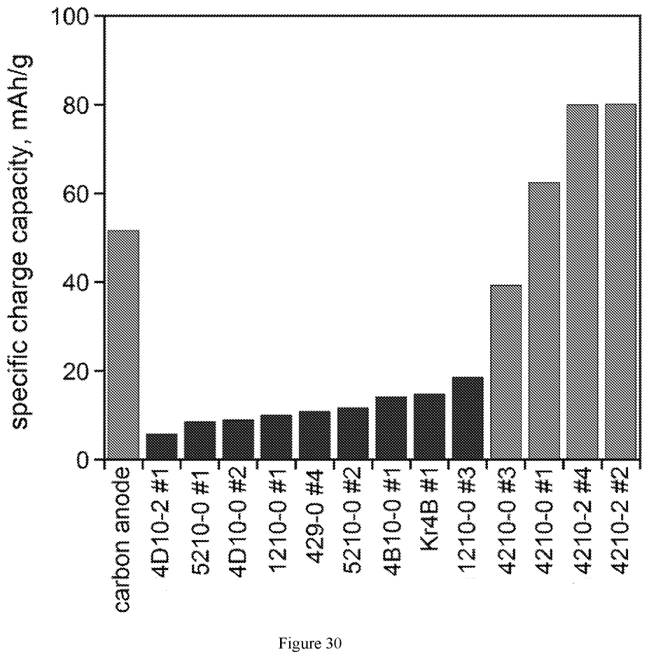

FIG. 30 shows a comparison of lithium-ion batteries having anodes prepared with functionalized Group IVA particles versus batteries prepared with a standard carbon based anode. Performance of the carbon-based anode is shown in red, performance of anodes prepared according to the present invention are shown in purple and green. As shown, the batteries of 4210-0 and 4210-2 outperformed the standard carbon based anode.

### Example 7

### Prediction of Specific Charge Capacity

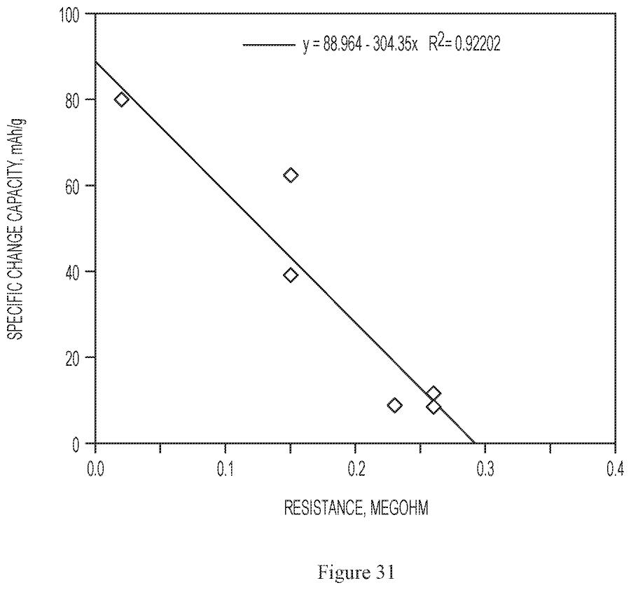

FIG. 31 shows that there appears to be a correlation such that Si can be tested prior to fabricating batteries to predict based on resistance of the Si, what the specific charge capacity, mAh/g will be.

It is understood that the foregoing detailed description and accompanying examples are merely illustrative and are not to be taken as limitations upon the scope of the invention, which is defined solely by the appended claims and their equivalents.

### Example 8

### General Experimental Methods for Examples 9-81

Reagents and solvents were obtained commercially and distilled prior to use. Distillation was accomplished by heating the solvents in a glass distillation apparatus under nitrogen or argon with sodium metal immediately prior to use.

Abbreviations used are as follows: 2,3-DHN: 2,3-dihydroxynaphthalene; 2,3-DHA: 2,3-dihydroxyanthracene; MWCNT: multi-walled carbon nanotube; SWCNT: single wall carbon nanotube; CCA: conducting carbon additive; P3HT: poly(3-hexylthiophene-2,5-diyl); nSi: nano silicon particles.

### Example 9

### Preparation of Nano-Sized Si Powder from P-Doped Si

A sample of micron-sized particles from P-doped Si wafers was milled in benzene, followed by solvent removal to produce a nano-sized Si powder (nSi).

### Example 10

### Preparation of Nano-Sized Si Powder from B-Doped Si

A sample of micron-sized particles from B-doped Si wafers was milled in benzene, followed by solvent removal to produce a nano-sized Si powder (nSi).

### Example 11

### Preparation of Nano-Sized Si Powder from Metallurgical Si

A sample of micron-sized particles of metallurgical Si was milled in benzene, followed by solvent removal to produce a nano-sized Si powder (nSi).

### Example 12

### Preparation of 2,3-DHN Modified Nano-Sized Si Powder

A sample of nSi prepared as described in Example 9 was heated in polyether in the presence of 2,3-DHN to produce nSi with surfaces modified by 2,3-DHN.

### Example 13

### Preparation of 2,3-DHA Modified Nano-Sized Si Powder

A sample of nSi prepared as described in Example 9 was heated in polyether in the presence of 2,3-DHA to produce nSi with surfaces modified by 2,3-DHA.

### Example 14

### Preparation of 2,3-DHN Modified Nano-Sized Si Powder

A sample of micron-sized particles from P-doped Si wafers was milled in benzene in the presence of 2,3-DHN, followed by solvent removal to produce nSi powder with surfaces modified by 2,3-DHN.

### Example 15

### Preparation of C₆₀/C₇₀ Modified Nano-Sized Si Powder

A sample of micron-sized particles from P-doped Si wafers was milled in benzene in the presence of C₆₀/C₇₀ fullerene extract, followed by solvent removal to produce a nano-sized surface-modified Si powder.

### Example 16

### Fabrication of an nSi Battery

Preparation of anode paste: The nSi powder prepared as described in Example 12 was used as anode material (AM) and 9%, by weight, C₆₀ fullerene was used as conducting carbon additive (CCA). The solids were mixed. To the solid mixture approximately 3 ml of dichloromethane was added, and the mixture was sonicated for 10 min. The mixture was then dried to a powder with a dry air purge at room temperature.

Formation of anode: 1,2,3-Trichloropropane was added to the dried solid such that a solids-loading of approximately 8.5% was achieved (% weight of the solids in the slurry). The mixture was sonicated using a Biologics probe sonicator at 40% power until a smooth suspension was formed. The suspension was spread on carbon coated copper foil with a doctor blade (from “ductor blade”, it is a metal or ceramic blade positioned with a predetermined gap just above the substrate, then moved across the substrate with a mass of ink in front of it, effectively spreading the ink on the substrate at some predictable thickness). The film was dried on the spreader at 90° C. for 30 min. From the dried film 16 mm anode discs were punched out.

Fabrication of Battery: The anode discs were dried in a vacuum oven at 100° C. under dynamic vacuum for 1 hr. Each battery was assembled and sealed under an atmosphere of nitrogen in a glovebox using the anode disc and a 19 mm LiCoO₂ disc on aluminum substrate as the cathode. The electrodes were separated with a 20 mm diameter Celgard disc and the components assembled in a 2032 coin-cell stainless steel housing filled with electrolyte composed of 1 M LiPF₆ dissolved in a blend of organic carbonate solvents with vinylene carbonate additive. A spacer and wave spring was placed on top of the anode side of the cell before crimping and hermetically sealing each coin cell battery.

Charging/discharging Cycle tests: The batteries were charged and discharged between 3.00 and 3.85 V at a constant current of 0.02 mA. The specific discharge capacity was 769 mAh/g (after 1^{st} cycle).

### Example 17

### Fabrication of an nSi Battery

The procedure of Example 16 was modified to use 18% C₆₀, by weight. The specific discharge capacity of the resulting battery was measured as 349 mAh/g.

### Example 18

### Fabrication of an nSi Battery

The procedure of Example 16 was modified to replace carbon coated copper foil with uncoated copper foil. The specific discharge capacity of the resulting battery was measured as 697 mAh/g.

### Example 19

### Fabrication of an nSi Battery

The procedure of Example 16 was modified to replace 9% C₆₀, by weight, with 9% nanospherical carbon, by weight. The specific discharge capacity of the resulting battery was measured as 558 mAh/g.

### Example 20

### Fabrication of an nSi Battery

The procedure of Example 16 was modified to also include 9% poly(3-hexylthiophene), by weight. The specific discharge capacity of the resulting battery was measured as 918 mAh/g.

### Example 21

### Fabrication of an nSi Battery

The procedure of Example 20 was modified to replace carbon coated copper foil with uncoated copper foil. The specific discharge capacity of the resulting battery was measured as 1020 mAh/g.

### Example 22

### Fabrication of an nSi Battery

The procedure of Example 16 was modified to also include 9% polyaniline crosslinked with phytic acid, by weight. The anode film was prepared differently in the following ways: (i) the solvent added to solids was water with a solids loading of ca. 25%, and after sonicating the mixture was stirred on a stir plate for 40 minutes; (ii) the film was not dried on the spreader, it was dried at room temperature for 72 hours; (iii) after the discs were punched out they were dipped in distilled, deionized water and agitated gently five times; and (iv) the discs were then dried at room temperature under dynamic vacuum for 19 hours. The specific discharge capacity was measured as 496 mAh/g.

### Example 23

### Fabrication of an nSi Battery

The procedure of Example 16 was modified to replace 9% C₆₀, by weight, with 9% single wall carbon nanotubes, by weight. The specific discharge capacity of the resulting battery was measured as 473 mAh/g.

### Example 24

### Fabrication of an nSi Battery

The procedure of Example 16 was modified to eliminate the use of a CCA. The specific discharge capacity of the resulting battery was measured as 548 mAh/g.

### Example 25

### Fabrication of an nSi Battery

The procedure of Example 16 was modified to employ the nSi powder prepared in Example 9. The specific discharge capacity of the resulting battery was measured as 454 mAh/g.

### Example 26

### Fabrication of an nSi Battery

The procedure of Example 16 was modified to employ the nSi powder prepared in Example 15, and no CCA was added in the post-milling procedure. The specific discharge capacity of the resulting battery was measured as 644 mAh/g.

### Example 27

### Fabrication of an nSi Battery

The procedure of Example 16 was modified to employ the nSi powder prepared in Example 15, and no CCA was added in the post-milling procedure. In addition, 9% poly(3-hexylthiophene) (a conductive polymer), by weight, was used in the modified procedure. The specific discharge capacity of the resulting battery was measured as 301 mAh/g.

### Example 28

### Fabrication of an nSi Battery

The procedure of Example 16 was modified to employ the nSi powder prepared in Example 15. The procedure was further modified to replace 9% C₆₀, by weight, with 9% single wall carbon nanotubes, by weight. The specific discharge capacity of the resulting battery was measured as 582 mAh/g.

### Example 29

### Fabrication of an nSi Battery

The procedure of Example 16 was modified to employ the nSi powder prepared in Example 15, and no CCA was added in the post-milling procedure. The charging/discharging cycle test of the resulting battery was modified to charge at a constant current of 0.03 mA. The specific discharge capacity of the battery was measured as 692 mAh/g.

### Example 30

### Fabrication of an nSi Battery

The procedure of Example 16 was modified to employ the nSi powder prepared in Example 15, and no CCA was added in the post-milling procedure. The charging/discharging cycle test of the resulting battery was modified to charge and discharge between 3.00 and 3.90 V. The specific discharge capacity of the battery was measured as 1400 mAh/g.

### Example 31

### Fabrication of an nSi Battery

The procedure of Example 16 was modified to employ the nSi powder prepared in Example 15, and no CCA was added in the post-milling procedure. The charging/discharging cycle test of the resulting battery was modified to charge and discharge between 3.00 and 3.90 V at a constant current of 0.03 mA. The specific discharge capacity of the battery was measured as 1600 mAh/g.

### Example 32

### Fabrication of an nSi Battery

The procedure of Example 16 was modified to employ the nSi powder prepared in Example 15, and no CCA was added in the post-milling procedure. The charging/discharging cycle test of the resulting battery was modified to charge and discharge between 3.00 and 3.95 V at a constant current of 0.03 mA. The specific discharge capacity of the battery was measured as 2840 mAh/g.

### Example 33

### Fabrication of an nSi Battery

The procedure of Example 16 was modified to employ the nSi powder prepared in Example 15, and no CCA was added in the post-milling procedure. The charging/discharging cycle test of the resulting battery was modified to charge and discharge between 3.00 and 3.95 V. The specific discharge capacity of the battery was measured as 1600 mAh/g.

### Example 34

### Fabrication of an nSi Battery

The procedure of Example 16 was modified to employ the nSi powder prepared in Example 15, and no CCA was added in the post-milling procedure. The charging/discharging cycle test of the resulting battery was modified to charge and discharge between 3.00 and 4.00 V at a constant current of 0.03 mA. The specific discharge capacity of the battery was measured as 2550 mAh/g.

### Example 35

### Fabrication of an nSi Battery

The procedure of Example 16 was modified to employ the nSi powder prepared in Example 15, and no CCA was added in the post-milling procedure. The charging/discharging cycle test of the resulting battery was modified to charge and discharge between 3.00 and 4.00 V. The specific discharge capacity of the battery was measured as 2460 mAh/g.

### Example 36

### Preparation of 2,3-DHA Modified Nano-Sized Si Powder

A sample of micron-sized particles from P-doped Si wafers was milled in benzene in the presence of 2,3-DHA, followed by solvent removal to produce nSi powder with surfaces modified by 2,3-DHA.

### Example 37

### Preparation of 9,10-phenanthrenequinone Modified Nano-Sized Si Powder

A sample of micron-sized particles from P-doped Si wafers was milled in benzene in the presence of 9,10-phenanthrenequinone, followed by solvent removal to produce nSi powder with surfaces modified by 9,10-phenanthrenequinone.

### Example 38

### Preparation of Etched Metallurgical Si Particles

Micron-sized metallurgical Si particles were treated at room temperature with two successive 1-hour washings with agitation in 6.2 M HCl. After each treatment, the acid solution was decanted from the particles followed by a rinse with deionized water (DI). The resulting Si particles were further treated with a 2.5M HF/2.8M NH₃ etching solution for about 10 minutes at room temperature. The etching solution was poured into a filtration device and the particles were washed thoroughly with DI water. The Si particles were then exposed to 2.5 M HF for about 5 minutes, filtered and washed thoroughly with DI water. The Si particles were spun dried then evacuated at 50° C. for several hours.

### Example 39

### Preparation of 2,3-DHA Modified Etched Metallurgical Si Particles

A sample of micron-sized Si particles prepared as described in Example 38 was milled in benzene in the presence of 2,3-DHA, followed by solvent removal to produce nSi powder with surfaces modified by 2,3-DHA.

### Example 40

### Preparation of C₆₀/C₇₀ Fullerene Modified Etched Metallurgical Si Particles

A sample of micron-sized Si particles prepared as described in Example 38 was milled in benzene in the presence of C₆₀/C₇₀ fullerene extract, followed by solvent removal to produce nSi powder with surfaces modified by C₆₀/C₇₀ fullerene.

### Example 41

### Preparation of Graphene Modified Etched Metallurgical Si Particles

A sample of micron-sized Si particles prepared as described in Example 38 was milled in benzene in the presence of grapheme, followed by solvent removal to produce nSi powder with surfaces modified by graphene.

### Example 42

### Preparation of Single Wall Carbon Nanotube Modified Etched Metallurgical Si Particles

A sample of micron-sized Si particles prepared as described in Example 38 was milled in benzene in the presence of single wall carbon nanotubes, followed by solvent removal to produce nSi powder with surfaces modified by single wall carbon nanotubes.

### Example 43

### Preparation of Multi-Wall Carbon Nanotube Modified Etched Metallurgical Si Particles

A sample of micron-sized Si particles prepared as described in Example 38 was milled in benzene in the presence of multi-wall carbon nanotubes, followed by solvent removal to produce nSi powder with surfaces modified by multi-wall carbon nanotubes.

### Example 44

### Preparation of 9,10-phenanthrenequinone Modified Etched Metallurgical Si Particles

A sample of micron-sized Si particles prepared as described in Example 38 was milled in benzene in the presence of 9,10-phenanthrenequinone, followed by solvent removal to produce nSi powder with surfaces modified by 9,10-phenanthrenequinone.

### Example 45

### Preparation of 2,3-DHA Modified Etched Metallurgical Si Particles

A sample of micron-sized Si particles prepared as described in Example 38 is milled in benzene in the presence of 2,3-DHA with substituents in the 9 and 10 positions (i.e., 2,3-dihydroxyanthracene 9,10-substituent), followed by solvent removal to produce nSi powder with surfaces modified by 2,3-DHA with substituents in the 9 and 10 positions, the substituents being fluorine or trifluoromethyl.

### Example 46

### Preparation of 2,3-dihydroxytetracene Modified Etched Metallurgical Si Particles

A sample of micron-sized Si particles prepared as described in Example 38 was milled in benzene in the presence of 2,3-dihydroxytetracene, followed by solvent removal to produce nSi powder with surfaces modified by 2,3-dihydroxytetracene.

### Example 47

### Preparation of 2,3-dihydroxytetracene Modified Etched Metallurgical Si Particles

A sample of micron-sized Si particles prepared as described in Example 38 was milled in benzene in the presence of fluorine or trifluromethyl substituted 2,3-dihydroxytetracene, followed by solvent removal to produce nSi powder with surfaces modified by fluorine or trifluromethyl substituted 2,3-dihydroxytetracene.

### Example 48

### Preparation of 2,3-dihydroxypentacene Modified Etched Metallurgical Si Particles

A sample of micron-sized Si particles prepared as described in Example 38 was milled in benzene in the presence of 2,3-dihydroxypentacene, followed by solvent removal to produce nSi powder with surfaces modified by 2,3-dihydroxypentacene.

### Example 49

### Preparation of 2,3-dihydroxypentacene Modified Etched Metallurgical Si Particles

A sample of micron-sized Si particles prepared as described in Example 38 was milled in benzene in the presence of fluorine or trifluromethyl substituted 2,3-dihydroxypentacene, followed by solvent removal to produce nSi powder with surfaces modified by fluorine or trifluromethyl substituted 2,3-dihydroxypentacene.

### Example 50

### Preparation of Pentacene Modified Etched Metallurgical Si Particles

A sample of micron-sized Si particles prepared as described in Example 38 was milled in benzene in the presence of pentacene, followed by solvent removal to produce nSi powder with surfaces modified by pentacene.

### Example 51

### Preparation of Pentacene Modified Etched Metallurgical Si Particles

A sample of micron-sized Si particles prepared as described in Example 38 was milled in benzene in the presence of fluorine or trifluromethyl substituted pentacene, followed by solvent removal to produce nSi powder with surfaces modified by fluorine or trifluromethyl substituted pentacene.

### Example 52

### Preparation of 2,3-DHA Modified Etched Metallurgical Si Particles

Micron-sized metallurgical Si particles were treated at room temperature with two successive 1-hour washings with agitation in 6.2 M HCl. After each treatment, the acid solution was decanted from the particles followed by a rinse with deionized water (DI). The resulting Si particles were further treated with a 2.5M HF/2.8M NH₃ etching solution for about 10 minutes at room temperature. The etching solution was poured into a filtration device and the particles were washed thoroughly with DI water. The micron-sized Si particles prepared were milled in benzene in the presence of 2,3-DHA, followed by solvent removal to produce nSi powder with surfaces modified by 2,3-DHA.

### Example 53

### Preparation of Surface Modified Etched Metallurgical Si Particles

The procedure described in Example 52 was modified by replacing 2,3-DHA with each of the reagents described in Examples 40-51: C₆₀/C₇₀ fullerene extract, graphene, single wall carbon nanotubes, multi-wall carbon nanotubes, 9,10-phenanthrenequinone, 2,3-DHA with substituents in the 9,10 positions, 2,3-dihydroxytetracene, fluorine, or trifluromethyl substituted 2,3-dihydroxytetracene, pentacene, and fluorinated or trifluromethylated pentacene.

### Example 54

### Preparation of 2,3-DHA Modified Etched Metallurgical Si Particles

Micron-sized metallurgical Si particles were treated at room temperature with two successive 1-hour washings with agitation in 6.2 M HCl. After each treatment, the acid solution was decanted from the particles followed by a rinse with deionized water. The micron-sized Si particles prepared were milled in benzene in the presence of 2,3-DHA, followed by solvent removal to produce nSi powder with surfaces modified by 2,3-DHA.

### Example 55

### Preparation of Surface Modified Etched Metallurgical Si Particles

The procedure described in Example 54 was modified by replacing 2,3-DHA with each of the reagents described in Examples 40-51: C₆₀/C₇₀ fullerene extract, graphene, single wall carbon nanotubes, multi-wall carbon nanotubes, 9,10-phenanthrenequinone, 2,3-DHA with substituents in the 9,10 positions, 2,3-dihydroxytetracene, fluorine, or trifluromethyl substituted 2,3-dihydroxytetracene, pentacene, and fluorinated or trifluromethylated pentacene.

### Example 56

### Modified Battery Charging/Discharging Cycle Tests

The battery charging/discharging cycle tests as described in Example 16 were modified to employ the use of imide pyrrolidinium electrolytes.

### Example 57

### Modified Battery Charging/Discharging Cycle Tests

The battery charging/discharging cycle tests as described in Example 16 were modified to employ the use of perfluoropolyether electrolytes.

### Example 58

### Fabrication of an nSi Battery

The battery preparation as described in Example 16 was modified to employ the use of LiFePO₄ as the cathode material.

### Example 59

### Fabrication of an nSi Battery

The battery preparation as described in Example 16 was modified to employ the use of LiNMC (LiNi_{1/3Co}1/3Mn_{1/3}O₂) as the cathode material.

### Example 60

### Fabrication of an nSi Battery

Micron-sized P-doped silicon particles (0.01-0.02 Ωcm) were milled in benzene in the presence of 5% by wt. C₆₀/C₇₀ fullerene extract pre-dissolved in benzene, followed by evaporation of solvent to produce nSi powder with surfaces modified by C₆₀ and C₇₀. This anode formulation was used to prepare coin cells as described in Example 16 with anode mass of 1.8-2.6 mg. Charging 0.03 mA between 3.9-3.0 V, the initial specific discharge capacity ranged from 662-951 mAh/g. Average specific discharge capacity fade after the first 5 cycles was 11%.

### Example 61

### Fabrication of an nSi Battery

To the nSi particles of Example 60 was added P3HT (8% by wt.) and multi-wall carbon nanotubes (8% by wt.) following the procedure of Example 22. The anode mass ranged from 1.1-1.3 mg. Charging 0.03 mA from 3.9-3.0 V, the initial specific discharge capacity ranged between 1350-1720 mAh/g.

### Example 62

### Fabrication of an nSi Battery

The procedure in Example 61 was modified to replace pyrene with industrial grade multi-wall carbon nanotubes (1.3% by wt.) and C₆₀/C₇₀ fullerene extract (1.4% by wt.). The anode mass ranged from 1.1-1.3 mg. Charging CC 0.03 mA from 3.9-3.0 V, the initial specific discharge capacity ranged between 1350-1720 mAh/g.

### Example 63

### Fabrication of an nSi Battery

Micron-sized Si particles prepared as described in Example 38 were milled in benzene in the presence of pyrene (8.5% by wt.) and C₆₀/C₇₀ fullerene extract (1.7% by wt.) pre-dissolved in benzene, followed by evaporation of the solvent to produce nSi powder with surfaces modified by fullerenes and pyrene. This anode formulation was used to make coin cells as described in Example 16 with anode mass of 0.6-1.1 mg. Charging CC 0.03 mA between 3.9 to 3.0V, the initial specific discharge capacity ranged between 1380-2550 mAh/g. Average specific discharge capacity fade after the first 4 cycles was 14%.

### Example 64

### Fabrication of an nSi Battery

Micron-sized particles prepared as described in Example 38 were milled in mesitylene in the presence of pyrene, followed by evaporation of the solvent to produce nSi powder with surfaces modified by pyrene. This anode formulation was used to prepare coin cells as described in Example 16 with anode mass of 0.5-0.7 mg. Charging 0.03 mA between 3.9-3.0 V, the specific discharge capacity ranged from 2360-3000 mAh/g.

### Example 65

### Preparation of Mesitylene Modified nSi/Sn Alloy Nanoparticles

Micron-sized particles prepared as described in Example 38 were milled in mesitylene in the presence of added Sn particles (20% by wt.), followed by evaporation of the solvent to produce nSi/Sn alloy nanoparticles with surfaces modified by mesitylene.

### Example 66

### Preparation of Mesitylene Modified nSi/Ge Alloy Nanoparticles

Micron-sized particles prepared as described in Example 38 were milled in mesitylene in the presence of added Ge particles (20% by wt.), followed by evaporation of the solvent to produce nSi/Ge alloy nanoparticles with surfaces modified by mesitylene.

### Example 67

### Preparation of Mesitylene Modified nSi/Sn/Ni Alloy Nanoparticles

Micron-sized particles prepared as described in Example 38 were milled in mesitylene in the presence of added Sn particles (15% by wt.) and Ni particles (15%), followed by evaporation of the solvent to produce nSi/Sn/Ni alloy nanoparticles with surfaces modified by mesitylene.

### Example 68

### Preparation of Mesitylene Modified nSi/Ti/Ni Alloy Nanoparticles

Micron-sized particles prepared as described in Example 38 were milled in mesitylene in the presence of added Ti particles (15% by wt.) and Ni particles (15%), followed by evaporation of the solvent to produce nSi/Ti/Ni alloy nanoparticles with surfaces modified by mesitylene.

### Example 69

### Preparation of Mesitylene Modified nSi/Sn Alloy Nanoparticles

Micron-sized particles prepared as described in Example 38 were milled in mesitylene (15% by wt.) in the presence of added Sn particles (20% by wt.), followed by evaporation of the solvent to produce nSi/Sn alloy nanoparticles with surfaces modified by mesitylene.

### Example 70

### Preparation of Mesitylene Modified nSi/Sn Alloy Nanoparticles

Micron-sized particles prepared as described in Example 38 were milled with C₆₀/C₇₀ fullerenes extract (5% by wt.) dissolved in mesitylene in the presence of added Sn particles (20% by wt.), followed by evaporation of the solvent to produce nSi/Sn alloy nanoparticles with surfaces modified by C₆₀/C₇₀ fullerenes and mesitylene.

### Example 71

### Preparation of Carbonized Conductive Carbon Modified nSi Nanoparticles

Micron-sized Si particles prepared as described in Example 38 were milled in xylenes following evaporation of the solvents to produce nSi particles with surfaces modified by xylenes. Subsequent heating of the particles to 650° C. under an atmosphere of argon with 1% H₂ produced silicon nanoparticles with surfaces surrounded by carbonized conductive carbon.

### Example 72

### Fabrication of an nSi Battery

The procedure in Example 22 was modified to employ the use of multi-wall carbon nanotubes (8% by wt.) in addition to P3HT (8% by wt.). Anode mass ranged from 1.1-1.3 mg. Charging CC 0.03 mA from 3.9-3.0 V, the initial specific discharge capacity ranged between 1350-1720 mAh/g

### Example 73

### Fabrication of an nSi Battery

The procedure for forming the electrodes in Example 16 was modified to include no additional conductive carbon added to the anode formulation, and the battery components were sized to 57×larger area (114 cm²) cut in a rectangular shape. The components were laid together between rigid glass plates with the positive and negative current collectors wired to the leads of a 0-5 V battery analyzer (MTI BST8-MA) (0.1-10 mA). Charge/discharge CC 1.0 mA between 3.9 to 3.0 V gave a peak specific discharge capacity of 951 mAh/g on the second discharge cycle. Cycle retention after the first 8 cycles based on the specific discharge capacity of cycle 2 was 96.1%.

### Example 74

### Preparation of Nano-Sized Si Powder from Metallurgical Si

A sample of micron-sized particles of metallurgical Si was milled in p-xylene, followed by solvent removal to produce a nano-sized Si powder (nSi) passivated by p-xylene.

### Example 75

### Preparation of 2,3-DHN Modified Etched Metallurgical Si Particles

The procedure in Example 39 was modified to employ p-xylene as the combination solvent instead of benzene and 2,3-DHN was employed to replace 2,3-DHA, and produce nSi particles with surfaces modified by 2,3-DHN.

### Example 76

### Fabrication of an nSi Battery

To the nSi particles of Example 60 was added carbon black (60% by wt.) following the procedure of Example 22. The anode mass ranged from 1.3-1.9 mg. Charging CC 0.03 mA from 3.9-3.0 V, the initial specific discharge capacity ranged between 587-968 mAh/g.

### Example 77

### Fabrication of an nSi Battery

To the nSi particles of Example 60 was added carbon black (45% by wt.) and P3HT (poly-3-hexylthiophene) (15% by wt.) following the procedure of Example 22. The anode mass ranged from 1.0-1.9 mg. Charging CC 0.03 mA from 3.9-3.0 V, the initial specific discharge capacity ranged between 627-1500 mAh/g.

### Example 78

### Fabrication of an nSi Battery

To the nSi particles of Example 62 was added carbon black (45% by wt.) and P3HT (poly-3-hexylthiophene) (15% by wt.) following the procedure of Example 22. The anode mass ranged from 0.6-0.9 mg. Charging CC 0.03 mA from 3.9-3.0 V, the initial specific discharge capacity ranged between 1460-2200 mAh/g.

### Example 79

### Fabrication of an nSi Battery

Anodes were made as in Example 76 except that dried anodes were calendered with a roller-press. The thickness of the calendered anode film decreased from 14 micron to 4 micron. Anode mass ranged from 1.5-1.8 mg. Charging CC 0.03 mA from 3.9-3.0 V, the initial specific discharge capacity ranged between 846-1002 mAh/g.

### Example 80

### Pre-Lithiation of the Negative Electrode

A 16 mm diameter lithium foil disc and a 16 mm diameter negative electrode on copper substrate were positioned together with a 20 mm Celgard separator film between. These discs were soaked in a 1 M LiPF₆ electrolyte solution (as described in Example 16) and positioned between stainless steel discs pressed together, submerged in the electrolyte solution and the potential across the stack was monitored. Lithiation was considered complete after the monitored potential dropped to zero. The lithium molar percentage was 30-60% depending on the mass ratio of the lithium foil to silicon nanoparticles.

### Example 81

### Pre-Lithiation of the Negative Electrode

Micron-sized Si particles prepared as described in Example 38 were milled in diglyme in the presence of tert-butyllithium followed by addition of mesitylene. Subsequent evaporation of the solvents produced lithiated nSi powder with surfaces modified by mesitylene.

### Example 82

### Evaluation of Charge/Discharge Cycles of a Si-NP Negative Electrode

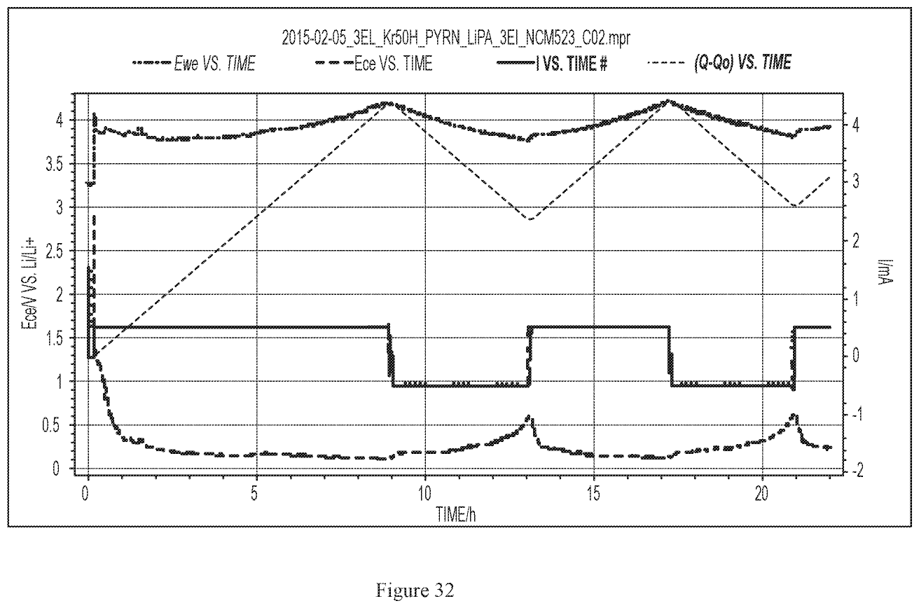

A Si-NP negative electrode composite was prepared by combining the Si-NP solids dispersed in NMP with graphite and carbon black in an aqueous slurry of 15 wt. % Li PA polymer. The negative electrode (counter electrode) was paired with a NCM523 working electrode, with both electrodes referenced to a Li reference electrode. FIG. 32 depicts charge/discharge voltage and current profiles that resulted from the electrochemical evaluations in this study.

### Example 83

### Evaluation of Charge/Discharge Cycles of a Si-NP Negative Electrode

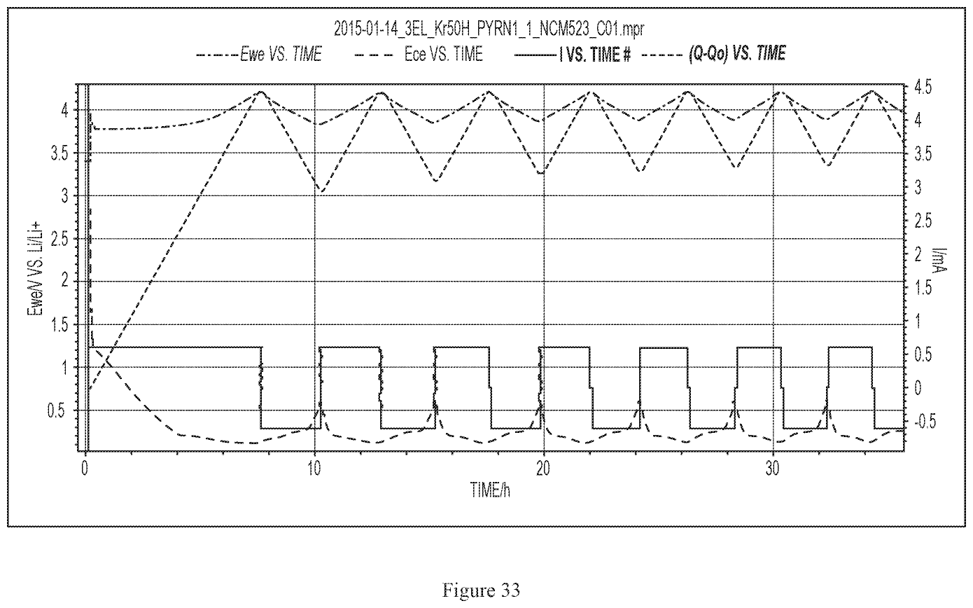

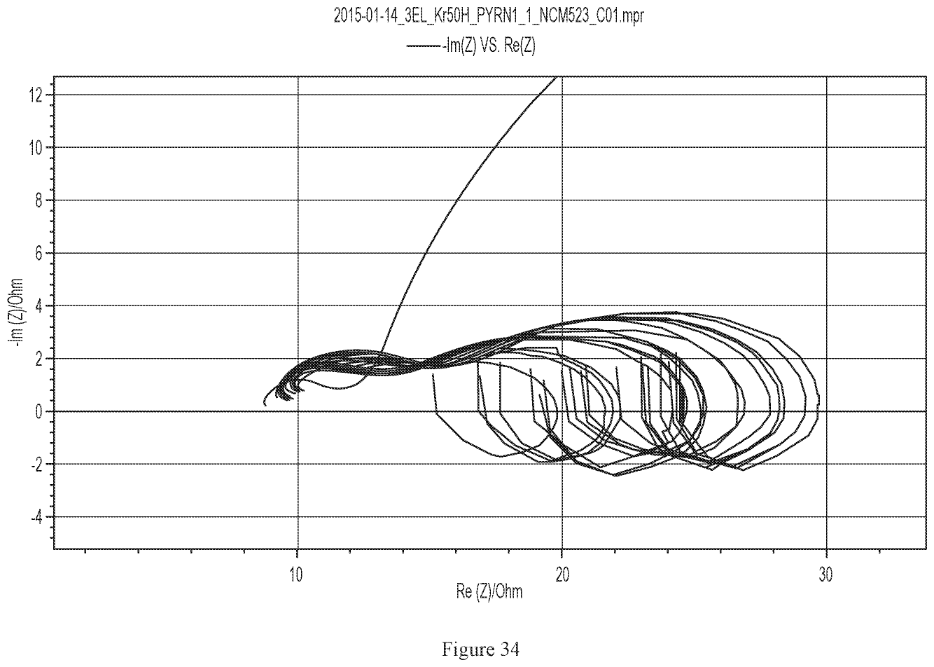

A Si-NP negative electrode composite was prepared by combining graphite and carbon black and the Si-NP in a slurry prepared with a 5 wt. % solution of PVDF in NMP solvent. The negative electrode (counter electrode) was paired with a NCM523 (working) electrode, with both referenced to a Li reference electrode. FIG. 33 depicts charge/discharge voltage and current profiles that resulted from the electrochemical evaluations in this study. FIG. 34 shows the potentiostatic electrochemical impedance profiles measured during charge/discharge cycling.

### Example 84

Surface modification and particle size distribution of silicon-based LIB anode materials can be controlled to provide good cycling stability and high cycle efficiency. Some examples that were prepared are shown below. (i) Build a temporary Li half-cell with the Si electrode and a Li foil electrode and charge the Si electrode to some specified potential. Then disassemble the half-cell and reassemble the prelithiated electrode into a full cell. (ii) Prelithiate the whole electrode laminate by submersion in an electrolyte solution and apply current until a desired potential difference is reached relative to a Li foil counter electrode. (iii) Prelithiate the electrode laminate or individual Si electrodes chemically by exposing the electrode to a suitable electrolyte solution that supports Li—active aromatic reagents (e.g. lithium naphthalenide or lithium pyrenide) and a clean Li foil. This method may be conducted under various conditions as shown in the examples below. (iv) Prelithiate SiNPs prior to mixing the electrode slurry with graphite and polymer binders. This can be accomplished by sonicating a SiNP slurry in an appropriate electrolyte solvent that supports Li—active aromatic reagents that serve as a surface modifier on the SiNPs. (v) Prelithiate SiNPs during the comminution process by adding the surface modifier in the form of a Li—active aromatic reagent. All of these processes utilize Li in a reduced state and are preferably conducted under strict anaerobic and anhydrous conditions.

### Example 85

A Si/graphite electrode (15 mm dia.) was punched out of a laminate on 10 μm Cu substrate. This electrode was paired with a Li foil counter electrode in a Swedgelok cell using 1.2 M LiPF₆ in EC/EMC 3:7 (90%) with 10% FEC added. The Si/graphite electrode was configured as the working electrode and allowed to accept Li by constant-current discharge from the Li counter electrode at a rate of C/20 until the potential difference of 0.11 V was reached. The cell was disassembled under Ar and reassembled again with a lithium iron phosphate (LFP) electrode (14 mm diameter). A full charge/discharge cycle was run to determine first cycle efficiency (FCE).

### Example 86

A Si/graphite electrode laminate in an Ar-filled glove-box was connected as the working electrode to a galvanostatic controller with a Li foil electrode connected as the counter electrode. These electrodes were separated from direct contact by a Cellgard separator film and pressed together between polyethylene (PE) separator films bathed with the electrolyte solution. The cell was cycled through two formation cycles, then partially discharged to 0.11 V. The partially prelithiated electrode film was evaluated by punching out 15 mm diameter electrodes and used to make coin-cells. FCE and cycle capacity was measured.

### Example 87

A Si/graphite/PVdF electrode laminate was placed in communication with a Li⁺ pyrenide solution in ethyl diglyme (or gamma butyrolactone). Lithium foil stripped of surface oxidation is on the bottom of the PE plastic vessel with a glass wool separator sandwiched between Cellgard films separating the two electrodes. The electrodes were allowed to equilibrate for 24 hours. After this period, the Si electrode was washed with clean ethyl diglyme and allowed to dry. Electrode discs (15 mm diameter) were cut out and the individual electrodes were pressed between heated (90° C.) polished dies with 60 Kg/m² force. The electrodes were then heated in vacuo for 14 hours to 235° C. before being assembled into coin cells with Li (half-cell) or LFP (whole cell) electrodes.

### Example 88

SiNPs were added to an electrolyte solution of Li⁺ pyrenide in an organic carbonate or lactone in a Cu vessel. A Li counter electrode was connected to a potentiostat controller with a Li reference electrode and the working electrode connected to the Cu mesh. The SiNPs were lithiated at constant voltage (0.01V) to target 25% of the expected theoretical capacity. The SiNPs were then used in making an electrode slurry by combining them with a polymer solution and graphite. The slurry was used to cast an electrode laminate on Cu substrate.

### Example 89

SiNPs were partially prelithiated in situ by the addition of surface modifiers (SM) in the form of Li⁺SM⁻ during comminution of metallurgical Si. After the initial volume of milling solvent has been added and is circulating through the slurry line, about half of the total amount of Li⁺SM⁻ is added initially, followed immediately by the addition of the entire amount of graded and pretreated metallurgical Si that is used for the batch run. Over the course of the milling run, the remainder of the Li⁺SM⁻ was added before ending the milling and recovering the SiNP product. The slurry was processed with inert solvents with exclusion of oxygen and moisture throughout the processes including post processing including stripping of solvents from the product.

### Example 90

Metallurgical Si sand (40 g; 325-170 mesh) was mulled under Ar atmosphere with 0.3 g of Li foil until no visible Li foil remained. The Li infused Si sand was further agitated for 16 hours (longer agitation time and/or equilibration time may be required to allow migration of Li into the Si phase) by tumbling in a polypropylene bottle with several 12 mm diameter ceramic balls. The Li/Si sand was combined with 15 mL of anhydrous heptanes freshly distilled under Ar just prior to adding to the mixing vessel of a circulating bead mill charged with 0.5-0.7 mm yittria stabilized zirconia beads and 370 mL of anhydrous heptanes. With a circulation rate of about 0.5 L per minute and the agitator tip speed running about 12.5 m/s, the Li/Si sand was added to the mixing vessel under an Ar purge. Comminution of the Si/Li slurry continued for 5 hours, after which time the slurry was expelled into an evaporating flask under Ar purge. Solvent was stripped from the slurry in-vacuo at 60 degrees Celsius and held under dynamic vacuum for at least 60 minutes at 80-85 degrees Celsius.

### Example 91

Describe the preparation of aqueous slurries using LiPAA or CMC/SBR(styrene-butadiene rubber) using SiNPs made according to Example 90.

### Example 92

The same procedure was followed as in Example 6 except that 0.4 g of TiO₂ anatase powder (Alfa Aesar, 99.9%; APS 32 nm) was added immediately following the complete addition of the Li/Si sand. After 3.5 hours from the beginning of the run, 1.2 g of fluoroethylene carbonate (FEC) was added. Comminution was allowed to continue for a total of 5 hours before collecting the slurry and stripping the volatiles as described in Example 90.

### Example 93

The same procedure was followed as in Example 91 except that 1.2 g of poly(acrylic acid) (Sigma Aldrich, average My about 450,000) was added to the slurry 10 minutes prior to collecting the slurry and stripping volatiles as described in Example 90.

### Example 94

Describe the preparation of aqueous slurries using LiPAA or CMC/SBR using SiNPs made as described in Example 91.

### Example 95

Sn powder (Alfa Aesar, 325-mesh, 99.8%) was mulled under Ar atmosphere with Li foil until no visible Li foil remained. The Sn/Li mixture was combined with metallurgical Si (325-170 mesh) and agitated by tumbling in a polypropylene container with about 12 of ½″ ceramic balls for at least 16 hours (even longer contact times can be beneficial). The Li/Sn/Si sand was milled according to the procedure in Example 90.

### Example 96

Examples 96-107 illustrate various approaches for the addition during milling of non Li-active metallic additives that could enhance electrode conductivity, Li-active metals that may alloy with Si or form separate solid phases (amorphous or crystalline), SMs that form artificial SEI, and SMs that primarily passivate lithiated Si particles from reactions with aqueous-based slurries. These examples will be compared to lithiated Si particles with no passivation layers (Example 95).

Sn ingot (Alfa Aesar, 99.99%) was scraped to remove surface oxides, then heated with Li foil until a single liquid phase was formed. The Sn/Li alloy was allowed to cool and solidify. The Sn/Li lump was shaved into granules small enough to be passed through a 140 mesh screen. The Li/Sn sand was combined with Si sand and the mixture was milled according to the procedure in Example 90. m-Si+Li (0.5%)+Sn (2%)+TiO2(1%)+FEC (2%).

### Example 97

Kerf from Ge wafer manufacturing was mulled under Ar atmosphere with Li foil until no visible pieces of the Li foil remained. The Ge/Li sand was agitated for 16 hr (or longer) by tumbling a polypropylene vessel with about 12×12 mm diameter ceramic balls. The pre-lithiated Ge sand was then comminuted with Si sand and isolated as a micron/nanoparticle powder as described in Example 90. Additional surface modifiers were added to passivate the particles, rendering them air stable and to slow their reaction with water. m-Si+Ge/Li (2.5%)+TiO₂ (1%)+FEC (2%).

### Example 98

m-Si+Sn (2%)+TiO₂ (1%)+FEC (2%) (cf Example 96, but no Li added).

### Example 99

m-Si+Ge/Li (2.5%)+TiO₂ (1%)+FEC (2%).

### Example 100

m-Si+TiO₂ (1%)+FEC (2%)+LiAlH₄ (0.71%).

### Example 101

m-Si+Li (0.75%)+TiO₂ (1%)+FEC (2%)+VC (0.5%).

### Example 102

m-Si+Li (0.75%)+TiO₂ (1%)+FEC (2%)+VC (0.5%)+LiF (2%)+Li₂CO₃ (2%).

### Example 103

m-Si+Cu (2%)+TiO₂ (1%)+FEC (2%).

### Example 104

m-Si+Fe (2%)+TiO₂ (1%)+FEC (2%).

### Example 105

m-Si+Al (2%)+TiO₂ (1%)+FEC (2%).

### Example 106

m-Si+Fe₃O₄(2%)+TiO₂ (1%)+FEC (2%).

### Example 107

m-Si+Cu (5%)+TiO₂ (1%)+FEC (2%).

### Example 108

### Benzene Passivated Silicon Particles

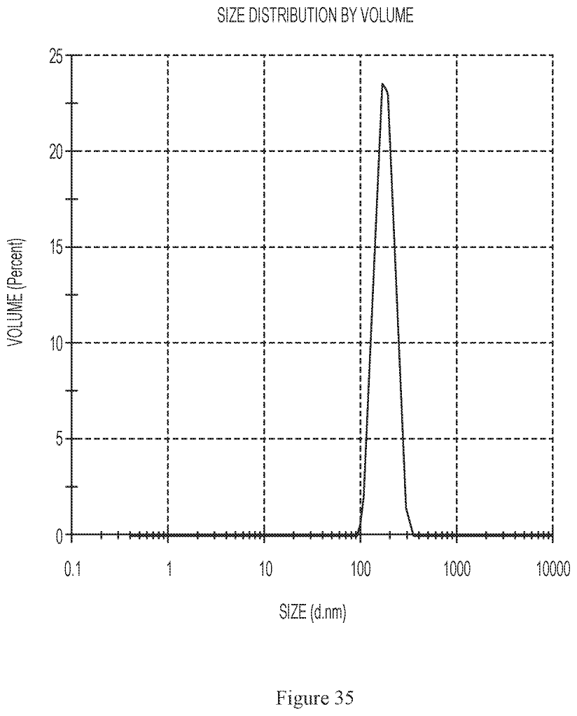

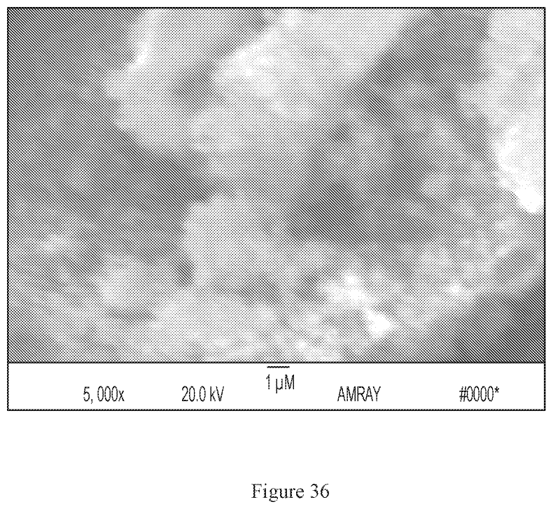

In one example, p-type silicon wafers with measured resistivity of 2-4 ohm/cm² were crushed, then ground with mortar and pestle, then passed through a #60 mesh sieve. The powder was further reduced to submicron particles by milling the Si sand in a bead mill (0.5-0.6 mm stabilized Zr beads) with benzene used as the solvent to make a slurry with about 15 wt % Si. After a period of time, the slurry was pumped out of the mill and the solvent was evaporated in a rotary evaporator yielding a dark brown powder. A particle size distribution measured by dynamic light scattering (Malvem Zetasizer) was recorded from an isopropyl alcohol suspension with the average particle size of about 175 nm (D50) shown in FIG. 35. The initial SEM image shown in FIG. 36 of the particles is poorly resolved, but it is shown to give a general scale of the particle size.

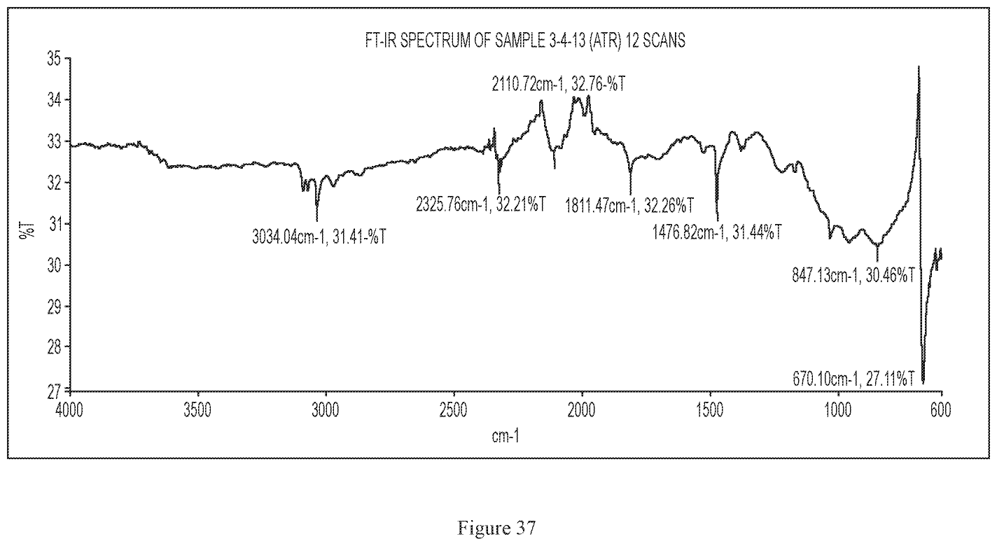

One qualitative test for surface organics is the measurement of a Fourier Transform InfraRed (FTIR) spectrum. FTIR measures modes of molecular vibrations due to stretching and bending frequencies of molecular bonds. While it is possible in FIG. 37 to see evidence of the FTIR fingerprint left behind by benzene, there are no significant shifts in the C—H stretching frequencies due to perturbations from their bonding interactions to the Si surfaces. C—C bending patterns will have to be examined in more detail. This is where perturbations (wave number shifts) will be most prominent if those interactions are indeed strong enough to shift bands beyond spectral resolution limits (+4 cm¹).

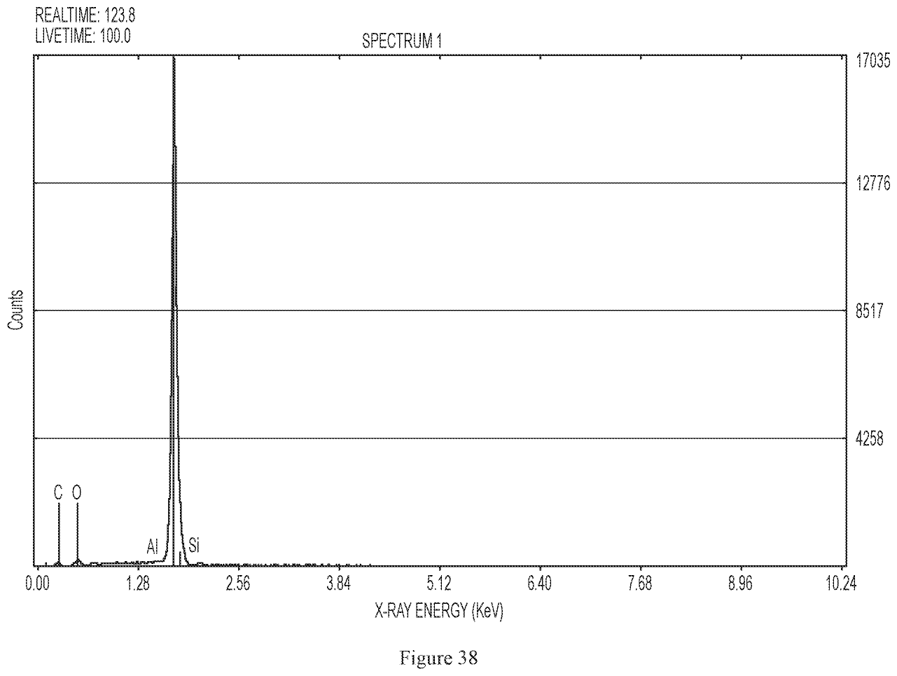

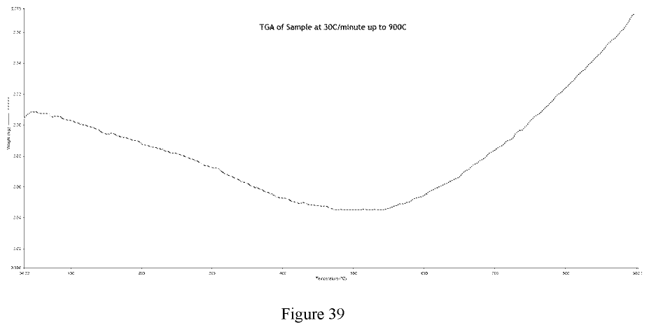

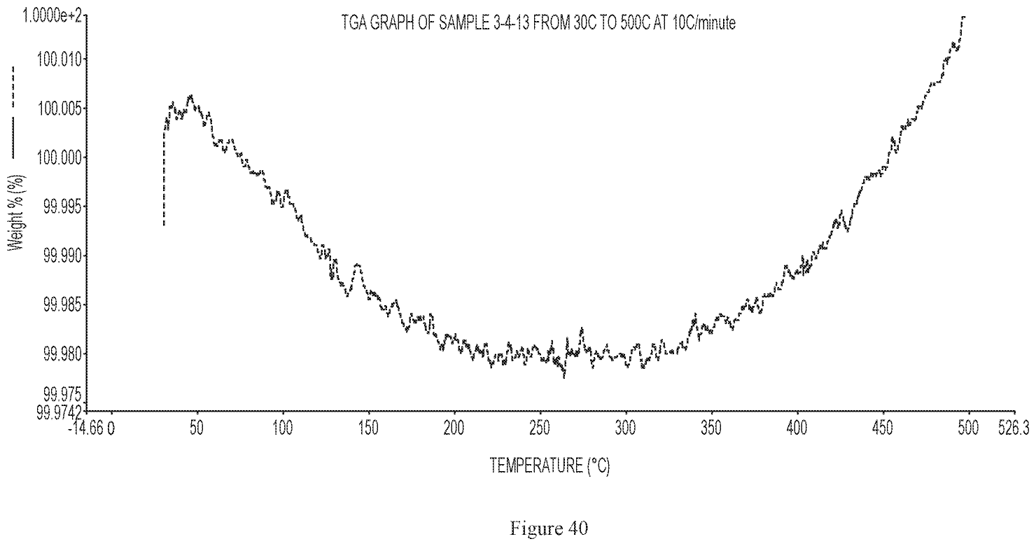

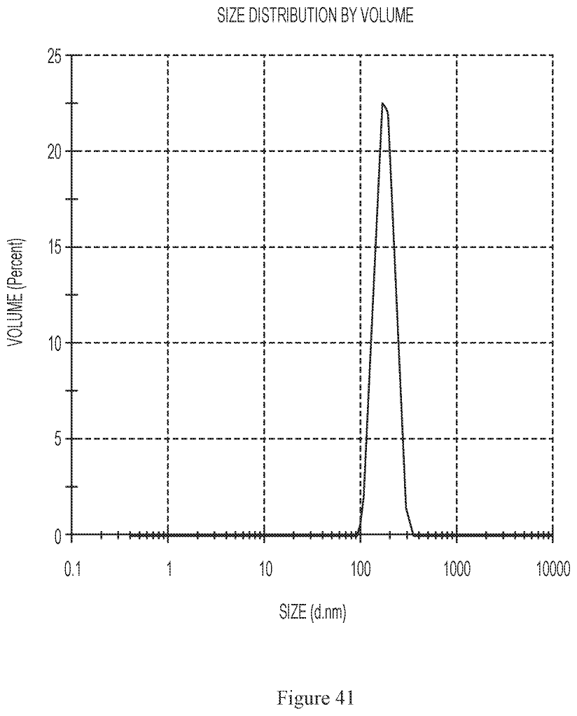

The elemental composition as determined by energy dispersive x-ray analysis (EDXA) is shown to be predominately silicon with observable carbon and oxygen signals appearing (FIG. 38). Further evidence that benzene is bound to the particle surfaces with bonding interactions that appear stronger than hydrogen bonding, but not as well defined as would be expected from a discrete monolayer, is shown in TGA scans. FIGS. 39 and 40 represent TGA scans run at heating rates of 30 degrees C./s and 10 degrees C./s, respectively. The initial scan at 30 degrees C./s was done to quickly observe the thermal profile up to 900° C. Under these conditions, the compound appears stable to oxidation up to 500° C. Also notable is the fact that it appears to lose mass gradually with no distinct onset temperature for mass loss. Benzene stays adsorbed well past its boiling point. The slower scan rate in FIG. 40 demonstrates that while benzene is continuously evolved from the sample, throughout the temperature range, the material will survive up to 250° C. for several minutes before beginning to oxidize at this slower scan rate. For this reason, using this material in a fixed (packed) bed reactor held at a sustained temperature may not survive beyond 250° C. However, the dynamic desorption of surface bound benzene does not occur instantly and could protect the Si surface from oxidation briefly at higher temperatures. The mass loss accounts for only 0.02% of the total mass before oxidation begins to occur.

Following a similar procedure, other hydrocarbon passivated micron- to nano-sized particles can be created using n-type Group IVA wafers, or wafers with higher or lower resistivity or bulk MG Group IVA material.

### Example 109

### Formation of PAN Coated SiNP

Metallurgical silicon classified 140×325 mesh was milled by circulating slurry bead mill in heptane under an argon atmosphere with poly(acrylonitrile) (3 wt %) added. The total solids loading of the milling slurry was 14% and the beads used were 0.3-0.4 mm diameter. For a 40 g batch of Si, the total milling time is about 5 hrs. The slurry was pumped into an evaporation flask and the solvent was removed by evacuation on a laboratory rotary evaporator. The particle size distribution was recorded (FIG. 41) APSD (D50)=133 nm.

### Example 110

### Combining SiNP with Flake Natural Graphite (FNG)

85 g of Asbury 230U flake natural graphite and 15 g of Si NP (made from metallurgical silicon milled with poly(acrylonitrile) (3 wt %) with APSD (D50)=136 nm were blended under argon atmosphere in a 3-dimensional blender or “Turbula” (turbulent mixer) for 2-8 hrs. This uncoated blend of powders was used to make electrode laminates using LiPAA aqueous binder.

### Example 111

### Coating of FNG+SiNPs

A portion of the mixed powder (10 g) from the prior example was stirred in a Schlenk-flask under argon atmosphere with heptanes under a slow purge of propylene. To the stirred slurry was added 0.25 g of a radical initiator (t-butyl peroxide). The slurry was allowed to stir overnight or about 16 hrs after which period the volatiles were evaporated by heating the flask in-vacuo to 60° C. yielding a fine black powder.

### Example 112

### Electrochemical Performance

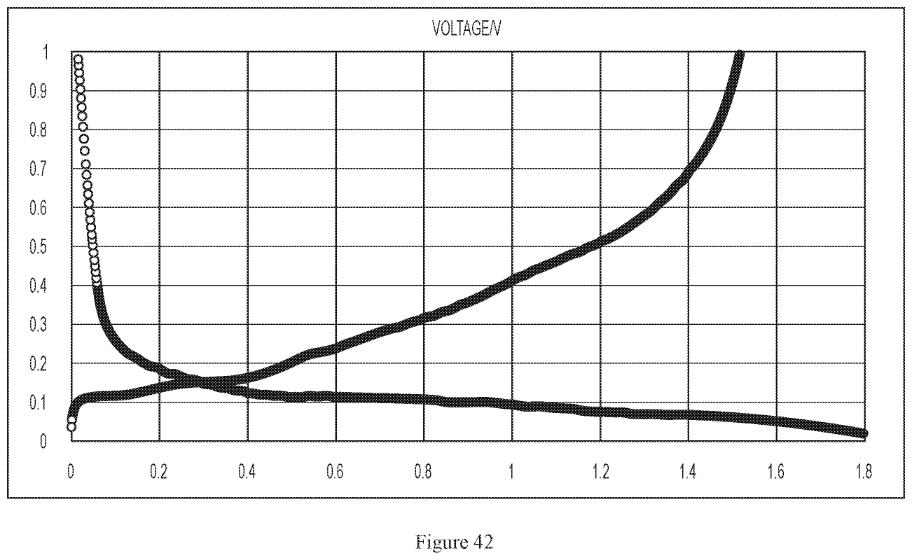

Next, the Li-active powders and about 2 wt % of carbon black were blended with a 10 wt % solution of polyacrylic acid neutralized with LiOH in deionized water. This slurry was blended and degassed in a planetary mixer until the slurry was suitable for spreading on Cu substrate with a doctor blade and the laminate was allowed to air dry. From the dried laminate, several disks (14 mm dia.) were cut and paired with 16 mm dia. Li foil electrodes each with 2 Celgard 2500 separator films in 2025 coin cells. The electrolyte used was 1.2M LiPF6 in 1:1:1 EC/DME/DEC with 10 wt % FEC added. The first discharge/charge cycle run at C/20 was recorded and is shown in FIG. 42.

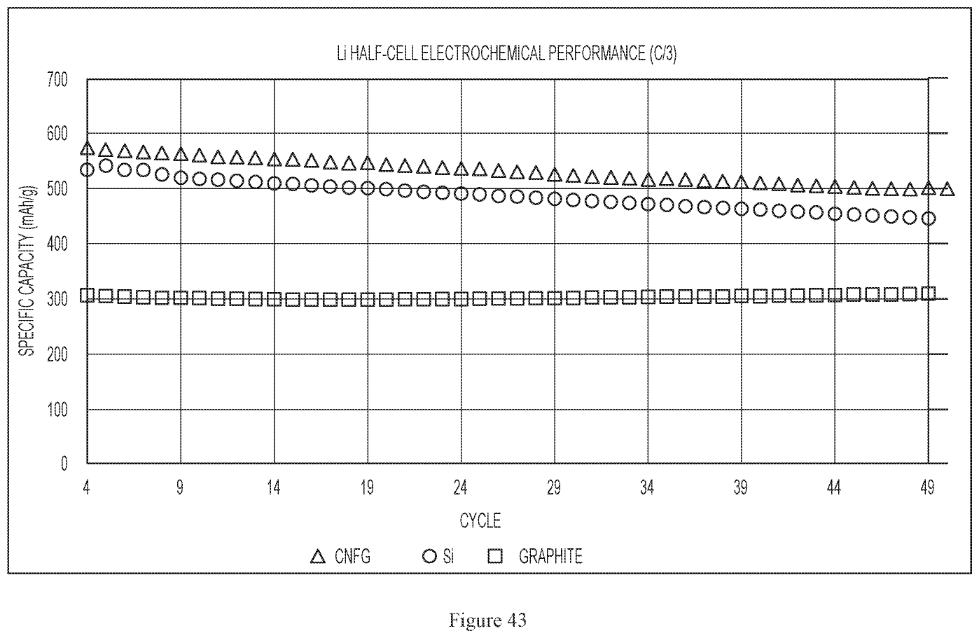

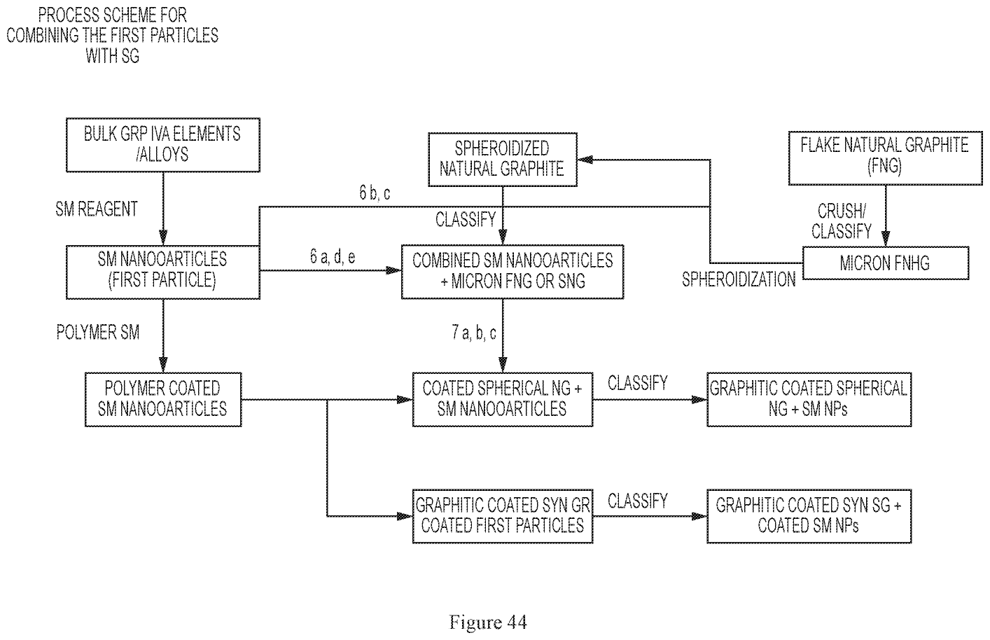

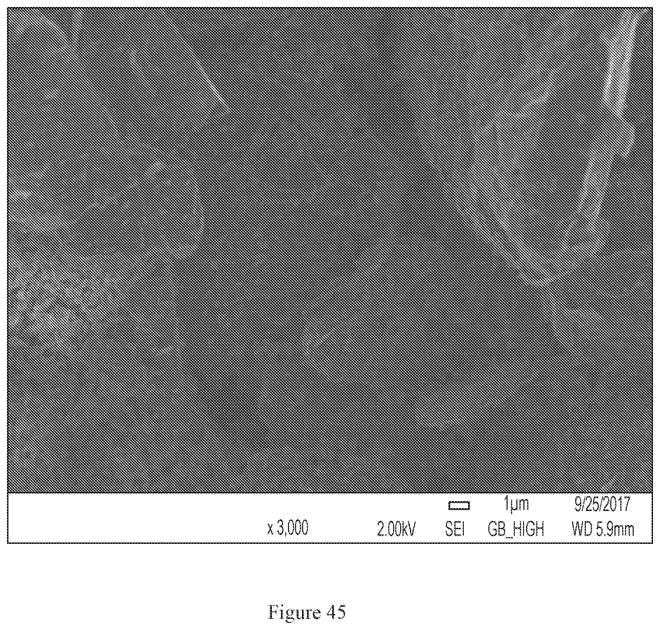

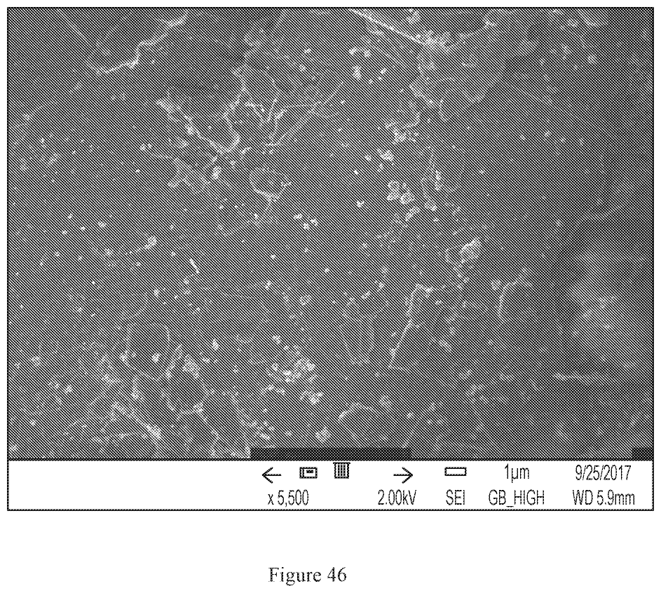

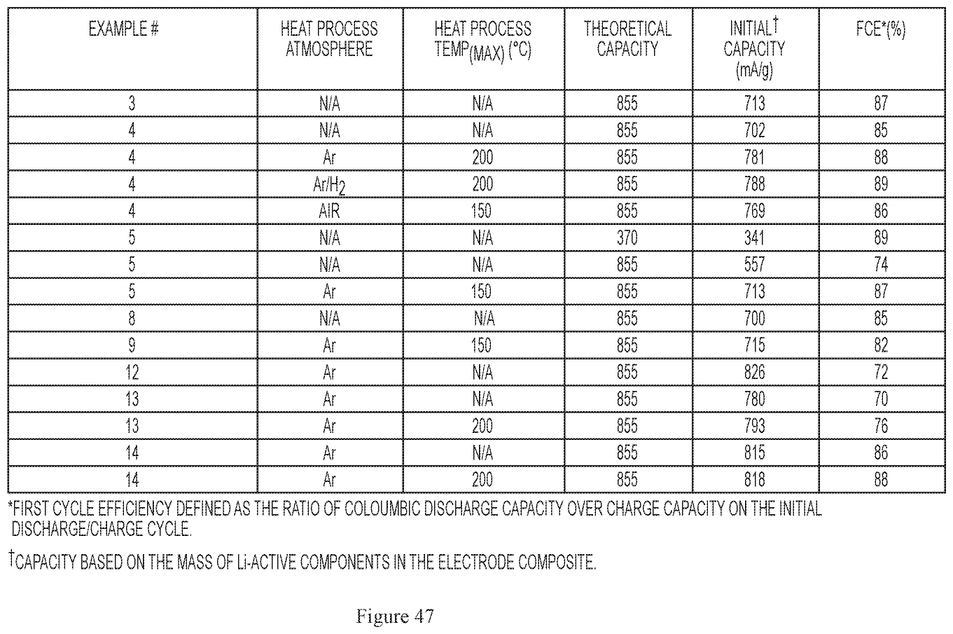

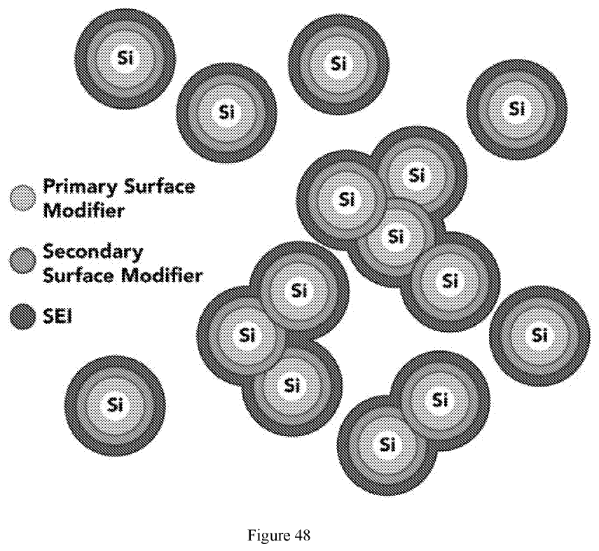

Comparative examples showing up to 50 charge/discharge cycles at C/3 are shown in FIG. 43.

### Example 113

Si NPs powder was siphoned into a high velocity pressurized gas injected into a jet mill at a rate such that the mass ratio of SiNP to graphite is 2%-20% under conditions used to spheronize flake graphite particles (typically lower velocity that used for initial size reduction of graphite). Collisions between the SiNPs and graphite particles cause abrasion of the graphite particles, such that the graphite becomes more rounded and somewhat smaller in dimension. Sub-micron Si particles became imbedded in the graphite surfaces and within crevices open to the surface. The graphite particles were classified in a cyclone classifier to separate isolate the optimum size range from particles outside the optimum range and later the selected range of particles are coated by any desired method (typically CVD) to stabilize the surface and to seal the SiNP under the coating.

### Example 114

Si NPs were introduced to spheronized graphite ranging in size between 2-40 microns by combining the particles in mass ratios of about 2-20% together in a vortex during a classification of the spheronized graphite particles. Collisions of the SiNPs with the spheronized graphite particles results in imbedding of the SiNPs on the surface and in pores, cracks or crevices on the graphite surfaces. The time and velocity of this process will vary depending on the desired size range of the finished products. The classified particles were then coated by any desired method (typically CVD) to stabilize the surface and to seal the SiNP under the coating.

### Example 115

Graphite and SiNP powders were mixed together in an 85:15 mass ratio respectively in a vessel used for a planetary mixer. The powders were mixed by the action of the rotating action of the planetary mixer at 2,200 r.p.m. for four 30 second intervals. A brief pause between intervals is to prevent excessive heating.

### Example 116

Graphite and SiNP powders were mixed in an 85:15 mass ratio respectively by stirring together in a slurry suspended in normal heptane. The slurry was stirred at ambient temperature overnight (about 16 hrs) then the solvent was evacuated leaving the dry powder mixture of graphite and SiNP.

### Example 117

SiNP made as described in example 109 and SG were were added in a 15:85 mass ratio to a stirred solution of 5 wt % carboxymethyl cellulose (CMC) in DI water to make a viscous slurry. The slurry was spin-cast to form thin ribbons which were allowed to dry. The dried mass was crushed and graded by a 100 mesh sieve and the resulting powder was heated in a ceramic boat in a furnace to 1,200° C. for 4 hrs. The furnace was allowed to cool slowly to room temperature over a 16 hr period.

### Example 118

Powdered mixture of graphite and SiNP were coated by chemical vapor deposition by exposure of the powders to propylene gas in a tumble dryer at 130° C. in the presence of a 0.5 wt % of a radical initiator (t-butyl peroxide). After 8 hrs the vessel was evacuated and repressurized with Ar/H₂ (95:5 mol %).

### Example 119

10 g of a powder consisting of 85% graphite and 15% SiNP was stirred into a THF solution of 0.8 g poly(methylmethacrylate) (PMMA). The solution was stirred at 50° C. in a Schlenk flask under argon atmosphere overnight after which time the solvent was evaporated in-vacuo yielding a dry powder.

### Example 120

A slurry was made from 10 g of graphite with PAN coated SiNP imbedded on the graphite surfaces, then further coated with PAN similar to the procedure in example 12, except that dimethylformamide (DMF) was used as the solvent. The powder was re-suspended and stirred in heptane. To this stirred slurry under argon in a Schlenk flask was added 0.5 g of succinamide. The mixture was allowed to stir overnight at room temperature, after which time the solvent was evaporated in-vacuo, yielding a dry powder.

### Example 121

A slurry was made from 10 g of polyaramid-coated SiNP with SiNP was suspended and stirred in heptane. To this stirred slurry under argon in a Schlenk flask was added 0.5 g of titanium tert-butoxide. The mixture was allowed to stir overnight at room temperature, after which time the solvent was evaporated in-vacuo, yielding a dry powder.

### Example 122

The powders in examples 120 and 121 were loaded into glass vials and placed in a 1″ diameter quartz furnace tube. Under an Ar purge, the tube was heated to 200° C. for 4 hrs, then allowed to cool slowly to room temperature. These heat treatments were also done without inert atmosphere, but the maximum temperature to which the powders was heated in air or in a vacuum oven was 150° C. The heat-treated powders were evaluated as electrode composites in Li-half-cells.

### Example 123

The powders in examples 117-119 were heated in a tube furnace under Ar and under Ar/H₂ (95:5) to 600 c and 800° C. for 4 hrs, then allowed to cool to ambient temperature under the same atmosphere. The product was ground into powders, graded through a 325 mesh sieve and the fine powders were evaluated as electrode composites in Li half-cells.

### Example 124

THF slurry from example 119 was spray-dried to form micron-sized particles of agglomerated SiNP imbedded in the polymer matrix. The powders were heat treated in-vacuo at 120° C. for 16 hrs before adding binders and carbon black to make slurries for electrode laminates.

### Example 125

SiNPs coated with a primary layer such as a polyaramid was chosen as a precursor substrate for a second layer coating that can be applied by any of a variety of methods. The coating may consist of a substance that has a surface-active functional group, such as a carboxylate or an amide on one end of the molecule that will form a covalent bond or hydrogen bond to the polyaramid amide functional group on the primary layer. One example of this compound is a perfluorocarboxylate. These compound can be combined by stirring together in a non-competing solvent. The bond will form at room temperature or it may require heating to the reflux temperature of the solvent depending on the chosen reagent of the second layer. The coated particles are isolated by evaporation of the solvent under reduce pressure. It is also possible that these coated particles can be recovered by flocculation upon addition of a secondary solvent, thus forming a slurry that will allow filtration of the solid coated particles.

### Example 126

SiNPs coated with a primary layer such as a polyaramid was chosen as a precursor substrate for a second layer coating that can be applied by any of a variety of methods. The coating may consist of a polymer that has a surface-active functional group, such as a carboxylate, epoxide or an amide on the polymer chain that is available to form a covalent bond or hydrogen bond to the polyaramid amide functional group on the primary layer. The polymer once bonded to the primary layer provides a continuous coating that has flexibility and will expand initially upon volumetric expansion of the first particle (as such during lithiation), but will not contract to its original position when the first particle volume contracts (as such during delithiation). This leave a void in which the first particle may expand and contract again in subsequent charge/discharge cycles without disturbing the SEI layer formed on the outside of the second layer. The second layer coating may be applied in any of a number of techniques known in material synthesis. One technique as described in example 124 is spray-drying, in which a solution comprising the coated under reduced pressure, whereby the volatile solvent will flash evaporate and form microspheres of the NPs as single particles or clusters of NPs with a continuous coating that has the properties just described in this example. Another process could be used to coat and separated polymer-coated particles, such as dispersion of the coated particles in a plasma or any fluid that will act to separate the particles from one another while the solvent is released and the polymer coating is allowed to crystallize, cure or condense to encase the first particle with the primary coating.

### EXEMPLARY EMBODIMENTS

For reasons of completeness, various aspects of the disclosure are set out in the following numbered clauses.

Clause 1. A method of making a graphite composite particle comprising:

a) providing a first particle, wherein the first particle has a core material comprising silicon, silicon oxide (SiOx where x is <2), germanium, tin, lead, iron, aluminum, lithium, cobalt, or an alloy of any combination of any one or more of silicon, germanium, tin, lead, iron, aluminum, lithium or cobalt;

b) providing a graphite particle;

c) combining the first particle and the graphite particle to provide a graphite composite particle wherein the first particle is embedded on the surface or in a pore of the graphite particle.

Clause 2. The method of clause 1, wherein the dimension of the first particle is between 15 nm-500 nm.

Clause 3. The method as in any of clauses 1-2 wherein the graphite particle is flake natural graphite, spherical graphite or synthetic graphite.

Clause 4. The method as in any of clauses 1-3 wherein the graphite particle has pore openings ranging in size of 200-1000 nm.

Clause 5. The method as in any of clauses 1-4 wherein the graphite particle size distribution is between 2000 nm-40000 nm.

Clause 6. The method as in any of clauses 1-5 wherein the first particle is combined with the graphite particle by a process comprising combining the first particle with graphite particle in a turbulent mixer capable of homogenizing dry powders without causing significant changes in particle shapes or size distributions.

Clause 7. The method as in any of clauses 1-5 wherein the first particle is combined with the graphite particle by a process comprising combining the first particle with the graphite particle during a dry spheronization process in which the graphite particle becomes abraded and captures the first particle on the surface or within pore openings in the surface of the graphite particle.

Clause 8. The method as in any of clauses 1-5 wherein the first particle is combined with the graphite particle, which is a spheronized graphite particle, by a process comprising combining the first particle with the spheronized graphite particle during a classifying step in which the spheronized graphite is fluidized in a gas with the first particle, such that the first particle becomes embedded on the surface or within a pore in the graphite particle.

Clause 9. The method as in any of clauses 1-5 wherein the first particle is combined with the graphite particle by a process comprising combining the first particle with the graphite particle in a planetary centrifugal mixer.

Clause 10. The method as in any of clauses 1-5 wherein the first particle is combined with the graphite particle by a process comprising combining the first particle with the graphite particle by stirring them together in a solvent followed by evaporation of the solvent.

Clause 11. The method as in any of clauses 1-5 wherein the first particle is combined with the graphite particle, wherein the graphite particle is a synthetic graphite precursor by a process comprising combining the first particle with the synthetic graphite precursor followed by heat processing to graphitize the precursor and surrounding the first particle within the synthetic graphite.

Clause 12. The method as in any of clauses 1-11 wherein the graphite composite particle is coated with a compound by chemical vapor deposition.

Clause 13. The method of clause 12 wherein the compound is selected from the group consisting of a light alkene or alkyne such as ethylene, propylene or acetylene, styrene, neoprene, butenes, butadiene, pentenes, pentadiene, organic carbonates, fluorinated alkenes, 1H, 1H, 2H-pefluoroalkenes (wherein the alkene is C3-C12).

Clause 14. The method as in any of clauses 1-11 wherein the graphite composite particle is coated by stirring the graphite composite particle together in a solution with solvated polymer, followed by evaporation of the solvent.

Clause 15. The method of clause 14 wherein the solvated polymer is selected from the group consisting of polyacrylonitrile (PAN) in n,n-dimethylformamide (DMF), or polyethylene-co-acrylic acid in THF, or polymethyl methacrylate (PMMA) in THF, or polystyrene in THF.

Clause 16. The method as in any of clauses 1-11 wherein the graphite composite particle is coated by stirring the graphite composite particle in a solvent with a reagent or combination of reagents that form(s) a polymer, followed by evaporation of the solvent.

Clause 17. The method as in any of clauses 12-16 wherein the coated graphite composite particle is subjected to a heat treatment process to cure the coating.

Clause 18. The method as in any of clauses 12-16 wherein the coated graphite composite particle is subjected to a process to induce cross-link coupling of the coating constituents.

Clause 19. The method as in any of clauses 1-18 wherein the first particle is passivated by a non-dielectric layer covering at least a portion of a surface of the first particle.

Clause 20. The method of clause 19 wherein the non-dielectric layer is derived from a compound selected from the group consisting of hydrogen (H2), alkenes, alkynes, aromatics, heteroaromatics, cycloalkenes, alcohols, glycols, thiols, disulfides, amines, amides, pyridines, pyrroles, furans, thiophenes, cyanates, isocyanates, isothiocyanates, ketones, carboxylic acids, amino acids, and aldehydes.

Clause 21. The method of clause 19 wherein the non-dielectric layer is derived from a compound selected from the group consisting of 1,2-dimethoxyethane (also referred to as glyme, monoglyme, dimethyl glycol, or dimethyl cellosolve); 1-methoxy-2-(2-methoxyethoxy)ethane (also referred to as diglyme, 2-methoxyethyl ether, di(2-methoxyethyl)ether, or diethylene glycol dimethyl ether); 1,2-bis(2-methoxyethoxy)ethane (also referred to as triglyme, triethylene glycol dimethyl ether, 2,5,8,11-tetraoxadodecane, 1,2-bis(2-methoxyethoxy)ethane, or dimethyltriglycol); 2,5,8,11,14-pentaoxapentadecane (also referred to as tetraglyme, tetraethylene glycol dimethyl ether, bis[2-(2-methoxyethoxy)ethyl]ether, or dimethoxytetraglycol); dimethoxymethane (also referred to as methylal); methoxyethane (also referred to as ethyl methyl ether); methyl tert-butyl ether (also referred to as MTBE); diethyl ether; diisopropyl ether; di-tert-butyl ether; ethyl tert-butyl ether; dioxane; furan; tetrahydrofuran; 2-methyltetrahydrofuran; and diphenyl ether.

Clause 22. The method of clause 19 wherein the non-dielectric layer is derived from a compound selected from the group consisting of toluene, benzene, a polycyclic aromatic, a fullerene, a metallofullerene, a styrene, a cyclooctatetraene, a norbomadiene, a primary alkene, a primary alkyne, a saturated or unsaturated fatty acid, a peptide, a protein, an enzyme, 2,3,6,7-tetrahydroxyanthracene, catechol, 2,3-hydroxynaphthalene, 9,10-dibromoanthracene, and terephthalaldehyde.

Clause 23. The method of clause 19 wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

Clause 24. The method of clause 19 wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

Clause 25. The method of clause 19 wherein the non-dielectric layer is derived from a compound selected from the group consisting of polyaramids, PAN, polyacrylic acid (PAA) and its neutralized salt, MPAA (M=Li, Na or K), polyethylene oxide (PEO), poly(methyl methacrylate) (PMMA), carboxymethyl cellulose (CMC), polyaniline (PANI), polyimide (PI), poly(ethylene-co-acrylic acid) (PEAA), cellulose, monosaccharides and polysaccharides.

Clause 26. The method of clause 19 wherein the non-dielectric layer is derived from a compound selected from the group consisting of metal-oxides, titanium isopropoxide (Ti(i-OPr)4, where OPr═OC3H7), and aluminum isopropoxide (Al(i-OPr)3)

Clause 27. The method of clause 19 wherein the non-dielectric layer is derived from a compound selected from the group consisting of carboxylates, EC, EMC, DMC, MEC, FEC DFEC, vinylene carbonate, perfluoroalkyl ethylene carbonates, perfluoroalkenes (C2-C12) and 1H,H1,H2-perfluoroalkenes (C3-C12).

Clause 28. The method of clause 19 wherein the non-dielectric layer is derived from a compound selected from the group consisting of p-phenylenediamine, succinamide, phenylene diamines (o-, m- and p-analogs) and alkyldiamides ranging from C2-C12.

Clause 29. The method as in any of clauses 1-28 wherein the first particle has an outer surface that is substantially free of silicon oxide species, as characterized by X-ray photoelectron spectroscopy (XPS).

Clause 30. The method of clause 29 wherein the outer surface of the first particle has a SiOx content of less than or equal to 1%, as characterized by X-ray photoelectron spectroscopy (XPS), wherein x is ≤2.

Clause 31. The method as in any of clauses 1-30 wherein the core material of the first particle further comprises:

a) one or more elements used for p-type semiconductor doping, the elements independently selected from boron, aluminum, and gallium;

b) one or more elements used for n-type semiconductor doping, the elements independently selected from nitrogen, phosphorous, arsenic, and antimony;

c) one or more elements found in metallurgical silicon, the elements independently selected from aluminum, calcium, titanium, iron, and copper;

d) one or more conductive metals independently selected from aluminum, nickel, iron, copper, molybdenum, zinc, silver, and gold;

e) or any combination thereof.

Clause 32. The method as in any of clauses 1-31 wherein the core material of the first particle is free of p-type and n-type semiconductor doping elements.

Clause 33. The method as in any of clauses 1-32 wherein the core material of the first particle has an outer surface modified with one or more surface-modifying agents, wherein the surface-modifying agent is benzene, mesitylene, xylene, 2,3-dihydroxynaphthalene, 2,3-dihydroxyanthracene, 9,10-phenanthrenequinone, 2,3-dihydroxytetracene, fluorine substituted 2,3-dihydroxytetracene, trifluromethyl substituted 2,3-dihydroxytetracene, 2,3-dihydroxypentacene, fluorine substituted 2,3-dihydroxypentacene, trifluromethyl substituted 2,3-dihydroxypentacene, pentacene, fluorine substituted pentacene, naphthalene, anthracene, pyrene, perylene, triphenylene, chrysene, phenanthrene, azulene, pentacene, pyrene, a polythiophene, poly(3-hexylthiophene-2,5-diyl), poly(3-hexylthiophene), polyvinylidene fluoride, a polyacrylonitrile, polyaniline crosslinked with phytic acid, single wall carbon nanotubes, multi-walled carbon nanotubes, C60 fullerenes, C70 fullerenes, nanospherical carbon, graphene, graphite nanoplatelets, carbon black, soot, carbonized conductive carbon, or any combination thereof.

Clause 34. The method as in any of clauses 1-33 wherein the first particle is an alloy of the core material and lithium.

Clause 35. The method of clause 34 wherein the first particle alloy is coated with a continuous coating on the surface of the first alloy particle with one or more surface-modifying agents, the surface-modifying agent is a polymer or a monomer additive.

Clause 36. The method of clause 35 wherein the polymer additive is selected from the group consisting of polystyrene, polyacrylonitrile, polyacrylic acid, lithium polyacrylate, and polyaniline.

Clause 37. The method of clause 35 wherein the monomer additive is selected from the group consisting of selected from the group consisting of alkenes, alkynes, aromatics, heteroaromatics, cycloalkenes, alcohols, glycols, polyglycols, ethers, polyethers, thiols, disulfides, amines, amides, pyridines, pyrroles, imides, imidazoles, imidazoline, furans, thiophenes, cyanates, isocyanates, isothiocyanates, ketones, carboxylic acids, esters, amino acids, aldehydes, acrylates, methacrylates, oxylates, organic carbonates, lactones, and the gases H2, O2, CO2, N2O, and HF, and fluorinated analogs thereof.

Clause 38. The method of clause 35 wherein the continuous coating forms a protective shell capable of impeding diffusion of oxygen and/or water to cores of the first particle alloy, wherein the continuous coating is capable of allowing Li+ ion mobility and/or facilitate electrical charge transfer from the first particle alloy to an electrode current collector.

Clause 39. A graphite composite particle made by the method of any of the previous clauses.

Clause 40. A graphite composite particle comprising:

a) a first particle, wherein the first particle has a core material comprising silicon, silicon oxide (SiOx where x is <2), germanium, tin, lead, iron, aluminum, lithium, cobalt, or an alloy of any combination of any one or more of silicon, germanium, tin, lead, iron, aluminum, lithium or cobalt;

b) and a graphite particle, wherein the first particle is embedded on the surface or in a pore of the graphite particle.

Clause 41. The graphite composite of clause 40, wherein the first particle has a non-dielectric layer covering at least a portion of a surface of the first particle.

Clause 42. The graphite composite of clause 41 wherein the non-dielectric layer is derived from a compound selected from the group consisting of hydrogen (H2), alkenes, alkynes, aromatics, heteroaromatics, cycloalkenes, alcohols, glycols, thiols, disulfides, amines, amides, pyridines, pyrroles, furans, thiophenes, cyanates, isocyanates, isothiocyanates, ketones, carboxylic acids, amino acids, and aldehydes.

Clause 43. The graphite composite of clause 41 wherein the non-dielectric layer is derived from a compound selected from the group consisting of 1,2-dimethoxyethane (also referred to as glyme, monoglyme, dimethyl glycol, or dimethyl cellosolve); 1-methoxy-2-(2-methoxyethoxy)ethane (also referred to as diglyme, 2-methoxyethyl ether, di(2-methoxyethyl)ether, or diethylene glycol dimethyl ether); 1,2-bis(2-methoxyethoxy)ethane (also referred to as triglyme, triethylene glycol dimethyl ether, 2,5,8,11-tetraoxadodecane, 1,2-bis(2-methoxyethoxy)ethane, or dimethyltriglycol); 2,5,8,11,14-pentaoxapentadecane (also referred to as tetraglyme, tetraethylene glycol dimethyl ether, bis[2-(2-methoxyethoxy)ethyl]ether, or dimethoxytetraglycol); dimethoxymethane (also referred to as methylal); methoxyethane (also referred to as ethyl methyl ether); methyl tert-butyl ether (also referred to as MTBE); diethyl ether; diisopropyl ether; di-tert-butyl ether; ethyl tert-butyl ether; dioxane; furan; tetrahydrofuran; 2-methyltetrahydrofuran; and diphenyl ether.

Clause 44. The graphite composite of clause 41 wherein the non-dielectric layer is derived from a compound selected from the group consisting of toluene, benzene, a polycyclic aromatic, a fullerene, a metallofullerene, a styrene, a cyclooctatetraene, a norbomadiene, a primary alkene, a primary alkyne, a saturated or unsaturated fatty acid, a peptide, a protein, an enzyme, 2,3,6,7-tetrahydroxyanthracene, catechol, 2,3-hydroxynaphthalene, 9,10-dibromoanthracene, and terephthalaldehyde.

Clause 45. The graphite composite of clause 41 wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

Clause 46. The graphite composite of clause 41 wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

Clause 47. The graphite composite of clause 41 wherein the non-dielectric layer is derived from a compound selected from the group consisting of polyaramids, PAN, polyacrylic acid (PAA) and its neutralized salt, MPAA (M=Li, Na or K), polyethylene oxide (PEO), poly(methyl methacrylate) (PMMA), carboxymethyl cellulose (CMC), polyaniline (PANI), polyimide (PI), poly(ethylene-co-acrylic acid) (PEAA), cellulose, monosaccharides and polysaccharides.

Clause 48. The graphite composite of clause 41 wherein the non-dielectric layer is derived from a compound selected from the group consisting of metal-oxides, titanium isopropoxide (Ti(i-OPr)4, where OPr═OC3H7), and aluminum isopropoxide (Al(i-OPr)3)

Clause 49. The graphite composite of clause 41 wherein the non-dielectric layer is derived from a compound selected from the group consisting of carboxylates, EC, EMC, DMC, MEC, FEC DFEC, vinylene carbonate, perfluoroalkyl ethylene carbonates, perfluoroalkenes (C2-C12) and 1H,H1,H2-perfluoroalkenes (C3-C12).

Clause 50. The graphite composite of clause 41 wherein the non-dielectric layer is derived from a compound selected from the group consisting of p-phenylenediamine, succinamide, phenylene diamines (o-, m- and p-analogs) and alkyldiamides ranging from C2-C12.

Clause 51. The graphite composite of clauses 40-50 wherein the first particle has an outer surface that is substantially free of silicon oxide species, as characterized by X-ray photoelectron spectroscopy (XPS).

Clause 52. The graphite composite of clause 51 wherein the outer surface of the first particle has a SiOx content of less than or equal to 1%, as characterized by X-ray photoelectron spectroscopy (XPS), wherein x is ≤2.

Clause 53. The graphite composite of clause 40 wherein the first particle has an outer surface modified with one or more surface-modifying agents, wherein the surface-modifying agent is benzene, mesitylene, xylene, 2,3-dihydroxynaphthalene, 2,3-dihydroxyanthracene, 9,10-phenanthrenequinone, 2,3-dihydroxytetracene, fluorine substituted 2,3-dihydroxytetracene, trifluromethyl substituted 2,3-dihydroxytetracene, 2,3-dihydroxypentacene, fluorine substituted 2,3-dihydroxypentacene, trifluromethyl substituted 2,3-dihydroxypentacene, pentacene, fluorine substituted pentacene, naphthalene, anthracene, pyrene, perylene, triphenylene, chrysene, phenanthrene, azulene, pentacene, pyrene, a polythiophene, poly(3-hexylthiophene-2,5-diyl), poly(3-hexylthiophene), polyvinylidene fluoride, a polyacrylonitrile, polyaniline crosslinked with phytic acid, single wall carbon nanotubes, multi-walled carbon nanotubes, C60 fullerenes, C70 fullerenes, nanospherical carbon, graphene, graphite nanoplatelets, carbon black, soot, carbonized conductive carbon, or any combination thereof.

Clause 54. The graphite composite of clause 40 wherein the first particle is an alloy of the core material and lithium.

Clause 55. The graphite composite of clause 54 wherein the first particle alloy is coated with a continuous coating on the surface of the first alloy particle with one or more surface-modifying agents, the surface-modifying agent is a polymer or a monomer additive.

Clause 56. The graphite composite of clause 55 wherein the polymer additive is selected from the group consisting of polystyrene, polyacrylonitrile, polyacrylic acid, lithium polyacrylate, and polyaniline.

Clause 57. The graphite composite of clause 55 wherein the monomer additive is selected from the group consisting of selected from the group consisting of alkenes, alkynes, aromatics, heteroaromatics, cycloalkenes, alcohols, glycols, polyglycols, ethers, polyethers, thiols, disulfides, amines, amides, pyridines, pyrroles, imides, imidazoles, imidazoline, furans, thiophenes, cyanates, isocyanates, isothiocyanates, ketones, carboxylic acids, esters, amino acids, aldehydes, acrylates, methacrylates, oxylates, organic carbonates, lactones, and the gases H2, O2, CO2, N2O, and HF, and fluorinated analogs thereof.

Clause 58. A method of making a coated particle comprising:

a) providing a first particle, wherein the first particle has a core material comprising silicon, silicon oxide (SiOx where x is <2), germanium, tin, lead, iron, aluminum, lithium, cobalt, or an alloy of any combination of any one or more of silicon, germanium, tin, lead, iron, aluminum, lithium or cobalt;

b) passivating the first particle by coating it with a non-dielectric layer covering the surface of the first particle.

c) coating the passivated first particle in its entirety.

Clause 59. The method of clause 58 wherein the non-dielectric layer is derived from a compound selected from the group consisting of hydrogen (H2), alkenes, alkynes, aromatics, heteroaromatics, cycloalkenes, alcohols, glycols, thiols, disulfides, amines, amides, pyridines, pyrroles, furans, thiophenes, cyanates, isocyanates, isothiocyanates, ketones, carboxylic acids, amino acids, and aldehydes.

Clause 60. The method of clause 58 wherein the non-dielectric layer is derived from a compound selected from the group consisting of 1,2-dimethoxyethane (also referred to as glyme, monoglyme, dimethyl glycol, or dimethyl cellosolve); 1-methoxy-2-(2-methoxyethoxy)ethane (also referred to as diglyme, 2-methoxyethyl ether, di(2-methoxyethyl)ether, or diethylene glycol dimethyl ether); 1,2-bis(2-methoxyethoxy)ethane (also referred to as triglyme, triethylene glycol dimethyl ether, 2,5,8,11-tetraoxadodecane, 1,2-bis(2-methoxyethoxy)ethane, or dimethyltriglycol); 2,5,8,11,14-pentaoxapentadecane (also referred to as tetraglyme, tetraethylene glycol dimethyl ether, bis[2-(2-methoxyethoxy)ethyl]ether, or dimethoxytetraglycol); dimethoxymethane (also referred to as methylal); methoxyethane (also referred to as ethyl methyl ether); methyl tert-butyl ether (also referred to as MTBE); diethyl ether; diisopropyl ether; di-tert-butyl ether; ethyl tert-butyl ether; dioxane; furan; tetrahydrofuran; 2-methyltetrahydrofuran; and diphenyl ether.

Clause 61. The method of clause 58 wherein the non-dielectric layer is derived from a compound selected from the group consisting of toluene, benzene, a polycyclic aromatic, a fullerene, a metallofullerene, a styrene, a cyclooctatetraene, a norbornadiene, a primary alkene, a primary alkyne, a saturated or unsaturated fatty acid, a peptide, a protein, an enzyme, 2,3,6,7-tetrahydroxyanthracene, catechol, 2,3-hydroxynaphthalene, 9,10-dibromoanthracene, and terephthalaldehyde.

Clause 62. The method of clause 58 wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

Clause 63. The method of clause 58 wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

Clause 64. The method of clause 58 wherein the non-dielectric layer is derived from a compound selected from the group consisting of polyaramids, PAN, polyacrylic acid (PAA) and its neutralized salt, MPAA (M=Li, Na or K), polyethylene oxide (PEO), poly(methyl methacrylate) (PMMA), carboxymethyl cellulose (CMC), polyaniline (PANI), polyimide (PI), poly(ethylene-co-acrylic acid) (PEAA), cellulose, monosaccharides and polysaccharides.

Clause 65. The method of clause 58 wherein the non-dielectric layer is derived from a compound selected from the group consisting of metal-oxides, titanium isopropoxide (Ti(i-OPr)4, where OPr═OC3H7), and aluminum isopropoxide (Al(i-OPr)3)

Clause 66. The method of clause 58 wherein the non-dielectric layer is derived from a compound selected from the group consisting of carboxylates, EC, EMC, DMC, MEC, FEC DFEC, vinylene carbonate, perfluoroalkyl ethylene carbonates, perfluoroalkenes (C2-C12) and 1H,H1,H2-perfluoroalkenes (C3-C12).

Clause 67. The method of clause 58 wherein the non-dielectric layer is derived from a compound selected from the group consisting of p-phenylenediamine, succinamide, phenylene diamines (o-, m- and p-analogs) and alkyldiamides ranging from C2-C12.

Clause 68. The method of any one of clauses 58-67 wherein the passivated first particle is coated with a compound by chemical vapor deposition.

Clause 69. The method of clause 68 wherein the compound is selected from the group consisting of a light alkene or alkyne such as ethylene, propylene or acetylene, styrene, neoprene, butenes, butadiene, pentenes, pentadiene, organic carbonates, fluorinated alkenes, 1H, 1H, 2H-pefluoroalkenes (wherein the alkene is C3-C12).

Clause 70. The method of in any of clauses 58-67 wherein the passivated first particle is coated by stirring the passivated first particle together in a solution with solvated polymer, followed by evaporation of the solvent.

Clause 71. The method of clause 70 wherein the solvated polymer is selected from the group consisting of polyacrylonitrile (PAN) in N,N-dimethylformamide (DMF), or polyethylene-co-acrylic acid in THF, or poly(methyl methacrylate) (PMMA) in THF, or polystyrene in THF.

Clause 72. The method as in any of clauses 58-67 wherein the passivated first particle is coated by stirring the particle in a solvent with a reagent or combination of reagents that form(s) a polymer, followed by evaporation of the solvent.

Clause 73. The method as in any of clauses 58-72 wherein the coated passivated first particle is subjected to a heat treatment process to cure the coating.

Clause 74. The method as in any of clauses 58-72 wherein the coated passivated first particle is subjected to a process to induce cross-link coupling of the coating constituents.

Clause 75. A method of making a coated particle comprising:

a) providing a first particle, wherein the first particle has a core material comprising silicon, silicon oxide (SiOx where x is <2), germanium, tin, lead, iron, aluminum, lithium, cobalt, or an alloy of any combination of any one or more of silicon, germanium, tin, lead, iron, aluminum, lithium or cobalt;

b) providing a surface modifier agent to the first particle;

c) coating the surface modified first particle in its entirety.

Clause 76. The method of clause 75 wherein the surface-modifying agent is selected from the group consisting of benzene, mesitylene, xylene, 2,3-dihydroxynaphthalene, 2,3-dihydroxyanthracene, 9,10-phenanthrenequinone, 2,3-dihydroxytetracene, fluorine substituted 2,3-dihydroxytetracene, trifluromethyl substituted 2,3-dihydroxytetracene, 2,3-dihydroxypentacene, fluorine substituted 2,3-dihydroxypentacene, trifluromethyl substituted 2,3-dihydroxypentacene, pentacene, fluorine substituted pentacene, naphthalene, anthracene, pyrene, perylene, triphenylene, chrysene, phenanthrene, azulene, pentacene, pyrene, a polythiophene, poly(3-hexylthiophene-2,5-diyl), poly(3-hexylthiophene), polyvinylidene fluoride, a polyacrylonitrile, polyaniline crosslinked with phytic acid, single wall carbon nanotubes, multi-walled carbon nanotubes, C60 fullerenes, C70 fullerenes, nanospherical carbon, graphene, graphite nanoplatelets, carbon black, soot, carbonized conductive carbon, or any combination thereof.

Clause 77. The method of clause 75 wherein the first particle is an alloy of the core material and lithium.

Clause 78. The method of clause 77 wherein the first particle alloy is coated with a continuous coating on the surface of the first alloy particle with one or more surface-modifying agents, the surface-modifying agent is a polymer or a monomer additive.

Clause 79. The method of clause 78 wherein the polymer additive is selected from the group consisting of polystyrene, polyacrylonitrile, polyacrylic acid, lithium polyacrylate, and polyaniline.

Clause 80. The method of clause 78 wherein the monomer additive is selected from the group consisting of selected from the group consisting of alkenes, alkynes, aromatics, heteroaromatics, cycloalkenes, alcohols, glycols, polyglycols, ethers, polyethers, thiols, disulfides, amines, amides, pyridines, pyrroles, imides, imidazoles, imidazoline, furans, thiophenes, cyanates, isocyanates, isothiocyanates, ketones, carboxylic acids, esters, amino acids, aldehydes, acrylates, methacrylates, oxylates, organic carbonates, lactones, and the gases H2, O2, CO2, N2O, and HF, and fluorinated analogs thereof.

Clause 81. A particle made by the method of any of clauses 58-80.

Clause 82. A coated particle comprising:

a) a core material comprising silicon, silicon oxide (SiOx where x is <2), germanium, tin, lead, iron, aluminum, lithium, cobalt, or an alloy of any combination of any one or more of silicon, germanium, tin, lead, iron, aluminum, lithium or cobalt;

b) a non-dielectric layer covering the surface of the core material.

c) a coating covering particle in its entirety.

Clause 83. The particle of clause 82 wherein the non-dielectric layer is derived from a compound selected from the group consisting of hydrogen (H2), alkenes, alkynes, aromatics, heteroaromatics, cycloalkenes, alcohols, glycols, thiols, disulfides, amines, amides, pyridines, pyrroles, furans, thiophenes, cyanates, isocyanates, isothiocyanates, ketones, carboxylic acids, amino acids, and aldehydes.

Clause 84. The particle of clause 82 wherein the non-dielectric layer is derived from a compound selected from the group consisting of 1,2-dimethoxyethane (also referred to as glyme, monoglyme, dimethyl glycol, or dimethyl cellosolve); 1-methoxy-2-(2-methoxyethoxy)ethane (also referred to as diglyme, 2-methoxyethyl ether, di(2-methoxyethyl)ether, or diethylene glycol dimethyl ether); 1,2-bis(2-methoxyethoxy)ethane (also referred to as triglyme, triethylene glycol dimethyl ether, 2,5,8,11-tetraoxadodecane, 1,2-bis(2-methoxyethoxy)ethane, or dimethyltriglycol); 2,5,8,11,14-pentaoxapentadecane (also referred to as tetraglyme, tetraethylene glycol dimethyl ether, bis[2-(2-methoxyethoxy)ethyl]ether, or dimethoxytetraglycol); dimethoxymethane (also referred to as methylal); methoxyethane (also referred to as ethyl methyl ether); methyl tert-butyl ether (also referred to as MTBE); diethyl ether; diisopropyl ether; di-tert-butyl ether; ethyl tert-butyl ether; dioxane; furan; tetrahydrofuran; 2-methyltetrahydrofuran; and diphenyl ether.

Clause 85. The particle of clause 82 wherein the non-dielectric layer is derived from a compound selected from the group consisting of toluene, benzene, a polycyclic aromatic, a fullerene, a metallofullerene, a styrene, a cyclooctatetraene, a norbomadiene, a primary alkene, a primary alkyne, a saturated or unsaturated fatty acid, a peptide, a protein, an enzyme, 2,3,6,7-tetrahydroxyanthracene, catechol, 2,3-hydroxynaphthalene, 9,10-dibromoanthracene, and terephthalaldehyde.

Clause 86. The particle of clause 82 wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

Clause 87. The particle of clause 82 wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

Clause 88. The particle of clause 82 wherein the non-dielectric layer is derived from a compound selected from the group consisting of polyaramids, PAN, polyacrylic acid (PAA) and its neutralized salt, MPAA (M=Li, Na or K), polyethylene oxide (PEO), poly(methyl methacrylate) (PMMA), carboxymethyl cellulose (CMC), polyaniline (PANI), polyimide (PI), poly(ethylene-co-acrylic acid) (PEAA), cellulose, monosaccharides and polysaccharides.

Clause 89. The particle of clause 82 wherein the non-dielectric layer is derived from a compound selected from the group consisting of metal-oxides, titanium isopropoxide (Ti(i-OPr)4, where OPr═OC3H7), and aluminum isopropoxide (Al(i-OPr)3)

Clause 90. The particle of clause 82 wherein the non-dielectric layer is derived from a compound selected from the group consisting of carboxylates, EC, EMC, DMC, MEC, FEC DFEC, vinylene carbonate, perfluoroalkyl ethylene carbonates, perfluoroalkenes (C2-C12) and 1H,H1,H2-perfluoroalkenes (C3-C12).

Clause 91. The particle of clause 82 wherein the non-dielectric layer is derived from a compound selected from the group consisting of p-phenylenediamine, succinamide, phenylene diamines (o-, m- and p-analogs) and alkyldiamides ranging from C2-C12.

Clause 92. The particle of any one of clauses 82-91 wherein the coating is selected from the group consisting of a light alkene or alkyne such as ethylene, propylene or acetylene, styrene, neoprene, butenes, butadiene, pentenes, pentadiene, organic carbonates, fluorinated alkenes, 1H, 1H, 2H-pefluoroalkenes (wherein the alkene is C3-C12).

Clause 93. The particle of any one of clauses 82-91 wherein the coating is selected from the group consisting of polyacrylonitrile (PAN), polyethylene-co-acrylic acid, polymethyl methacrylate (PMMA), or polystyrene.

Clause 94. An electrode film comprising a particle of any one of clauses 37 or 57 or 81-91, and one or more additives independently selected from polythiophenes, polyacrylonitrile, polyaniline crosslinked with phytic acid, sodium alginate, carbon black, nanospherical carbon, graphene, fullerenes, single-wall carbon nanotubes (SWCNT), and multi-wall carbon nanotubes (MWCNT).

Clause 95. The electrode film of clause 94, further comprising one or more polymer binders independently selected from polythiophenes, polyvinylidene difluoride (PVDF), polyacrylonitrile, sodium alginate, and lithium polyacrylates.

Clause 96. The electrode film of clause 94, further comprising one or more lithium reagents independently selected from the group consisting of Li+H3NB12H11-, Li+H3NB12F11-, 1,2-(H3N)2B12H10, 1,7-(H3N)2B12H10, 1,12-(H3N)2B12H10, 1,2-(H3N)2B12F10, 1,7-(H3N)2B12F10, and 1,12-(H3N)2B12F10, LiAl(ORF)4, or any combination thereof, wherein RF at each occurrence is independently selected from fluorinated-alkyl and fluorinated-aryl, provided the fluorinated-alkyl and fluorinated-aryl are not perfluorinated.

Clause 97. A lithium ion battery comprising:
a positive electrode;
a negative electrode comprising a particle of any one of clauses 37 or 57 or 81-91, wherein the negative electrode comprises a stable solid electrolyte interface (SEI) layer;
a lithium ion permeable separator between the positive electrode and the negative electrode;
an electrolyte comprising lithium ions; and

a solvent comprising ethylene carbonate, dimethyl carbonate, diethyl carbonate, methylethyl carbonate, or a combination thereof.

Clause 98. The lithium ion battery of clause 97, wherein the electrolyte comprises one or more of monofluoroethylene carbonate, Li+R3NB12H11-, Li+R3NB12F11-, Li+H3NB12H11-, Li+H3NB12F11-, 1,2-(H3N)2B12H10, 1,7-(H3N)2B12H10, 1,12-(H3N)2B12H10, 1,2-(H3N)2B12F10, 1,7-(H3N)2B12F10, 1,12-(H3N)2B12F10, LiAl(ORF)4, or any combination thereof, wherein R at each occurrence is independently selected from methyl, ethyl, propyl, iso-propyl, n-butyl, iso-butyl sec-butyl and t-butyl, and RF at each occurrence is independently selected from fluorinated-alkyl and fluorinated-aryl, provided the fluorinated-alkyl and fluorinated-aryl are not perfluorinated.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

Various features and advantages of the invention are set forth in the following claims.

What is claimed is:

1. A method of making a graphite composite particle comprising:
a) providing a first particle, wherein the first particle has a core material comprising silicon, silicon oxide (SiOₓ where x is <2), germanium, tin, lead, iron, aluminum, lithium, cobalt, or an alloy of any combination of any one or more of silicon, germanium, tin, lead, iron, aluminum, lithium or cobalt;
b) providing a graphite particle;
c) combining the first particle and the graphite particle to provide a graphite composite particle wherein the first particle is embedded on the surface or in a pore of the graphite particle.

2. The method of claim 1, wherein the dimension of the first particle is between 15 nm-500 nm.

3. The method as in any of claims 1-2, wherein the graphite particle is flake natural graphite, spherical graphite or synthetic graphite.

4. The method as in any of claims 1-3, wherein the graphite particle has pore openings ranging in size of 200-1000 nm.

5. The method as in any of claims 1-4, wherein the graphite particle size distribution is between 2000 nm-40000 nm.

6. The method as in any of claims 1-5, wherein the first particle is combined with the graphite particle by a process comprising combining the first particle with graphite particle in a turbulent mixer capable of homogenizing dry powders without causing significant changes in particle shapes or size distributions.

7. The method as in any of claims 1-5, wherein the first particle is combined with the graphite particle by a process comprising combining the first particle with the graphite particle during a dry spheronization process in which the graphite particle becomes abraded and captures the first particle on the surface or within pore openings in the surface of the graphite particle.

8. The method as in any of claims 1-5, wherein the first particle is combined with the graphite particle, which is a spheronized graphite particle, by a process comprising combining the first particle with the spheronized graphite particle during a classifying step in which the spheronized graphite is fluidized in a gas with the first particle, such that the first particle becomes embedded on the surface or within a pore in the graphite particle.

9. The method as in any of claims 1-5, wherein the first particle is combined with the graphite particle by a process comprising combining the first particle with the graphite particle in a planetary centrifugal mixer.

10. The method as in any of claims 1-5, wherein the first particle is combined with the graphite particle by a process comprising combining the first particle with the graphite particle by stirring them together in a solvent followed by evaporation of the solvent.

11. The method as in any of claims 1-5, wherein the first particle is combined with the graphite particle, wherein the graphite particle is a synthetic graphite precursor by a process comprising combining the first particle with the synthetic graphite precursor followed by heat processing to graphitize the precursor and surrounding the first particle within the synthetic graphite.

12. The method as in any of claims 1-11, wherein the graphite composite particle is coated with a compound by chemical vapor deposition.

13. The method of claim 12, wherein the compound is selected from the group consisting of a light alkene or alkyne such as ethylene, propylene or acetylene, styrene, neoprene, butenes, butadiene, pentenes, pentadiene, organic carbonates, fluorinated alkenes, 1H, 1H, 2H-pefluoroalkenes (wherein the alkene is C3-C12).

14. The method as in any of claims 1-11, wherein the graphite composite particle is coated by stirring the graphite composite particle together in a solution with solvated polymer, followed by evaporation of the solvent.

15. The method of claim 14, wherein the solvated polymer is selected from the group consisting of polyacrylonitrile (PAN) in n,n-dimethylformamide (DMF), or polyethylene-co-acrylic acid in THF, or polymethyl methacrylate (PMMA) in THF, or polystyrene in THF.

16. The method as in any of claims 1-11, wherein the graphite composite particle is coated by stirring the graphite composite particle in a solvent with a reagent or combination of reagents that form(s) a polymer, followed by evaporation of the solvent.

17. The method as in any of claims 12-16, wherein the coated graphite composite particle is subjected to a heat treatment process to cure the coating.

18. The method as in any of claims 12-16, wherein the coated graphite composite particle is subjected to a process to induce cross-link coupling of the coating constituents.

19. The method as in any of claims 1-18, wherein the first particle is passivated by a non-dielectric layer covering at least a portion of a surface of the first particle.

20. The method of claim 19, wherein the non-dielectric layer is derived from a compound selected from the group consisting of hydrogen (H₂), alkenes, alkynes, aromatics, heteroaromatics, cycloalkenes, alcohols, glycols, thiols, disulfides, amines, amides, pyridines, pyrroles, furans, thiophenes, cyanates, isocyanates, isothiocyanates, ketones, carboxylic acids, amino acids, and aldehydes.

21. The method of claim 19, wherein the non-dielectric layer is derived from a compound selected from the group consisting of 1,2-dimethoxyethane (also referred to as glyme, monoglyme, dimethyl glycol, or dimethyl cellosolve); 1-methoxy-2-(2-methoxyethoxy)ethane (also referred to as diglyme, 2-methoxyethyl ether, di(2-methoxyethyl)ether, or diethylene glycol dimethyl ether); 1,2-bis(2-methoxyethoxy)ethane (also referred to as triglyme, triethylene glycol dimethyl ether, 2,5,8,11-tetraoxadodecane, 1,2-bis(2-methoxyethoxy)ethane, or dimethyltriglycol); 2,5,8,11,14-pentaoxapentadecane (also referred to as tetraglyme, tetraethylene glycol dimethyl ether, bis[2-(2-methoxyethoxy)ethyl]ether, or dimethoxytetraglycol); dimethoxymethane (also referred to as methylal); methoxyethane (also referred to as ethyl methyl ether); methyl tert-butyl ether (also referred to as MTBE); diethyl ether; diisopropyl ether; di-tert-butyl ether; ethyl tert-butyl ether; dioxane; furan; tetrahydrofuran; 2-methyltetrahydrofuran; and diphenyl ether.

22. The method of claim 19, wherein the non-dielectric layer is derived from a compound selected from the group consisting of toluene, benzene, a polycyclic aromatic, a fullerene, a metallofullerene, a styrene, a cyclooctatetraene, a norbomadiene, a primary alkene, a primary alkyne, a saturated or unsaturated fatty acid, a peptide, a protein, an enzyme, 2,3,6,7-tetrahydroxyanthracene, catechol, 2,3-hydroxynaphthalene, 9,10-dibromoanthracene, and terephthalaldehyde.

23. The method of claim 19, wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

24. The method of claim 19, wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

25. The method of claim 19, wherein the non-dielectric layer is derived from a compound selected from the group consisting of polyaramids, PAN, polyacrylic acid (PAA) and its neutralized salt, MPAA (M=Li, Na or K), polyethylene oxide (PEO), poly(methyl methacrylate) (PMMA), carboxymethyl cellulose (CMC), polyaniline (PANI), polyimide (PI), poly(ethylene-co-acrylic acid) (PEAA), cellulose, monosaccharides and polysaccharides.

26. The method of claim 19, wherein the non-dielectric layer is derived from a compound selected from the group consisting of metal-oxides, titanium isopropoxide (Ti(i-OPr)4, where OPr═OC₃H₇), and aluminum isopropoxide (Al(i-OPr)₃)

27. The method of claim 19, wherein the non-dielectric layer is derived from a compound selected from the group consisting of carboxylates, EC, EMC, DMC, MEC, FEC DFEC, vinylene carbonate, perfluoroalkyl ethylene carbonates, perfluoroalkenes (C2-C12) and 1H,H1,H2-perfluoroalkenes (C3-C12).

28. The method of claim 19, wherein the non-dielectric layer is derived from a compound selected from the group consisting of p-phenylenediamine, succinamide, phenylene diamines (o-, m- and p-analogs) and alkyldiamides ranging from C2-C12.

29. The method as in any of claims 1-28, wherein the first particle has an outer surface that is substantially free of silicon oxide species, as characterized by X-ray photoelectron spectroscopy (XPS).

30. The method of claim 29, wherein the outer surface of the first particle has a SiOₓ content of less than or equal to 1%, as characterized by X-ray photoelectron spectroscopy (XPS), wherein x is ≤2.

31. The method as in any of claims 1-30, wherein the core material of the first particle further comprises:
a) one or more elements used for p-type semiconductor doping, the elements independently selected from boron, aluminum, and gallium;
b) one or more elements used for n-type semiconductor doping, the elements independently selected from nitrogen, phosphorous, arsenic, and antimony;
c) one or more elements found in metallurgical silicon, the elements independently selected from aluminum, calcium, titanium, iron, and copper;
d) one or more conductive metals independently selected from aluminum, nickel, iron, copper, molybdenum, zinc, silver, and gold;
e) or any combination thereof.

32. The method as in any of claims 1-31, wherein the core material of the first particle is free of p-type and n-type semiconductor doping elements.

33. The method as in any of claims 1-32, wherein the core material of the first particle has an outer surface modified with one or more surface-modifying agents, wherein the surface-modifying agent is benzene, mesitylene, xylene, 2,3-dihydroxynaphthalene, 2,3-dihydroxyanthracene, 9,10-phenanthrenequinone, 2,3-dihydroxytetracene, fluorine substituted 2,3-dihydroxytetracene, trifluromethyl substituted 2,3-dihydroxytetracene, 2,3-dihydroxypentacene, fluorine substituted 2,3-dihydroxypentacene, trifluromethyl substituted 2,3-dihydroxypentacene, pentacene, fluorine substituted pentacene, naphthalene, anthracene, pyrene, perylene, triphenylene, chrysene, phenanthrene, azulene, pentacene, pyrene, a polythiophene, poly(3-hexylthiophene-2,5-diyl), poly(3-hexylthiophene), polyvinylidene fluoride, a polyacrylonitrile, polyaniline crosslinked with phytic acid, single wall carbon nanotubes, multi-walled carbon nanotubes, C60 fullerenes, C70 fullerenes, nanospherical carbon, graphene, graphite nanoplatelets, carbon black, soot, carbonized conductive carbon, or any combination thereof.

34. The method as in any of claims 1-33, wherein the first particle is an alloy of the core material and lithium.

35. The method of claim 34, wherein the first particle alloy is coated with a continuous coating on the surface of the first alloy particle with one or more surface-modifying agents, the surface-modifying agent is a polymer or a monomer additive.

36. The method of claim 35, wherein the polymer additive is selected from the group consisting of polystyrene, polyacrylonitrile, polyacrylic acid, lithium polyacrylate, and polyaniline.

37. The method of claim 35, wherein the monomer additive is selected from the group consisting of selected from the group consisting of alkenes, alkynes, aromatics, heteroaromatics, cycloalkenes, alcohols, glycols, polyglycols, ethers, polyethers, thiols, disulfides, amines, amides, pyridines, pyrroles, imides, imidazoles, imidazoline, furans, thiophenes, cyanates, isocyanates, isothiocyanates, ketones, carboxylic acids, esters, amino acids, aldehydes, acrylates, methacrylates, oxylates, organic carbonates, lactones, and the gases H₂, O₂, CO₂, N₂O, and HF, and fluorinated analogs thereof.

38. The method of claim 35, wherein the continuous coating forms a protective shell capable of impeding diffusion of oxygen and/or water to cores of the first particle alloy, wherein the continuous coating is capable of allowing Li+ ion mobility and/or facilitate electrical charge transfer from the first particle alloy to an electrode current collector.

39. A graphite composite particle made by the method of any of the previous claims.

40. A graphite composite particle comprising:
a) a first particle, wherein the first particle has a core material comprising silicon, silicon oxide (SiOx where x is <2), germanium, tin, lead, iron, aluminum, lithium, cobalt, or an alloy of any combination of any one or more of silicon, germanium, tin, lead, iron, aluminum, lithium or cobalt;
b) and a graphite particle, wherein the first particle is embedded on the surface or in a pore of the graphite particle.

41. The graphite composite particle of claim 40, wherein the first particle has a non-dielectric layer covering at least a portion of a surface of the first particle.

42. The graphite composite particle of claim 41, wherein the non-dielectric layer is derived from a compound selected from the group consisting of hydrogen (H₂), alkenes, alkynes, aromatics, heteroaromatics, cycloalkenes, alcohols, glycols, thiols, disulfides, amines, amides, pyridines, pyrroles, furans, thiophenes, cyanates, isocyanates, isothiocyanates, ketones, carboxylic acids, amino acids, and aldehydes.

43. The graphite composite particle of claim 41, wherein the non-dielectric layer is derived from a compound selected from the group consisting of 1,2-dimethoxyethane (also referred to as glyme, monoglyme, dimethyl glycol, or dimethyl cellosolve); 1-methoxy-2-(2-methoxyethoxy)ethane (also referred to as diglyme, 2-methoxyethyl ether, di(2-methoxyethyl)ether, or diethylene glycol dimethyl ether); 1,2-bis(2-methoxyethoxy)ethane (also referred to as triglyme, triethylene glycol dimethyl ether, 2,5,8,11-tetraoxadodecane, 1,2-bis(2-methoxyethoxy)ethane, or dimethyltriglycol); 2,5,8,11,14-pentaoxapentadecane (also referred to as tetraglyme, tetraethylene glycol dimethyl ether, bis[2-(2-methoxyethoxy)ethyl]ether, or dimethoxytetraglycol); dimethoxymethane (also referred to as methylal); methoxyethane (also referred to as ethyl methyl ether); methyl tert-butyl ether (also referred to as MTBE); diethyl ether; diisopropyl ether; di-tert-butyl ether; ethyl tert-butyl ether; dioxane; furan; tetrahydrofuran; 2-methyltetrahydrofuran; and diphenyl ether.

44. The graphite composite particle of claim 41, wherein the non-dielectric layer is derived from a compound selected from the group consisting of toluene, benzene, a polycyclic aromatic, a fullerene, a metallofullerene, a styrene, a cyclooctatetraene, a norbomadiene, a primary alkene, a primary alkyne, a saturated or unsaturated fatty acid, a peptide, a protein, an enzyme, 2,3,6,7-tetrahydroxyanthracene, catechol, 2,3-hydroxynaphthalene, 9,10-dibromoanthracene, and terephthalaldehyde.

45. The graphite composite particle of claim 41, wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

46. The graphite composite particle of claim 41, wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

47. The graphite composite particle of claim 41, wherein the non-dielectric layer is derived from a compound selected from the group consisting of polyaramids, PAN, polyacrylic acid (PAA) and its neutralized salt, MPAA (M=Li, Na or K), polyethylene oxide (PEO), poly(methyl methacrylate) (PMMA), carboxymethyl cellulose (CMC), polyaniline (PANI), polyimide (PI), poly(ethylene-co-acrylic acid) (PEAA), cellulose, monosaccharides and polysaccharides.

48. The graphite composite particle of claim 41, wherein the non-dielectric layer is derived from a compound selected from the group consisting of metal-oxides, titanium isopropoxide (Ti(i-OPr)4, where OPr═OC₃H₇), and aluminum isopropoxide (Al(i-OPr)₃)

49. The graphite composite of claim 41, wherein the non-dielectric layer is derived from a compound selected from the group consisting of carboxylates, EC, EMC, DMC, MEC, FEC DFEC, vinylene carbonate, perfluoroalkyl ethylene carbonates, perfluoroalkenes (C2-C12) and 1H,H1,H2-perfluoroalkenes (C3-C12).

50. The graphite composite particle of claim 41, wherein the non-dielectric layer is derived from a compound selected from the group consisting of p-phenylenediamine, succinamide, phenylene diamines (o-, m- and p-analogs) and alkyldiamides ranging from C2-C12.

51. The graphite composite particle of claims 40-50, wherein the first particle has an outer surface that is substantially free of silicon oxide species, as characterized by X-ray photoelectron spectroscopy (XPS).

52. The graphite composite particle of claim 51, wherein the outer surface of the first particle has a SiOₓ content of less than or equal to 1%, as characterized by X-ray photoelectron spectroscopy (XPS), wherein x is ≤2.

53. The graphite composite particle of claim 40, wherein the first particle has an outer surface modified with one or more surface-modifying agents, wherein the surface-modifying agent is benzene, mesitylene, xylene, 2,3-dihydroxynaphthalene, 2,3-dihydroxyanthracene, 9,10-phenanthrenequinone, 2,3-dihydroxytetracene, fluorine substituted 2,3-dihydroxytetracene, trifluromethyl substituted 2,3-dihydroxytetracene, 2,3-dihydroxypentacene, fluorine substituted 2,3-dihydroxypentacene, trifluromethyl substituted 2,3-dihydroxypentacene, pentacene, fluorine substituted pentacene, naphthalene, anthracene, pyrene, perylene, triphenylene, chrysene, phenanthrene, azulene, pentacene, pyrene, a polythiophene, poly(3-hexylthiophene-2,5-diyl), poly(3-hexylthiophene), polyvinylidene fluoride, a polyacrylonitrile, polyaniline crosslinked with phytic acid, single wall carbon nanotubes, multi-walled carbon nanotubes, C60 fullerenes, C70 fullerenes, nanospherical carbon, graphene, graphite nanoplatelets, carbon black, soot, carbonized conductive carbon, or any combination thereof.

54. The graphite composite particle of claim 40, wherein the first particle is an alloy of the core material and lithium.

55. The graphite composite particle of claim 54, wherein the first particle alloy is coated with a continuous coating on the surface of the first alloy particle with one or more surface-modifying agents, the surface-modifying agent is a polymer or a monomer additive.

56. The graphite composite particle of claim 55, wherein the polymer additive is selected from the group consisting of polystyrene, polyacrylonitrile, polyacrylic acid, lithium polyacrylate, and polyaniline.

57. The graphite composite particle of claim 55, wherein the monomer additive is selected from the group consisting of selected from the group consisting of alkenes, alkynes, aromatics, heteroaromatics, cycloalkenes, alcohols, glycols, polyglycols, ethers, polyethers, thiols, disulfides, amines, amides, pyridines, pyrroles, imides, imidazoles, imidazoline, furans, thiophenes, cyanates, isocyanates, isothiocyanates, ketones, carboxylic acids, esters, amino acids, aldehydes, acrylates, methacrylates, oxylates, organic carbonates, lactones, and the gases H₂, O₂, CO₂, N₂O, and HF, and fluorinated analogs thereof.

58. A method of making a coated particle comprising:
a) providing a first particle, wherein the first particle has a core material comprising silicon, silicon oxide (SiOₓ where x is <2), germanium, tin, lead, iron, aluminum, lithium, cobalt, or an alloy of any combination of any one or more of silicon, germanium, tin, lead, iron, aluminum, lithium or cobalt;
b) passivating the first particle by coating it with a non-dielectric layer covering the surface of the first particle.
c) coating the passivated first particle in its entirety.

59. The method of claim 58, wherein the non-dielectric layer is derived from a compound selected from the group consisting of hydrogen (H₂), alkenes, alkynes, aromatics, heteroaromatics, cycloalkenes, alcohols, glycols, thiols, disulfides, amines, amides, pyridines, pyrroles, furans, thiophenes, cyanates, isocyanates, isothiocyanates, ketones, carboxylic acids, amino acids, and aldehydes.

60. The method of claim 58, wherein the non-dielectric layer is derived from a compound selected from the group consisting of 1,2-dimethoxyethane (also referred to as glyme, monoglyme, dimethyl glycol, or dimethyl cellosolve); 1-methoxy-2-(2-methoxyethoxy)ethane (also referred to as diglyme, 2-methoxyethyl ether, di(2-methoxyethyl)ether, or diethylene glycol dimethyl ether); 1,2-bis(2-methoxyethoxy)ethane (also referred to as triglyme, triethylene glycol dimethyl ether, 2,5,8,11-tetraoxadodecane, 1,2-bis(2-methoxyethoxy)ethane, or dimethyltriglycol); 2,5,8,11,14-pentaoxapentadecane (also referred to as tetraglyme, tetraethylene glycol dimethyl ether, bis[2-(2-methoxyethoxy)ethyl]ether, or dimethoxytetraglycol); dimethoxymethane (also referred to as methylal); methoxyethane (also referred to as ethyl methyl ether); methyl tert-butyl ether (also referred to as MTBE); diethyl ether; diisopropyl ether; di-tert-butyl ether; ethyl tert-butyl ether; dioxane; furan; tetrahydrofuran; 2-methyltetrahydrofuran; and diphenyl ether.

61. The method of claim 58, wherein the non-dielectric layer is derived from a compound selected from the group consisting of toluene, benzene, a polycyclic aromatic, a fullerene, a metallofullerene, a styrene, a cyclooctatetraene, a norbomadiene, a primary alkene, a primary alkyne, a saturated or unsaturated fatty acid, a peptide, a protein, an enzyme, 2,3,6,7-tetrahydroxyanthracene, catechol, 2,3-hydroxynaphthalene, 9,10-dibromoanthracene, and terephthalaldehyde.

62. The method of claim 58, wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

63. The method of claim 58, wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

64. The method of claim 58, wherein the non-dielectric layer is derived from a compound selected from the group consisting of polyaramids, PAN, polyacrylic acid (PAA) and its neutralized salt, MPAA (M=Li, Na or K), polyethylene oxide (PEO), poly(methyl methacrylate) (PMMA), carboxymethyl cellulose (CMC), polyaniline (PANI), polyimide (PI), poly(ethylene-co-acrylic acid) (PEAA), cellulose, monosaccharides and polysaccharides.

65. The method of claim 58, wherein the non-dielectric layer is derived from a compound selected from the group consisting of metal-oxides, titanium isopropoxide (Ti(i-OPr)4, where OPr═OC₃H₇), and aluminum isopropoxide (Al(i-OPr)₃)

66. The method of claim 58, wherein the non-dielectric layer is derived from a compound selected from the group consisting of carboxylates, EC, EMC, DMC, MEC, FEC DFEC, vinylene carbonate, perfluoroalkyl ethylene carbonates, perfluoroalkenes (C2-C12) and 1H,H1,H2-perfluoroalkenes (C3-C12).

67. The method of claim 58, wherein the non-dielectric layer is derived from a compound selected from the group consisting of p-phenylenediamine, succinamide, phenylene diamines (o-, m- and p-analogs) and alkyldiamides ranging from C2-C12.

68. The method of any one of claims 58-67, wherein the passivated first particle is coated with a compound by chemical vapor deposition.

69. The method of claim 68, wherein the compound is selected from the group consisting of a light alkene or alkyne such as ethylene, propylene or acetylene, styrene, neoprene, butenes, butadiene, pentenes, pentadiene, organic carbonates, fluorinated alkenes, 1H, 1H, 2H-pefluoroalkenes (wherein the alkene is C3-C12).

70. The method of in any of claims 58-67, wherein the passivated first particle is coated by stirring the passivated first particle together in a solution with solvated polymer, followed by evaporation of the solvent.

71. The method of claim 70, wherein the solvated polymer is selected from the group consisting of polyacrylonitrile (PAN) in N,N-dimethylformamide (DMF), or polyethylene-co-acrylic acid in THF, or poly(methyl methacrylate) (PMMA) in THF, or polystyrene in THF.

72. The method as in any of claims 58-67, wherein the passivated first particle is coated by stirring the particle in a solvent with a reagent or combination of reagents that form(s) a polymer, followed by evaporation of the solvent.

73. The method as in any of claims 58-72, wherein the coated passivated first particle is subjected to a heat treatment process to cure the coating.

74. The method as in any of claims 58-72, wherein the coated passivated first particle is subjected to a process to induce cross-link coupling of the coating constituents.

75. A method of making a coated particle comprising:
a) providing a first particle, wherein the first particle has a core material comprising silicon, silicon oxide (SiOₓ where x is <2), germanium, tin, lead, iron, aluminum, lithium, cobalt, or an alloy of any combination of any one or more of silicon, germanium, tin, lead, iron, aluminum, lithium or cobalt;
b) providing a surface modifier agent to the first particle;
c) coating the surface modified first particle in its entirety.

76. The method of claim 75, wherein the surface-modifying agent is selected from the group consisting of benzene, mesitylene, xylene, 2,3-dihydroxynaphthalene, 2,3-dihydroxyanthracene, 9,10-phenanthrenequinone, 2,3-dihydroxytetracene, fluorine substituted 2,3-dihydroxytetracene, trifluromethyl substituted 2,3-dihydroxytetracene, 2,3-dihydroxypentacene, fluorine substituted 2,3-dihydroxypentacene, trifluromethyl substituted 2,3-dihydroxypentacene, pentacene, fluorine substituted pentacene, naphthalene, anthracene, pyrene, perylene, triphenylene, chrysene, phenanthrene, azulene, pentacene, pyrene, a polythiophene, poly(3-hexylthiophene-2,5-diyl), poly(3-hexylthiophene), polyvinylidene fluoride, a polyacrylonitrile, polyaniline crosslinked with phytic acid, single wall carbon nanotubes, multi-walled carbon nanotubes, C60 fullerenes, C70 fullerenes, nanospherical carbon, graphene, graphite nanoplatelets, carbon black, soot, carbonized conductive carbon, or any combination thereof.

77. The method of claim 75, wherein the first particle is an alloy of the core material and lithium.

78. The method of claim 77, wherein the first particle alloy is coated with a continuous coating on the surface of the first alloy particle with one or more surface-modifying agents, the surface-modifying agent is a polymer or a monomer additive.

79. The method of claim 78, wherein the polymer additive is selected from the group consisting of polystyrene, polyacrylonitrile, polyacrylic acid, lithium polyacrylate, and polyaniline.

80. The method of claim 78, wherein the monomer additive is selected from the group consisting of selected from the group consisting of alkenes, alkynes, aromatics, heteroaromatics, cycloalkenes, alcohols, glycols, polyglycols, ethers, polyethers, thiols, disulfides, amines, amides, pyridines, pyrroles, imides, imidazoles, imidazoline, furans, thiophenes, cyanates, isocyanates, isothiocyanates, ketones, carboxylic acids, esters, amino acids, aldehydes, acrylates, methacrylates, oxylates, organic carbonates, lactones, and the gases H₂, O₂, CO₂, N₂O, and HF, and fluorinated analogs thereof.

81. A coated particle made by the method of any of claims 58-80.

82. A coated particle comprising:
a) a core material comprising silicon, silicon oxide (SiOₓ where x is <2), germanium, tin, lead, iron, aluminum, lithium, cobalt, or an alloy of any combination of any one or more of silicon, germanium, tin, lead, iron, aluminum, lithium or cobalt;
b) a non-dielectric layer covering the surface of the core material.
c) a coating covering particle in its entirety.

83. The coated particle of claim 82, wherein the non-dielectric layer is derived from a compound selected from the group consisting of hydrogen (H₂), alkenes, alkynes, aromatics, heteroaromatics, cycloalkenes, alcohols, glycols, thiols, disulfides, amines, amides, pyridines, pyrroles, furans, thiophenes, cyanates, isocyanates, isothiocyanates, ketones, carboxylic acids, amino acids, and aldehydes.

84. The coated particle of claim 82, wherein the non-dielectric layer is derived from a compound selected from the group consisting of 1,2-dimethoxyethane (also referred to as glyme, monoglyme, dimethyl glycol, or dimethyl cellosolve); 1-methoxy-2-(2-methoxyethoxy)ethane (also referred to as diglyme, 2-methoxyethyl ether, di(2-methoxyethyl)ether, or diethylene glycol dimethyl ether); 1,2-bis(2-methoxyethoxy)ethane (also referred to as triglyme, triethylene glycol dimethyl ether, 2,5,8,11-tetraoxadodecane, 1,2-bis(2-methoxyethoxy)ethane, or dimethyltriglycol); 2,5,8,11,14-pentaoxapentadecane (also referred to as tetraglyme, tetraethylene glycol dimethyl ether, bis[2-(2-methoxyethoxy)ethyl]ether, or dimethoxytetraglycol); dimethoxymethane (also referred to as methylal); methoxyethane (also referred to as ethyl methyl ether); methyl tert-butyl ether (also referred to as MTBE); diethyl ether; diisopropyl ether; di-tert-butyl ether; ethyl tert-butyl ether; dioxane; furan; tetrahydrofuran; 2-methyltetrahydrofuran; and diphenyl ether.

85. The coated particle of claim 82, wherein the non-dielectric layer is derived from a compound selected from the group consisting of toluene, benzene, a polycyclic aromatic, a fullerene, a metallofullerene, a styrene, a cyclooctatetraene, a norbornadiene, a primary alkene, a primary alkyne, a saturated or unsaturated fatty acid, a peptide, a protein, an enzyme, 2,3,6,7-tetrahydroxyanthracene, catechol, 2,3-hydroxynaphthalene, 9,10-dibromoanthracene, and terephthalaldehyde.

86. The coated particle of claim 82, wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

87. The coated particle of claim 82, wherein the non-dielectric layer is derived from a compound selected from the group consisting of dichloromethane (also referred to as methylene chloride), 1,2-dichloroethane, 1,1-dichloroethane, 1,1,1-trichloropropane, 1,1,2-trichloropropane, 1,1,3-trichloropropane, 1,2,2-trichloropropane, 1,2,3-trichloropropane, 1,2-dichlorobenzene (also referred to as ortho-dichlorobenzene), 1,3-dichlorobenzene (also referred to as meta-dichlorobenzene), 1,4-dichlorobenzene (also referred to as para-dichlorobenzene), 1,2,3-trichlorobenzene, 1,3,5-trichlorobenzene, α,α,α-trichlorotoluene, 2,4,5-trichlorotoluene, N-methyl pyrrolidinone (NMP), dimethylsulfoxide (DMSO), tetrahydrofuran (THF), nitromethane, hexamethylphosphoramide (HMPA), dimethylforamide (DMF), and sulfalone.

88. The coated particle of claim 82, wherein the non-dielectric layer is derived from a compound selected from the group consisting of polyaramids, PAN, polyacrylic acid (PAA) and its neutralized salt, MPAA (M=Li, Na or K), polyethylene oxide (PEO), poly(methyl methacrylate) (PMMA), carboxymethyl cellulose (CMC), polyaniline (PANI), polyimide (PI), poly(ethylene-co-acrylic acid) (PEAA), cellulose, monosaccharides and polysaccharides.

89. The coated particle of claim 82, wherein the non-dielectric layer is derived from a compound selected from the group consisting of metal-oxides, titanium isopropoxide (Ti(i-OPr)4, where OPr═OC₃H₇), and aluminum isopropoxide (Al(i-OPr)₃)

90. The coated particle of claim 82, wherein the non-dielectric layer is derived from a compound selected from the group consisting of carboxylates, EC, EMC, DMC, MEC, FEC DFEC, vinylene carbonate, perfluoroalkyl ethylene carbonates, perfluoroalkenes (C2-C12) and 1H,H1,H2-perfluoroalkenes (C3-C12).

91. The coated particle of claim 82, wherein the non-dielectric layer is derived from a compound selected from the group consisting of p-phenylenediamine, succinamide, phenylene diamines (o-, m- and p-analogs) and alkyldiamides ranging from C2-C12.

92. The coated particle of any one of claims 82-91, wherein the coating is selected from the group consisting of a light alkene or alkyne such as ethylene, propylene or acetylene, styrene, neoprene, butenes, butadiene, pentenes, pentadiene, organic carbonates, fluorinated alkenes, 1H, 1H, 2H-pefluoroalkenes (wherein the alkene is C3-C12).

93. The coated particle of any one of claims 82-91, wherein the coating is selected from the group consisting of polyacrylonitrile (PAN), polyethylene-co-acrylic acid, polymethyl methacrylate (PMMA), or polystyrene.
